(19) United States
(12) Patent Application Publication
(10) Pub. No.: US 2008/0071929 A1
(43) Pub. Date: Mar. 20, 2008

(54) Methods and apparatus for selection of information and web page generation

(76) Inventors: Yann Emmanuel Motte, Louveciennes (FR); Marcus Gill Greenwood, London (GB)

Correspondence Address: SCHWEGMAN, LUNDBERG & WOESSNER, P.A., P.O. BOX 2938, MINNEAPOLIS, MN, 55402, US

(21) Appl. No.: 11/522,857

(22) Filed: Sep. 18, 2006

(51) Int. Cl. G06F 15/16

(52) U.S. Cl. 709/246; 709/229; 709/217

(57) ABSTRACT

A method and apparatus for generating new web pages using pre-existing web pages as a template, and a method and apparatus for selection of information from a database or index based on user-allocated ratings, where the selected information may be used to provide content for a web site or for broadcast on TV, radio or other media. For the web page creation, preferably each web page is provided with a “remix” button, which a user can click on to create an editable copy of the web page. The user may subsequently edit individual components of the web page to customise it. A ranking system for web pages, modules, content and users may be implemented, and may be used to automatically select highly rated content. The automatic selection may also use meta data such as “tags” specifying the subject matter of the web site, and meta data relating to the particular user who is viewing the web site. The automatic selection process may use “tag clouds” comprising groups of related tags, in order to improve the search and matching process. The selected content may include advertising material or any other web site content, such as news feeds, blogs, pictures, etc. Where advertising material is selected for display, the selection criteria may take into account the user allocated ratings of each advert, as well as the price that advertisers are willing to pay in order to have the advert displayed.

### FIELD OF THE INVENTION

The present invention relates to methods and apparatus for selection of information and web page generation. In particular, this may include automatically selecting information from an information store or index, and publishing of web pages which may include adverts or other content.

### BACKGROUND OF THE INVENTION

The internet is becoming increasingly important as a publishing medium for both private and commercial users. Increasing numbers of people and businesses are setting up web sites, for business and social purposes. However, this normally requires some technical skill and/or specialist software. Although it is possible to generate a web page without specialist software, e.g. directly as html code in a text editor, this is very time consuming and it is difficult to visualise the final effects. More commonly, a web page may be generated by web design software such as Microsoft Frontpage™, and the resulting code may be sent to a web publishing internet host, to be made available for viewing on the internet. However, this process is difficult for the novice user, and requires a user to purchase and install the web page generation software, which may be prohibitively expensive for occasional users. It is particularly difficult for novice users to add functional features to their web page, such as message boards, calendars, blogs, etc.

Some such functional features are provided for non-technical internet users via services such as Smartgroups™. Smartgroups™ allows sharing of information within selected groups of users on the internet. The shared information may include files, pictures, calendar, diary, web links, and message board facilities. Members of a group may upload information to a web page hosted by the service provider, and may view and use information uploaded by other members of the group. However, the format and content is very much limited to a fixed template, and customisation and design options are generally minimal.

As well as the increasing requirement for allowing only particular groups or communities to access certain web pages, there is a growing requirement to make internet web pages accessible via mobile and portable devices such as mobile phones and PDAs. These commonly have a smaller, lower quality display and lesser processing capabilities than a standard desktop computer. Although the WAP protocol is designed for such mobile devices, many web pages are not adapted to use WAP. Attempts to automatically convert them to WAP format tend to meet with varying degrees of success. There is a need for better ways of making web site content available to mobile and portable devices, while avoiding restricting the quality of such content when it is displayed on a normal computer.

At present, sites such as Netvibes™ and MSN Live™ allow a user to customise the content viewed on a web site. However, these sites only allow limited publishing and little if any information sharing. There is a need for new and more convenient methods of web publishing and information sharing, suitable for people without specialist technical knowledge. This emerging area of technology is known as “social publishing”.

The internet provides access to vastly more information than the largest of paper-based libraries. However, it is frequently difficult to separate poor quality and unreliable information on the internet from good quality material. There is a need for better ways of sourcing the best quality material available on the internet. Some existing internet sites provide a rating system for items for sale. For example, Amazon.com provides a user rating system for books and other items. A prospective buyer may view ratings and comments provided by other users, to evaluate different products before purchase. Other web sites provide user rating systems for certain types of published internet content. For example, Digg.com provides a system for rating of news stories which have been published elsewhere on the internet. Users award points to news items that they like, and can request the removing of items that they don't like. A list of the most highly rated news stories is provided to people viewing the Digg.com web site. Links to the best stories within each of several different categories (e.g. technology, science, etc) are displayed in a list. New stories are listed on an “upcoming story” part of the web site for up to 24 hours before being promoted to the main web page if they receive high enough ratings, or being removed if they fail to receive high enough ratings. However, Digg.com is only concerned with rating news stories, and does not rate other types of internet content.

Some existing web sites indicate popularity of different topics on the internet using a so-called “tag cloud” to provide a visual indication of the relationship between topics. A tag cloud is a weighted list of words or phrases. For example, a tag cloud can be visually displayed to show a number of related words, where the size of each word is selected according to a score allocated to that word, e.g. its popularity. The words are normally displayed in alphabetical order. When a user clicks on any word in the tag cloud, this can result in the display of a tag cloud for the word that has been clicked on, and additional information relating to the clicked-on word may also be displayed. This provides a user interface for navigation of information. However, there is always a demand for improved user interfaces, for use on individual computers or electronic devices, the internet and elsewhere.

The concept of advertising on the internet is well known, and has the potential to generate a great deal of revenue for popular web sites. The current advertising paradigm involves advertisers segmenting audiences to convey messages based on expected needs, and thus to provide better targeting and user interest in the adverts. One of the present market leaders for distribution of adverts is the Google AdSense™ and AdWords™ software, which analyses the content of a target web page e.g. by identifying keywords in the text of the web page, and uses an algorithm to select adverts that are most likely to be relevant that particular web page and its users. If a web site subscribes to Google AdSense, the site owner will normally receive a payment per click for users viewing and clicking on the adverts, and/or a payment per viewing of the web page containing the advert. AdSense for Feeds is a version of AdSense that runs on RSS and Atom feeds. However, there is always a demand for more effective targeting of advertisements on the internet.

### SUMMARY OF THE INVENTION

A first aspect of the present invention provides a method and apparatus for generating a web page. An instruction from a user to generate a web page is received at a server, and an identification of an existing web page which is to be used as a template for creating the new web page is also received at the server. The existing webpage is accessible over a network, e.g. the internet. In many embodiments, the new and original web pages are modular web pages, each including a number of separate functional parts.

Information defining the existing web page is initially copied to define the new web page. However, any restricted access material on the existing web site may not be copied to the new web page, if the user creating the new web page does not have access rights. Access levels may be set for individual web pages or web sites. In some embodiments, access levels may be set for individual modules of a web page. Access levels may include single user access only; access by any user in a predetermined list of users (termed “community access”); access by any logged on user, or unrestricted public access. A series of user selectable tabs may be provided on the web page, to allow a user with sufficient access rights to view the appearance of the screen at different access levels. This is discussed in more detail below.

Each module may also be allocated with a device compatibility rating, e.g. to indicate whether the module is displayable on specified types of hardware, e.g. low resolution computer screens, mobile computing devices such as mobile phones or PDAs, televisions, etc. A series of tabs may be provided for each of one or more levels of restricted compatibility, e.g. selection of a “mobile phone” tab may result in the display of only those modules that are compatible with the WAP protocol.

A log-on or registration procedure may be automatically initiated if the user is not logged on when requesting to create a new modular web page. A network address, such as a URL or an IP address in a TCP/IP network, may be automatically allocated to the new modular web page.

The existing and first new modular web pages may be stored on storage space associated with the same server. For example, the storage space may be a single disk within the server, or two different disks (e.g. a hard disk and an optical disk) both within the server or linked to the server. The system may initiate a log-on or registration procedure if the user is not logged on when requesting to create a new modular web page. The system may allocate a network address to the new modular web page.

User editing controls may be provided to the user, to allow the user to edit content, layout, modules and access rights e.g. “community settings” of the new web page. The server then modifies information defining the new web page in accordance with these user edits, e.g. modifying html code, or any other type of code defining the web page. The information defining the new web page is sent to an information store which is accessible over the network.

In some embodiments, the web pages may be generated dynamically using server-side code such as scripts and applets. In this case, the user edits may be applied to modify the information stored in a user preference database, and this modified information may be used by code running on the server to modify the html code of a web page. For example, if the html code of the web pages was generated from a server run script, then user edits may result in a modification of stored information in a database which will be processed by the script to indirectly change the html code that is generated by the script. In another embodiment, parts of the script itself may be changed in response to user edits, e.g. particular parameters may be inserted into the script. To replicate a web site, it may not be necessary to make a copy of all components and code used in a web page in a web browser, for example, information in a user preference database for that web page may be copied and associated with a name or ID of the replicating user, and/or associated with an identifier of a web page belonging to the replicating user, instead of creating multiple copies of the server-side code on the server.

In preferred embodiments, the original webpage includes a web page replication control which may be activated by a user to send an ID of the web page and an instruction to generate a further new web page to a server. This replication control may be known, for example, as a “re-mix” button, a “clone” button or a “replicate” button. A user instruction to generate a new web page may be generated automatically when a user activates the web page replication control. This instruction may automatically include an identifier of the original web page. The new web page may also include a web page replication control for generating further new web pages. The replication control may be explicitly included within code defining the web page, or it may be automatically added by the server whenever the web page is requested.

Templates may be provided to allow a user to add new modules or other components to their new or existing web pages. The templates may comprise definitions of individual web page components or groups of web page components. When a user selects a particular template or web page component, the relevant code may then be automatically added to the user's web page. In embodiments of the invention using modular web pages, a user may be offered a selection of web page modules, and a module chosen by the user may be added to the new web page by modifying information defining the web page. When a new web page is created from an existing web page, all modules of the original web page, for which the user has read access, may be automatically copied to the new web page.

The information defining the original web page may include meta data, and meta data for the new web page and/or for individual elements of the new web page may be automatically generated using this meta data that is already associated with the original web page. The meta data may include tags or labels identifying subject matter of the web page and/or of individual modules in the web page. Tags may be used to label web pages as a whole, individual web page modules, users, and other components. In one embodiment, the meta data from the original web page may be automatically copied to the information defining the new web page. Alternatively, or additionally, meta data may be entered or edited by a user, and/or may be automatically generated e.g. by extracting keywords from the actual content of the original web site. A user may be provided with editing controls to edit the meta data associated with the new web page.

User access right settings may be copied from the original web page to the new web page. These may define user access rights for one or more users, and may include read access settings, write access settings and any other type of access settings. The user access rights may be defined with reference to particular individual users or groups of users, or may be defined relative to the web site properties, e.g. giving particular rights to whoever owns the web site, whoever owns a parent web site used to generate the current web site, etc.

The user access rights may be defined for an entire web page or for individual modules. The user access settings may include a list of particular users who have user access, such as a list of user IDs or email addresses. This list may define a “community”, such as a neighbourhood group, social or sports club, common interest group, or any other type of community. The list may be stored in the form of a list, or may be stored in any other format, e.g. as a collection of sub-lists.

The content of a new web page may be manually selected by a user, copied from another web page, or may be automatically selected using a content selection algorithm. The meta data associated with a new web page may be created, and then used to automatically select content for at least a part of the new web page, e.g. for one or more modules in the new web page. In addition to or instead of meta data being used for content selection, stored information identifying interests or habits of a user may be used to automatically select content for at least a part of the new web page. Such user information may be stored on the server and retained over multiple user sessions on the network.

To allow users to identify which web sites have been replicated, a hyperlink may be created in the new web page, linking the new web page to the original web page. One or more hyperlinks may be included in the new web page, linking the new web page with any web page in a chain of web pages from which the new web page was generated, or with any web page in a chain of web pages that has been generated using the new web page. A hyperlink may be created in the original web page, linking the original web page to the new web page. One or more hyperlinks may be generated, linking to the new web page, on any web page in a chain of web pages from which the new web page was generated, or on any web page in a chain of web pages that has been generated using the new web page.

A history list may be generated, identifying the relationship between the new web page, the original web page, and any previous web pages that were used to generate either the original web page or another of said previous web pages. A list may be generated identifying any web pages that have been generated using the new web page. These lists may be included in one or more of the web pages.

Rating points may be allocated to web pages, modules, layouts, users and content such as advertising content or non-advertising content, by users of the system. Rating points may be automatically allocated to a web page each time it is used as a template for a new web page.

A further aspect of the invention comprises a user terminal for use in automatically generating a web page, and a corresponding method performed by the user terminal. The user terminal may communicate with a server that automatically generates new web pages as described above. The user terminal may be adapted to receive an existing web page from the server via a network and to display the existing web page. In response to an instruction from a user, the user terminal may send an instruction to the server to generate a new web page and send an identifier of the existing web page to the server. The user terminal may then receive a new web page generated by the server and display the new web page to a user, where the new web page has been generated using information defining the existing web page. The user terminal may provide user editing controls to allow a user to edit content, layout, modules and/or access rights e.g. “community settings” of the new web page, and send the user edits to the server, such that the modified new web page may be stored in an information store which is accessible over the network. The user terminal may then update the display of the new web page to include the user edits. Other aspects of the web pages may be as described above.

A further aspect of the invention comprises a method and apparatus for automatically generating a web page, where the method includes receiving a user selection or automatic selection of a topic for the web page. The topic selection is then used to search a database for information associated with the topic. Items of information within the search results are selected using rating values associated with the items of information. The selection may comprise the most highly rated items of information, e.g. the top rated items, or items within a top range of rating values. A web page is then generated, where the web page includes the selected items of information, which are arranged using predetermined layout information. The selection may be based on scores which are calculated using the rating values. The scores may also be calculated using the age of each item of information or the time at which the items of information were last updated or confirmed to be current.

The selected topic may be associated with one or more additional topics, and the search of the database may include searching for items of information associated with the selected topic and/or at least one additional topic. The scores may be calculated using weightings which are set according to which of the selected topic and additional topics are associated with each item of information.

A yet further aspect of the invention comprises a method and apparatus for automatically selecting information from an information store or index. Each item of information has meta data such as a rating value and one or more tags. Data associated with one or more users is retrieved and used to generate a search query. For example, this data may include information on the interests or behaviour of a user who is browsing the web site. The information store or index is searched using the search query and items of information having at least one tag corresponding to the search term are selected. Thus, the search may identify information from the database which is of relevance to the user. A score may then be awarded to each selected item of information, using the rating values of each item of information. The selected items of information may be ranked according to their scores. At least one of the selected items of information with a score in a top part of the ranking may be output. For example, the top part of the ranking may be the top 1%, 5%, 10%, 20%, 50%, or some other figure. In some embodiments, the highest ranked item may be output.

The selected items of information may be output by publishing them on a web site, broadcasting them on television or radio, displaying them on an electronic billboard, or putting them into a queue for such publication, broadcast or display. The selected content may include advertising content. The data associated with a user may comprise information associated with a single user, e.g. that user's individual preferences, or may be more generic information associated with a group of users, e.g. a geographical location or an expected age group.

After an item of information has been outputted, it may be removed from the ranking, to prevent it being outputted for a second time successively. A further item of information which has a score in a top part of the revised ranking may then be output. The ranking may be used to select information for output for a selected time period, such as for a 30 minute period, a 1 hour period, a 3 hour period, a one day period, or a one week period. Alternatively, the selected time period may be dependent on the user behaviour, e.g. for the duration of a current user internet session, or may be set to a particular number of times that information is output from the ranking, e.g. until 10 items are output, or until 10% of the items of information are output. The time period may be selected according to the type of medium to which the information is outputted and/or using statistics on the user's browsing behaviour on said medium. For example, the time period may be 30 minutes for information output to the internet, but 2 days for information output to a radio station. After expiry of the time period, a new search query is used to generate a new ranking, which is used for subsequent output of information.

The scores may be adjusted using weightings that are determined according to a creation date of each item of information, and/or the number of times each item of information has previously been viewed by users, and/or the source locations of the items of information.

In embodiments where the output information is published on a modular web page, the search query may be generated using retrieved information associated with the user and using tags associated with a module of the web page. Only selected items of information which are suitable for output within said module are chosen for output, when content for the module is being determined.

Awarding a score may involve using only rating values that have been allocated by members of a restricted group of users. The restricted group of users may be users in a predetermined age range, users of a predetermined gender, users located in a predetermined geographical area, or some combination of these restrictions. The results of the search of the information store or index may be used to select a plurality of module types for a modular web page, e.g. if several highly rated modules of a first type are found, and no highly rated modules of a second module type are found, then two of the first type of module and none of the second type of module may be displayed.

Content for display on a web page may be selected using predetermined user interest information from a user, which is stored on a server. A request is received from the user to view the web page, and the user interest information is used to select content for display on the web site from an information content store or index. The selected content is then displayed on the web page. The selected content may be selected using a combination of the user interest information and user assigned ratings assigned by a plurality of users. Alternatively, the selected content may be selected using a combination of the user interest information and meta data associated with the web page. The selected content may include advertising material selected from one or more databases of adverting material.

Another aspect of the invention provides a user interface for displaying inter-relations between different items of information. The inter-relations are displayed in the form of a “tag cloud”, which shows a number of key-words related to a common subject. A tag cloud is a weighted list of tags. Tag clouds are often visually depicted with the most heavily weighted tags being displayed in a larger font than the less heavily weighted tags. The tag cloud may also be used to allow user navigation through information in an information store, by allowing a user to select tags in the tag cloud, and displaying a new tag cloud associated with the selected tag. The general concept of tag clouds is already known, e.g. at the Technorati web site, the size of tag reflects popularity, and the tags are sorted in alphabetical order.

In embodiments of the invention, the main keyword may be displayed in the centre of the tag cloud, with the largest size of font. The other keywords are then displayed around the main keyword, with their size being proportional to their ratings.

In embodiments of the invention, information may be output to a user, by retrieving tags from a tag store, where the tags are in one or more of the following categories: tags representing interests of a user; tags relating to published web page content of the user; tags relating to a web page that a user has most recently requested to view; and tags relating to topics for which a user has requested to received advertising material. Individual tags may be in multiple categories. Each individual tag of the retrieved tags may be provided with a score, where the score is determined using the number and type of categories in which the individual tag is included. A predetermined number of tags with the highest scores may be used to search an information database or index to locate information relating to these tags. At least some of said located information may be output to the user.

The number of categories in which one or more of the predetermined number of tags occurs may be used to select a format for displaying the located information. The located information may include advertising material, and the number of categories in which one or more of the predetermined number of tags occurs may be used to select an advertising format. For example, a text format may be selected if each said tag associated with particular located information is only in one of the categories, but a video format may be selected if at least one of the tags associated with particular located information is in a predetermined number of categories. Scores for each tag in each category may be determined according to the time at which each tag was initially generated or confirmed by a user to be currently valid. A user may regularly be asked to confirm if their current tags are still currently valid. Scores for individual tags that are present in multiple categories may be generated by allocating a score to each occurrence of an individual tag in any category, and summing the scores for the individual tag over a plurality of categories.

Embodiments of the present invention provide tag clouds for rating individual web page components as well as entire web pages, and for rating individual users. Also, a graphical user interface may be provided to show the history of tag cloud development, and/or demographic information on tag clouds.

A further aspect of the invention comprising rating a web page, web page component or user. User controls are provided to allow users to rate the web page, web page component or user by adding new tags to a tag cloud describing the web page, web page component or user, and/or by rating the tags in said tag cloud. Data defining the tag cloud and the ratings is stored in a data store. User controls are provided for rating a web page, web page component or user by allocating a numerical score, and storing the numerical score in a data store. User controls are provided to rate a web page, web page component or user by providing user comments, and storing the user comments in a data store.

A yet further aspect of the invention comprises generating a tag cloud for a specified topic. A database storing meta data relating to each of a plurality of items of information is searched, where the meta data indicates the subject matter of the information. Items of information which have meta data matching the specified topic are identified. A list of meta data that is associated with the items of information identified in said search is generated. The list will include meta data that does not match the specified topic. Weights for each item of meta data in the list are generated, using the number of times each item of meta data is associated with any item of information identified in the search. A tag cloud is generated for the specified topic using the list and weights.

In some embodiments, only the items of meta data which have weights above a predetermined threshold are used to generate the tag cloud. The weights may be modified using any combination of the following factors: popularity of each tag; time since generation of each tag; time since last update of information associated with said tag; ratings values of said tag. A search interface may be provided to allow a user to enter a search term, and the specified topic may be specified to be this search term. To display search results, a tag cloud may be displayed to the user.

In some embodiments, a user interface comprising a visual representation of said tag cloud may be displayed, wherein the user interface is configured to allow a user to select any topic in said tag cloud, and to generate and display a new tag cloud using the topic selected by the user as the specified topic.

In another embodiment, tags of a tag cloud, ratings for each tag, and information about users who created and rated each tag may be stored. User controls may be provided to allow a user to specify a sub group of users according to a user criteria. Weightings for each tag in the tag cloud may be generated using only ratings that have been allocated by users in the selected group of users. The tag cloud may then be displayed with these generated weightings. The user criteria may include any combination of gender, age or age group, geographical location, type of employment, political views. The weightings may also be determined according to the time at which each tag was created.

Another aspect of the invention provides a method of prioritisation of advertising material for display or broadcast. Instead of simply selecting adverts according to the amount of money paid by an advertiser, the adverts to be displayed are selected by a combination of the amount of money paid, and the user-allocated rating of the adverts. Meta data relating to the particular user who is viewing the web page may be used in the advert selection procedure.

An advert to be served to a user or a group of users may be automatically selected as follows. A list of adverts is ranked using price categories paid by advertisers for the adverts and using ratings allocated to the adverts by users. An advert is selected from a top part of the ranked list. The selected advert is served to a user or group of users. The list of adverts may be obtained by searching a database of advert information using information specific to a user or group of users to whom the advert will be served.

The selected advert may be served to a web page, and the information specific to a user or group of users may include any of the following criteria: stated interests of the user or group of users; published content of web pages owned by the user or group of users; advertising topics that the user or group of users has specified; information associated with the web page to which the advert will be served; information relating to the geographical location of the user or group of users; a language used by the user or group of users, and/or a preferred advert format selected by the user or group of users. At least some of said criteria may be assigned weighting values to determine their relative importance, and the weighting values may be used to determine search terms for searching a database of adverts to obtain the ranked list. In one example, the top part of the ranked list is the top 20% of the ranked list.

A further aspect of the invention comprises selecting keywords to be generated for use in the selection of advertising material for a target web site. Keywords relating to any of the following sources may be retrieved: the content of the target web site; the author of the target web site; the user who is requesting to view the target web site; and other web sites owned by said user. Weighting values are used to assign weights to the retrieved keywords according to the keyword source and the time at which the keyword was assigned to said keyword source. A ranked list of keywords is generated using the assigned weights, and the ranked list of keywords is compared to the keywords associated with individual adverts. Adverts are selected in dependence upon the result of the comparison.

The sources of keywords may include tags associated with information in an information store. A paid price of each selected advert and a user rating of said selected advert may be used to assign a priority rating to the advert. An advert may be served to the target web site, where the advert is chosen using the priority rating. In some embodiments, only adverts with a priority rating above a threshold value are served.

In addition to advert selection for the internet, embodiments of the invention may be used for other types of advert selection or content selection. For example, embodiments of the invention may be used to select television advertising material, radio advertising material and advertising material on electronic billboards, such as those displayed in railway stations, shopping centres, etc. This advert selection may be driven by the preferences of one or more particular viewer of the advert, and/or it may be driven by the location of the person viewing the advert, or other local factors. For example, radio advertising may be driven by which types of people listen to the radio station, and which local area is served by the radio station. Where several transmitters for the same radio station are located in different areas, each transmitter may be set up to transmit different adverts within common advertising time slots, using an advert selection process according to an embodiment of the invention, that takes geographical location into account when choosing an advert, in particular when combined with user preference. Similarly, networks of electronic billboards may have adverts selected automatically according to their location. For example, an electronic billboard on a train may be automatically served with different adverts, depending on the destination of the train at that time.

A further aspect of the invention relates to management of displayed adverts. Identifiers of adverts are stored, where these adverts are adverts that have been served to a user on one or more web pages during a time period. These identifiers may be an advert name, title, URL, serial number or code, or any other data identifying the advert. The entire advert itself may also be stored, or may simply be accessed from a third party system when required. User controls are provided for displaying adverts corresponding to the stored identifiers and for sorting and/or searching adverts corresponding to the stored identifiers, in response to a user input. The time period may be an automatically selected time period, or may be selected by the user. Adverts according to any of the following criteria, in response to a corresponding user selection: time of serving of advert; time of publication of advert; content of the adverts; previous user interest in the adverts; previous labelling of adverts by the user; referrals of adverts by another user.

A further aspect of the invention comprises generating and sharing revenue from advertising. An advert may be served to a first web page owned by a first user, where the first web page has been generated using a second web page as a template, or using a web page that has been directly or indirectly derived from the second web page as a template. An advertising fee may be charged to an advertiser for serving the advert. A first predetermined portion of the advertising fee is then allocated to the first user, and a second predetermined portion of the advertising fee is allocated to a second user who owns the second web page.

The second web page may be a web page that was used as a template by the first user to create the first web page or to create a web page from which the first web page was directly or indirectly derived. The second web page may have been generated using a third web page as a template, or using a web page that has been directly or indirectly derived from the third web page as a template. A third predetermined portion of the advertising fee may be allocated to a third user who owns the third web page. The third web page may be a web page that was used as a template by the second user to create the second web page or to create a web page from which the second web page was directly or indirectly derived. The first predetermined portion is preferably larger than the second predetermined portion, and the second predetermined portion is preferably larger than the third predetermined portion. The sum of said predetermined portions preferably does not exceed 50% of the advertising fee. The remainder of the advertising fee may be allocated to an owner of a web server hosting said web pages. In some embodiments, the first user may be allocated only the first portion of the advertising fee if the first web site was generated using another web site belonging to said first user as a template.

Further aspects of the invention comprise a carrier medium carrying computer readable code for controlling a computer to carry out any of the above described methods, or to function as any of the above described apparatus.

Some preferred embodiments of the invention include some or all of the following features:
Page Replicability: Users can replicate other modular web pages and tune the replicated copy to the their needs by amending, deleting, or adding meta data (e.g. keywords or tags), modules, content, layouts, access rights of different users, e.g. community settings (such as who can read the site or even edit the site), access rights from different devices, etc. A representation of “parent/child” genealogy-like page relationships may be provided for tracking the origins of web pages created by replication.
Multiple Page and Community Management: A user may own and manage multiple web pages, and the user may invite and allow separate groups of other users to view and/or edit each of the web pages
User Driven Content Selection: Content is automatically selected for a web page according to the relevancy of both the visiting user and the tags of the web page. The tags used may be restricted to those entered by users with appropriate access rights.
Automated tag/keyword driven Channels: Content and module based around any topic is brought together into a single place termed a “channel”, where content is automatically selected for the channel based on relevancy, popularity and age
“Mood” Representation: Metadata is associated with each user, and may represent characteristics of that user. For example, the meta data may include a personal tag cloud, referred to as a “mood cloud”, which represents combinations of tags from any of at least the following seven categories: (i) the user's stated interests, (ii) the user's published content, (iii) the topics on which the user wants to receive advertising; (iv) the tags of the current web page which the user is viewing; (v) the geographical location of the user, e.g. based on the user's ZIP code; (vi) the user's language; and (vii) the preferred advert format selected by the user.
Reputation System: Any user, page, element of the page, advertisement, or any topic a user might chose, can be rated quantitatively and qualitatively through tagclouds, and keywords/tags inputted by a user which may represent the user's opinion on that topic
Tagcloud representation: A tagcloud on a specific topic, i.e. a collection of keywords characterizing that topic, is used to represent the perception of that topic by users, e.g. by tag popularity, time since posting and/or perception of the tag for that topic. A topic tagclouds can be used as a search result on that topic, and as a navigating tool in which any click on a keyword leads to the tagcloud characterizing that keyword.
Tagcloud Management: Any user can select several views about a given topic by generating a specific tagcloud based on several criteria (e.g. gender, location, age of the users inputting tags, and time where these tags where inputted).
Advertising Ranking Algorithm (ARA): Any user can rate each advert that is served to that user. The ad ranking and the amount the advertiser is willing to pay to associate that advert to the relevant keyword/category are then used to increase or decrease the prioritisation of the advert.
Advertising Serving Algorithm (ASA): Any user can influence which adverts they are served based on a combination of the user's “mood cloud” meta data, and how the adverts are associated and prioritised using the ARS above. Adverts served to a user are then stored in a separate table, so-called “moodbox”, where they can be referred to later, the user benefiting from the ratings from the community to navigate and sort the ads.
Ad Boost: The format used to serve and advert may depend on the number of times each particular tag appears within each of the different tag categories used to generate a mood cloud. For example, if BMW appears only as a user interest tag, but not as any of a user's published content tag, a user-selected advertising tag, or a tag on the current web site, then a text advert for BMW would be served to the user. However, if BMW appeared in all four of these categories, then a much bigger and more intrusive advert would be served, such as a video advert.
Third generation revenue sharing: The revenue collected on each page can be shared with the publisher of the page up to the third generation of web page creation, e.g. the publisher gets 30% of the revenue for a web page (i.e. “parent” web page) that they have created, 15% for each child page that has been replicated from the parent web page, and 5% of the revenue for each grandchild page that has been generated from a child web page. In some cases, a publisher can only collect revenues on pages replicated by third parties, not pages they have replicated from their own pages without amending them.

### BRIEF DESCRIPTION OF THE DRAWINGS

Embodiments of the present invention will now be described, by way of example only, with reference to the accompanying drawings, in which:

FIG. 1 is a schematic diagram showing a computer network with a system according to a first embodiment of the invention;

FIG. 2 is a block diagram of a web server in an embodiment of the invention;

FIG. 3 is a block diagram showing a general overview of the web server and ad server system, in an embodiment of the invention;

FIG. 4 is a screenshot showing an example web page layout, in an embodiment of the invention;

FIG. 5 is a screenshot showing a user's personal web page, as displayed to that user, in an embodiment of the invention;

FIG. 6 is a screenshot showing a public web page belonging to the same user, as displayed to that user;

FIG. 7 is a screenshot showing the public web page of FIG. 6, when displayed to a different user;

FIG. 8 is a block diagram illustrating page and community management, in an embodiment of the invention;

FIG. 9 is a block diagram illustrating the content and module structure, in an embodiment of the invention;

FIG. 10A is a screenshot of a blank web page template for generating a new web page without using the “re-mix” process, as displayed to a web page author who is not yet logged in;

FIG. 10B is a screenshot of a blank web page template for generating a new web page without using the “re-mix” process, as displayed to a logged-in user;

FIG. 11 is a flowchart showing a process for generating a new web site from an existing web site, in an embodiment of the invention;

FIG. 12 is a screenshot showing set-up of tags during the generation of a new web page, in an embodiment of the invention;

FIG. 13 is a screenshot showing layout of modules during the generation of a new web page, in an embodiment of the invention;

FIGS. 14A and 14B show a flow diagram of a process for generating a new web site from an existing web site, in an embodiment of the invention;

FIG. 15 is a block diagram illustrating the user ratings and reputation system, in an embodiment of the invention;

FIG. 16 is a screenshot showing individual module setup during the generation of a new web page, in an embodiment of the invention;

FIG. 17 is a flowchart showing a content selection algorithm for selecting content for display in a web site according to the content ratings;

FIG. 18A is a screenshot of a web page that uses a content selection algorithm to automatically select highest rated content and displays this in a variety of modules.

FIG. 18B is a screenshot showing a further example of a web page which obtains its content using a content selection algorithm, in this case showing a “sports channel”;

FIG. 19 is a flowchart showing a process for generating a “channel” web page for a selected topic;

FIG. 20 is a flowchart showing a process for generating a tag cloud for display within a web page in an embodiment of the invention;

FIG. 21 is a schematic diagram showing an example of a tag cloud and associated trends;

FIG. 22 is a schematic diagram showing a graphical display of multiple variables associated with different tags in a tag cloud;

FIG. 23 is a flowchart showing a process for generating a mood cloud in an embodiment of the invention;

FIG. 24 is a partial screenshot showing examples of adverts on a web page;

FIG. 25 is a flowchart showing a process for selection of an advert for display in a particular web page;

FIG. 26 is a process diagram showing the functioning of the Ad server in an embodiment of the invention;

FIG. 27 is a block diagram showing the data structure in the advert database.

FIG. 28A is a block diagram showing a first example of a model for sharing of advertising revenue. FIG. 28B is a block diagram showing a second example of a model for sharing of advertising revenue.

### DETAILED DESCRIPTION OF EMBODIMENTS OF THE INVENTION

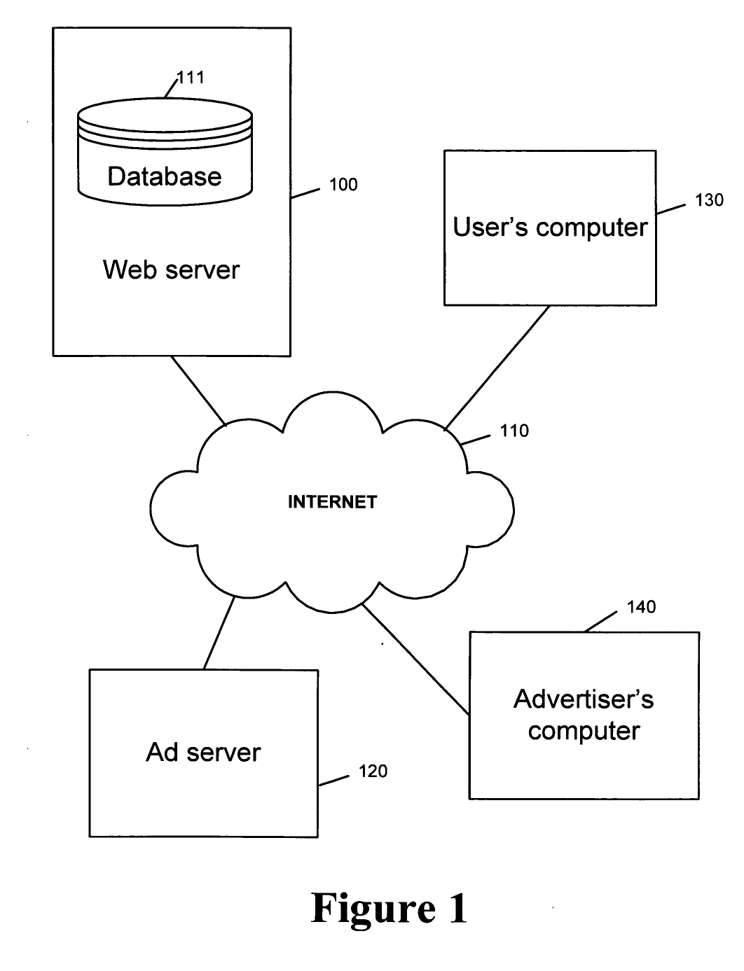

FIG. 1 shows the hardware used in an embodiment of the invention. A web server 100, an ad-server 120, a user's computer 130 and an advertiser's computer 140 are each connected to the internet 110. In this embodiment, the web server 100 includes a database 111 storing modular web pages belonging to different users. In alternative embodiments, the database 111 may be separate to, but accessible by the web server, e.g. via the internet 110 or via an alternative communications link. The ad-server 120 is a third party server providing adverts to be displayed on the modular web pages. The ad-server 120 may store text, graphics, video clips, sound clips, etc, for use in the adverts. The user's computer 130 may request web pages to be downloaded from the web server 100, and the web server may request adverts to be sent from the ad-server 120 to the user's computer. The advertiser's computer 140 may be used by an advertiser to upload new adverts to the ad-server 120, or to perform other administrative tasks relating to the adverts.

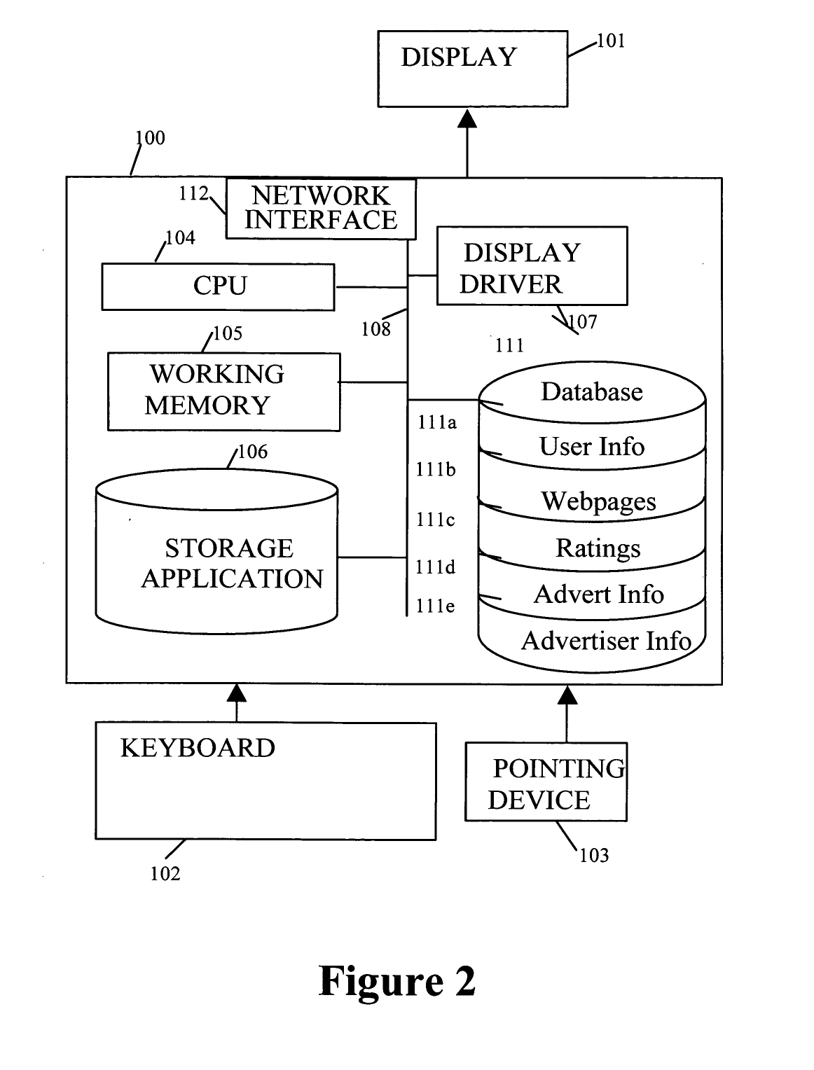

FIG. 2 is a more detailed block diagram of the web server 100 in an embodiment of the invention. The web server 100 includes a CPU 104, working memory 105, display driver 107, storage space 106 for storing applications, a network interface 112, and a database 111. These components are all connected to a central bus 108.

The database 111 includes user information 111a, stored modular web pages 111b and web page components (such as modules, layout, content and access rights e.g. “community settings”), quantitative and/or qualitative ratings 111c (such as web page ratings or module ratings), rankings, advert information 111d, advertiser information 111e, etc. The web server 100 is also provided with a display 101, a keyboard 102 and a pointing device 103. In some embodiments, the keyboard, pointing device, display and/or display driver may be omitted, but if provided, these may allow an administrator to directly edit information stored in the database 111.

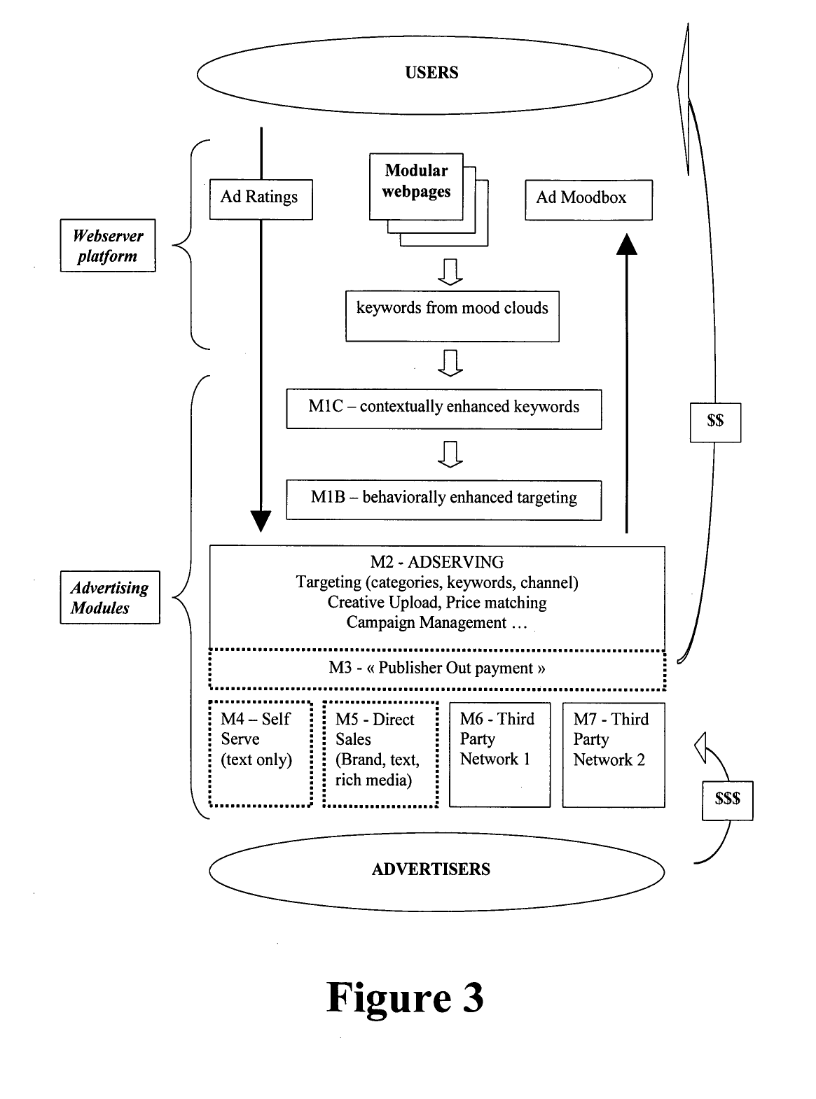

FIG. 3 is a block diagram giving an overview of the web server and ad-server system according to an embodiment of the invention. The users of the system interact with the web server platform, which stores modular web pages and dynamically generated keywords generated from individual stored modular web pages. In some embodiments, the dynamically generated keywords may be enriched by contextual information if there are not enough keywords to match up with the available advert categories. For example, more keywords may be automatically generated by their associations with existing keywords. The set of keywords may also be enriched by behavioural information such as a user's browsing history, to improve targeting of adverts.

In this embodiment, advertisers interact with the advertising modules to upload and manage their adverts. The advertising modules include an ad-serving platform (M2) configured to match up the web page keywords with the available advert categories. The advertising modules also control the pricing of adverts, provide tool features for use by advertisers, and include a payment system (M3) for calculating the revenue made on a page by page basis, to allow a determination of what share of the advertising revenue is due to the web page publisher. The advertising modules include a self-serve platform (M4) which allows an advertiser to directly upload any type of adverts onto the system, and includes management functions and pricing functions. The advert types may include text adverts, graphical adverts, video adverts, etc. The advertising modules may also include direct sales modules (M5) to allow sales teams to directly upload and manage adverts, and third party network interfaces (M6, M7), to receive advertising material from external media sales teams.

Some embodiments of the invention comprise a system for generating modularly structured web pages. The modular structure allows complex and sophisticated web site design, with a range of functionalities. In preferred embodiments, the system may be used by web site designers without the need to have specialist software installed on their computer, and without the need for any specialist experience in web design.

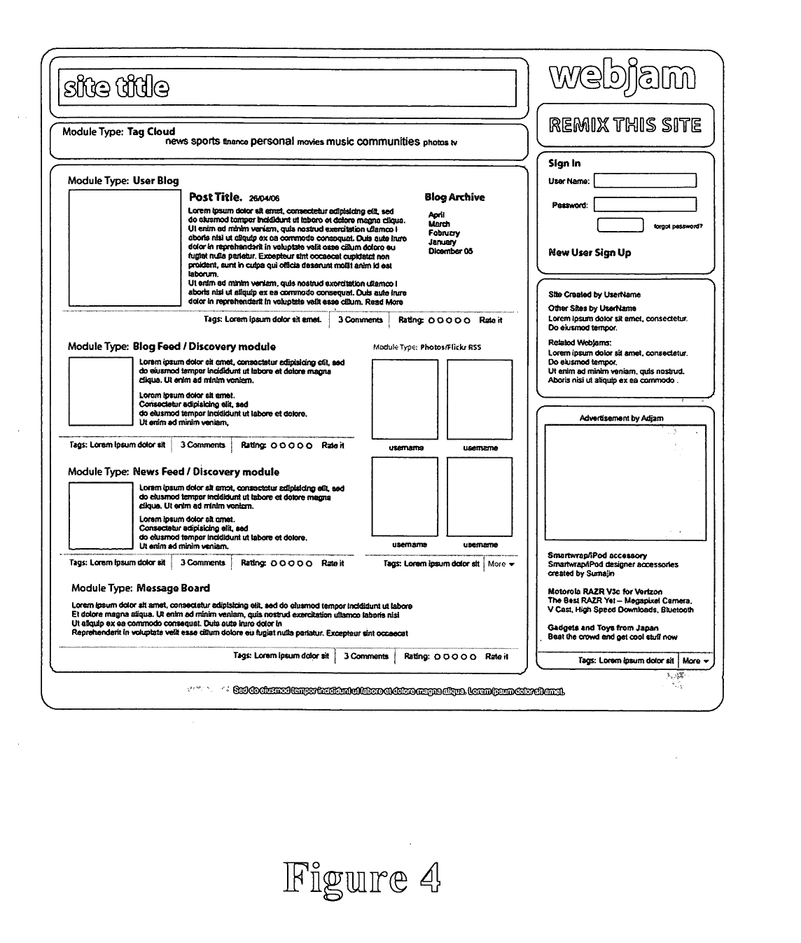

FIG. 4 shows a screenshot of an example modular web page, according to an embodiment of the invention. A modular web page comprises one or more modules, laid out in a page format. Each module provides a particular feature or set of features to the web page. For example, modules may add particular functionalities or particular design features to a web site. The modules provided for construction of a modular web page may include RSS or Atom feeds (e.g. text feeds, image feeds, or podcasting feeds), blogs (such as a personal blog or a blog that other users can post to), pictures, video, audio, email, diary, calendar, clock, message board, interface modules for interfacing to a database or other information source, and advertising modules. These modules may each be configured by a web site designer, according to their individual properties. For example, an RSS or Atom feed may be used to provide constantly updated news or a changing sequence of images on a web site, an interactive interface module may be used to provide access to dictionaries, encyclopaedias or other reference material, and interactive code modules such as java applets may be used to provide on-line games that may be played by users browsing the modular web page. In some embodiments of the invention, it may be possible for a user to configure their own custom modules.

Modules may comprise computer readable code for generating the corresponding features on a web page. Individual modules may include code and data objects, such as html code, XML code, code using other mark-up languages, files (e.g. image files, video files, sound files, data files), database resources, Macromedia Flash files, Shockwave files, Java applets, software or scripts (e.g. ASP, ASP.NET, JSP, PHP, CGI, ColdFusion, Perl, Python, Ruby) e.g. for dynamically generating code or retrieving data from a database, or any other code that is compliant with a user's web browser. Module components may be unique to a particular type of module or may be available for shared use between different modules. In simple cases, modules may simply comprise html code that is inserted into the html file of the web page. Alternatively, a section of code within the html may provide a direct or indirect reference to separate code or data of the module, which is then rendered by the web browser when displaying the web page. A further possibility is that the html code of a web page is generated dynamically, taking into account the modules present on that web page. Individual modules may comprise a combination of different data types or code types.

Modules may have a code structure that includes fields for holding information about the particular settings of the module contents, e.g. username and password settings for an email account so that the contents of the email inbox may be displayed on the page. The code structure of each module preferably includes a definition of the type of content that will appear when the module is rendered to the web browser, and this definition may be stored as a specific type field. Fields may be used to store formatting and layout information for that particular module.

The code defining the web page may also include content and layout sections. The layout section may include information defining the desired layout of different modules on a user's screen when displayed, such as displayed size, position, colours and pattern. Predetermined layouts may be provided for defining design features of the web page, such as borders, backgrounds, colours, patterns, layouts, etc, or some combination of these. This may provide a certain design theme or a particular “look and feel” to the web page.

The content section may include displayable information that is available to be displayed within particular types of modules, and general information for the web site. In preferred embodiments of the invention, content may be labelled with an identifier of a parent modular web page. The parent modular web site is the web page on which the content was originally created, and where it will be initially displayed. Content may be indexed or tagged, e.g. to identify its subject matter and to allow it to be displayed on other modular web pages. Content on modular web pages may, in some instances, be automatically selected for particular modules, e.g. through use of a content selection algorithm, which will be described below in more detail. The module and its selected content may be rendered into HTML and displayed to the user who is visiting the web page.

In FIG. 4, the web page has a title in the top left area of the screen, and a short collection of words describing the web site content listed below the title. The screen is divided into a contents section on the left side, and a login/advertising section on the right side. The content area of the screen contains several different modules, each including text and images (which are represented by dark grey shading). The modules are distinguished from each other on the screen by each having a shaded background, to distinguish it from the white background of the web page. The upper right part of the screen shows a user log-in interface, to allow a user viewing the web page to log in to the system. A selection of adverts is displayed below the user log-in interface. The screen layout and the process of selecting these adverts will be discussed in further detail below.

Preferably, each module has an access level setting to determine which users can view or access the module when it is displayed on a web page. For example, the following access settings may be provided:
Public: Everyone can view and access the module
Logged-on users only can view and access the module
Community: Only users with certain access privileges (such as members of a “friends” list) can view and access the module
Private: Only the owner of the modular web page containing the module can view and access the module

Modular web pages may be owned by particular users who are registered on the system. Each registered user may create and manage several modular web pages. These may include corresponding public, community and private web pages, which have the same set of public modules in each, but where private modules (such as email) only appear on the private web page, and may be omitted or substituted by another module with greater access rights on the community and public pages. Similarly, modules with “community” access rights may appear on the Community and Private web pages, but may be omitted or substituted by another public module on the public web page.

In some embodiments, a single user may have several web pages, where each relates to a different “community” with a different “friends” list. For example, one community may relate to the user's local neighbourhood and another community may relate to a sports club to which the user belongs. To add a new “friend”, the user may click an “Add to friends” button which is provided on the user's profile page. Then the “friend” may be prompted to which of their modular web pages they wish to add this user as a friend and therefore allow this user access to the community view. The “friends” list may comprise any list of email addresses or user IDs that is selected or approved by the web page owner.

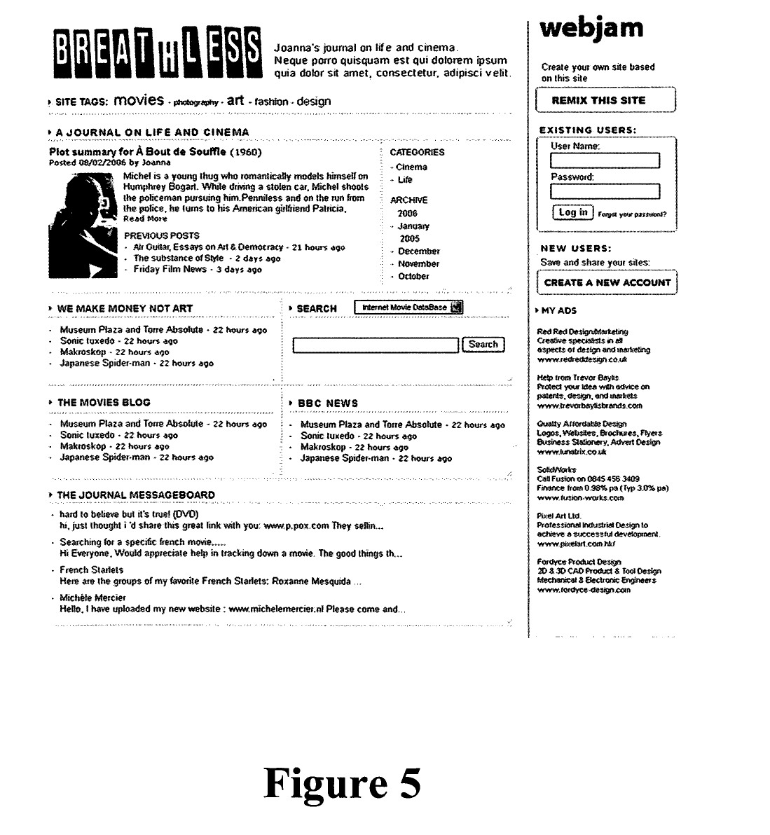

FIG. 5 shows a screenshot of a further example of a modular web page. The layout is slightly different to that in FIG. 4. The web site has a title in the top left area of the screen, and a short description of what the site is about. In this example, the title is “Breathless”, and the site is “a journal on life and cinema” by a user named Joanna. The screen is divided into a contents section on the left side, and a login/advertising section on the right side.

On the left side, below the title of Joanna's web page, is a “site tags” section. The “site tags” are words and phrases used as labels in order to identify the content of a web site. Preferably, each tag is a one word descriptor. In preferred embodiments, tags are not predetermined categories, but new tags can be created as required by a user. In this example, the tags shown are “movies”, “photography”, “art”, “fashion” and “design”. The size of each tag indicates its relative importance.

Below the “site tags” section, the content area of the screen contains several different modules, including a Journal module at the top left of the content area, a web site index on the top right, a first Blog module below the Journal module, an interface to a search engine below the web site index, a second blog module below the first blog module, an RSS feed to BBC news, and a journal message board at the bottom part of the content area.

The upper right part of the screen shows a user log-in interface, to allow a user viewing the web page to log in to the system. The user log-in interface includes input fields to enable a user to enter their username and password. Below the user log-in interface, a button is provided to “create a new account” for users who are currently not registered with the system. If a user was already logged in when viewing Joanna's web page, then instead of a user log-in interface, a profile of the user may be displayed at the top right section of the screen.

At the top of the user log-in interface, a “remix this site” button is displayed, to allow a logged-in user to generate a new web page, using the current web page as a template. In alternative embodiments, this button may be labelled with the term “replicate” or “clone” instead of “re-mix”. If a user who is not logged in selected this remix button, then in preferred embodiments, a request will be displayed to the user to log-in or register and log-in, before creating the new web page.

A selection of adverts is displayed below the user log-in interface. In this embodiment, the designated area for adverts is used to display text adverts. Each text advert may be allocated an equal amount of space, or text adverts may be allocated different amounts of space, e.g. depending on their size, priority or other requirements. The number of adverts displayed may be fixed or may be selected according to the amount of available space for display. The text may be formatted, for example using different colours, different fonts, different sizes, bold, italic, underline, etc. In alternative embodiments, the adverts may include images, video clips, sound effects, etc. The process of selecting the adverts from an advert database is discussed in further detail below.

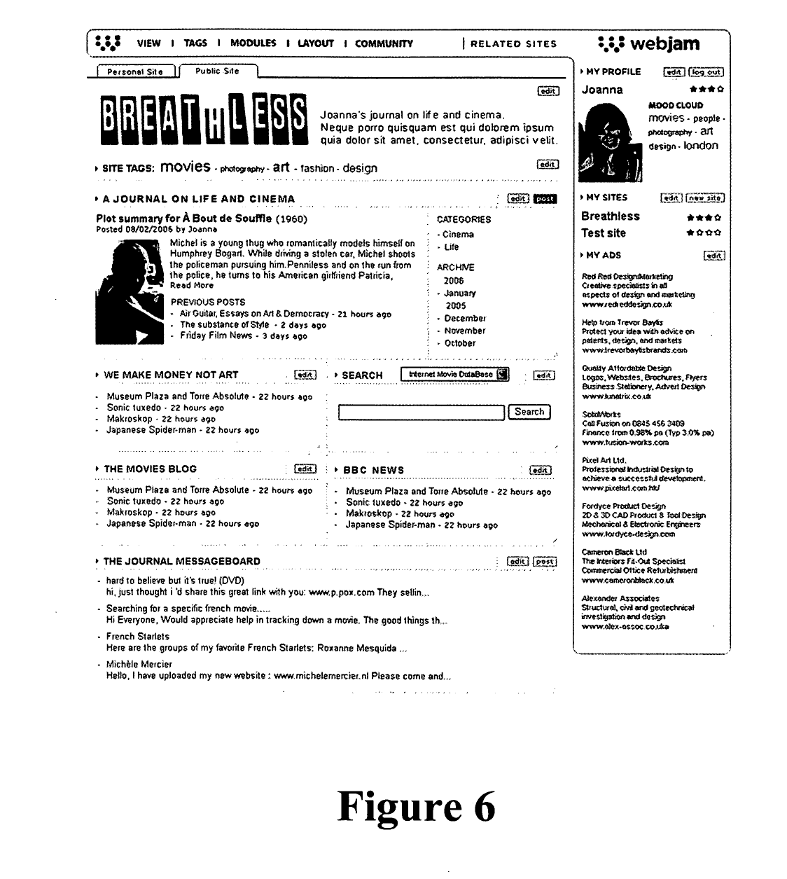

FIG. 6 shows an example of the same web page as shown in FIG. 5, when the owner of the web site is logged on. Instead of a user log-in interface, Joanna's profile is shown in the top right hand side of the page. Her profile includes her photograph, her mood cloud (which includes tags that she has set, indicating her interests of “movies”, “people”, “photography”, “art”, “design”, “London”) and her rating by other users (which is three out of four stars).

When a user logs in and views their own web pages, that user may be presented with the option of viewing different access levels of their web site. In some embodiments, as a default, logged-in users may automatically view all modules on their own web pages, unless the user selects a view with a different access level. Above the web page title in FIG. 6, access tabs are provided to allow Joanna to access the site with a personal (i.e. private) access level, or a public access level. In this case, the “public” access level is selected.

When viewing her own site in “public view”, Joanna will see the same set of modules as displayed to any unregistered user browsing her web site. However, she also has the option of editing any of the modules, i.e. each module has an “edit” button to allow her to edit its contents and layout. Likewise, the title and Joanna's profile also contain “edit” buttons. The top of the screen has further edit options, to allow editing of the web site as a whole. These include buttons to “view” and to edit “tags”, “modules” and “layout”, including the option of allowing new tags to be added to the page, new modules to be added to the page, and the overall page layout to be modified. A “community” button is also provided at the top of the screen, to allow a user to set up community access to the web page, e.g. access for a named list of users. These edit options at the top of the screen are only displayed in this embodiment because the owner of the web page is viewing it. If a different registered user or an unknown user was browsing this public web page, then the “edit” buttons and other edit functions would not be displayed.

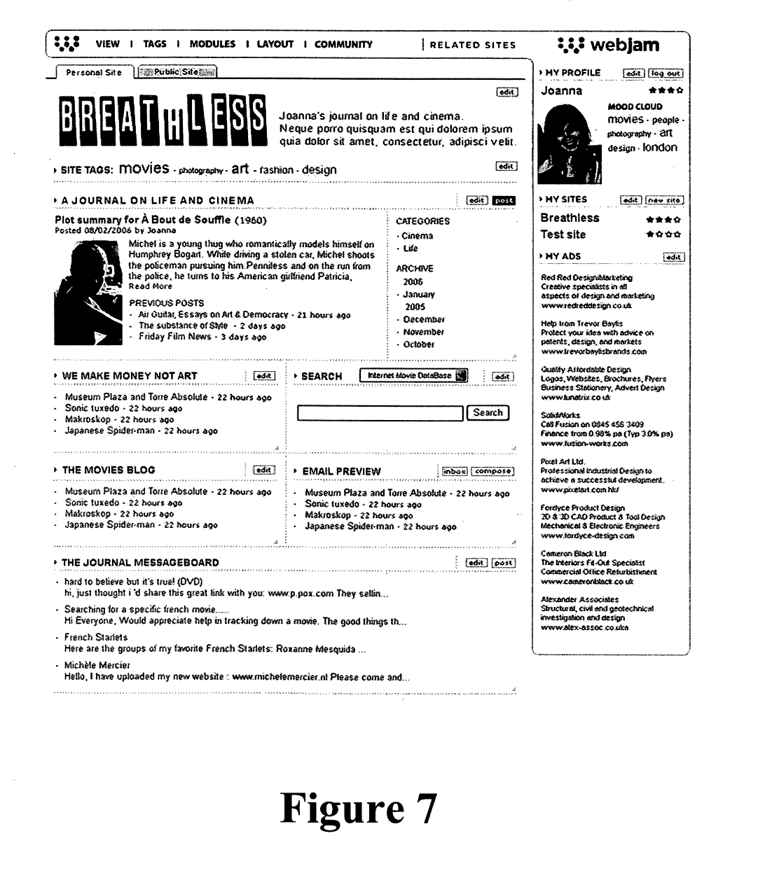

FIG. 7 shows Joanna's private view of her own web site, which she can select with the access level buttons that are located above the web page title. In Joanna's private view of her web page, the RSS feed to BBC news has been replaced by an email module, providing a shortcut to Joanna's personal email. As the shortcut to email is a private module, it will not appear in any corresponding public web page.

In embodiments where a single registered user owns a web site with multiple access levels, anyone with suitable access rights may be able to view the access tabs (e.g. someone belonging to a particular community group may be able to select between the public web page and the community web page). Users with read access to particular modules may also be given edit rights to some or all of these modules.

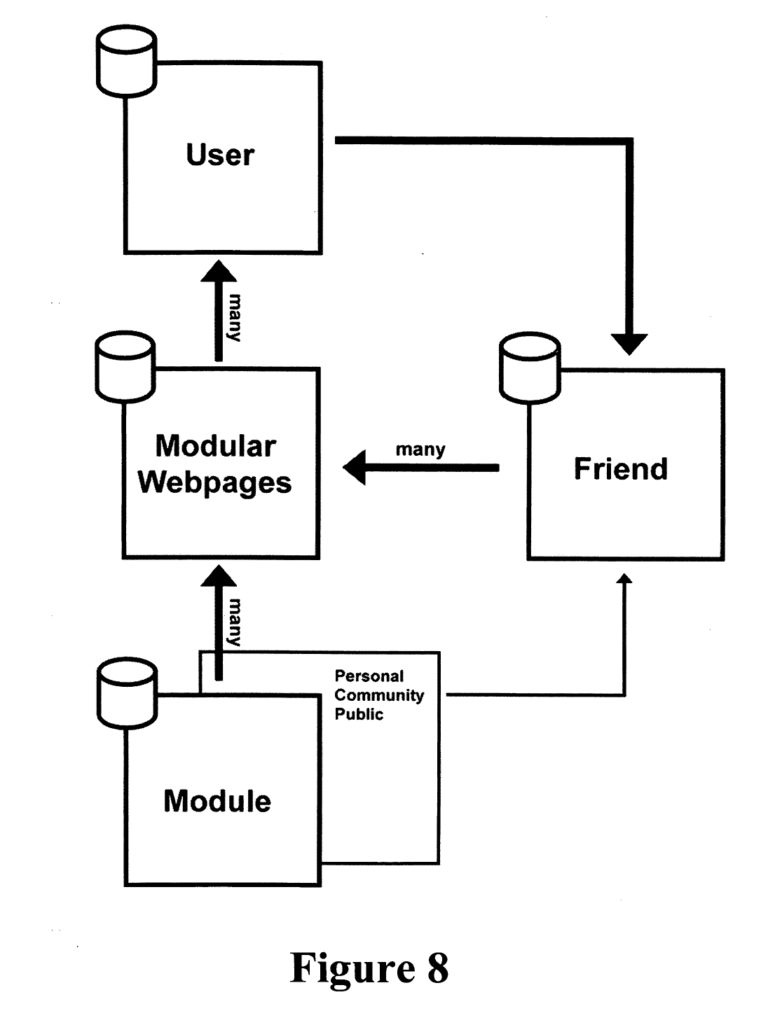

FIG. 8 is a block diagram showing the page and community management structure. The arrows between the boxes of the block diagrams represent relationships between the items they represent. The top box represents a user who owns multiple modular web pages (represented by the middle left box). Each modular web page is build from a plurality of modules (represented by the bottom box). The user may allow several of their friends (represented by the right hand box) to access these web pages at “community” level. A “friends list” may be set up for each individual module, to determine who has access rights to the module.

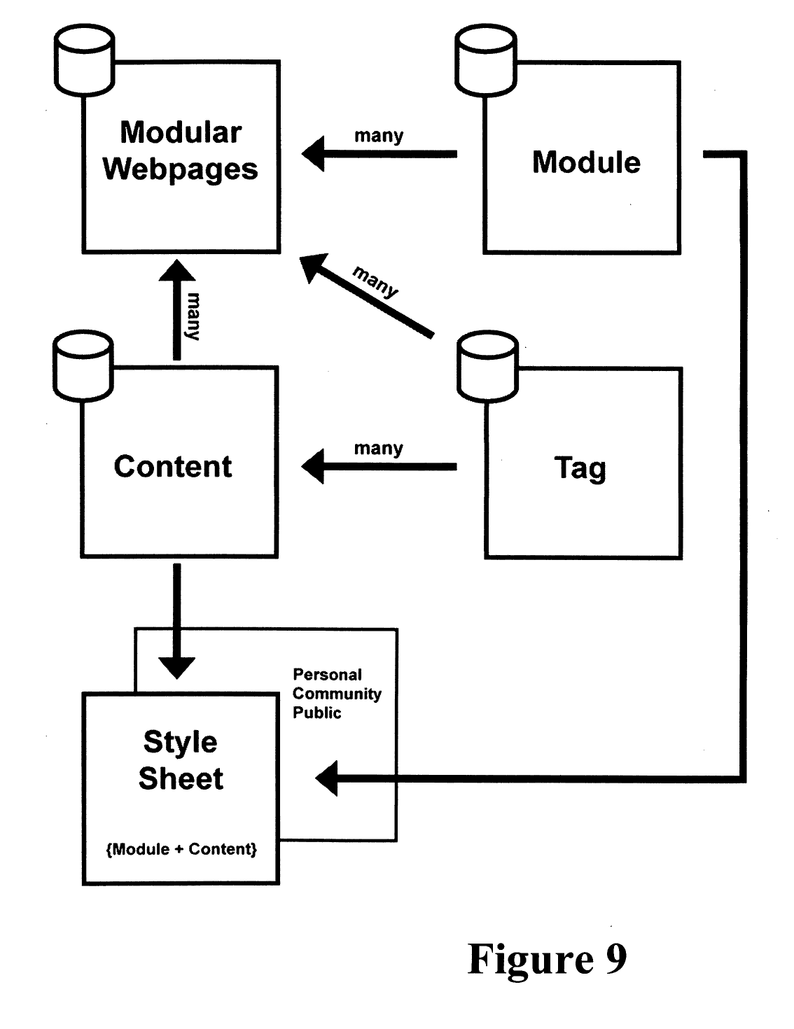

FIG. 9 is a block diagram showing the content and module structure. The top left box represents a modular web page. This modular web page may include several modules (represented by the top right box), several items of content (represented by the middle left box), and several tags (represented by the middle right box). The content may also include tags, which are associated with particular content rather than the modular web pages or modules in which the content is used. A style sheet or layout (represented by the bottom box) allows modifications to modules and content. The content within this style sheet is automatically selected by a content selection algorithm, which is described in more detail below. In other modules, a user may select the content that they wish to have associated with a particular module, or the user may set up parameters to determined the scope of the content.

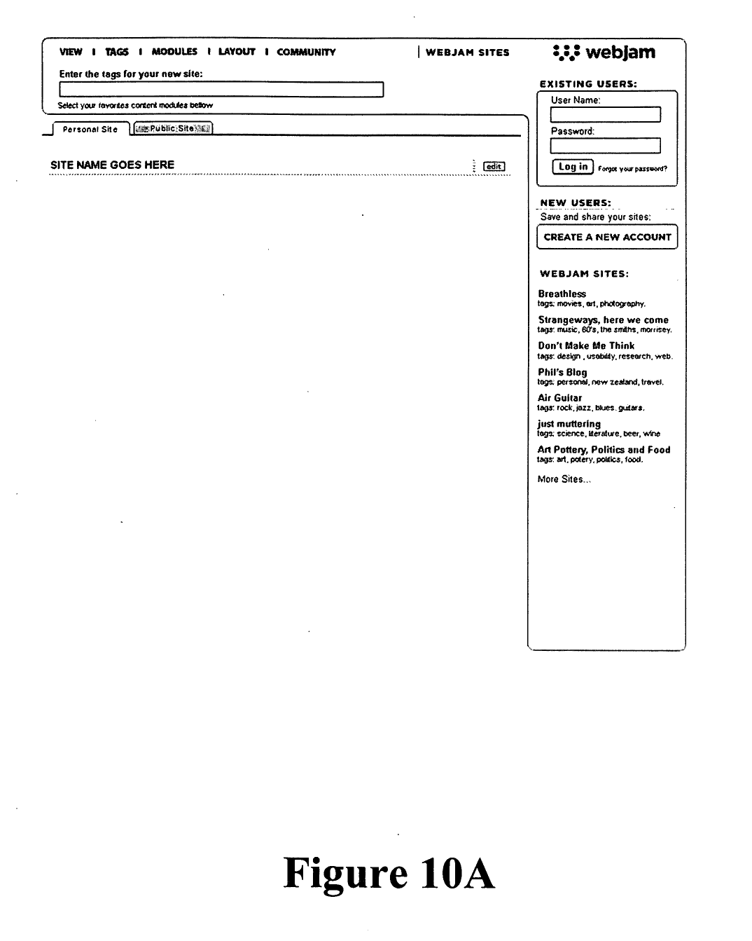

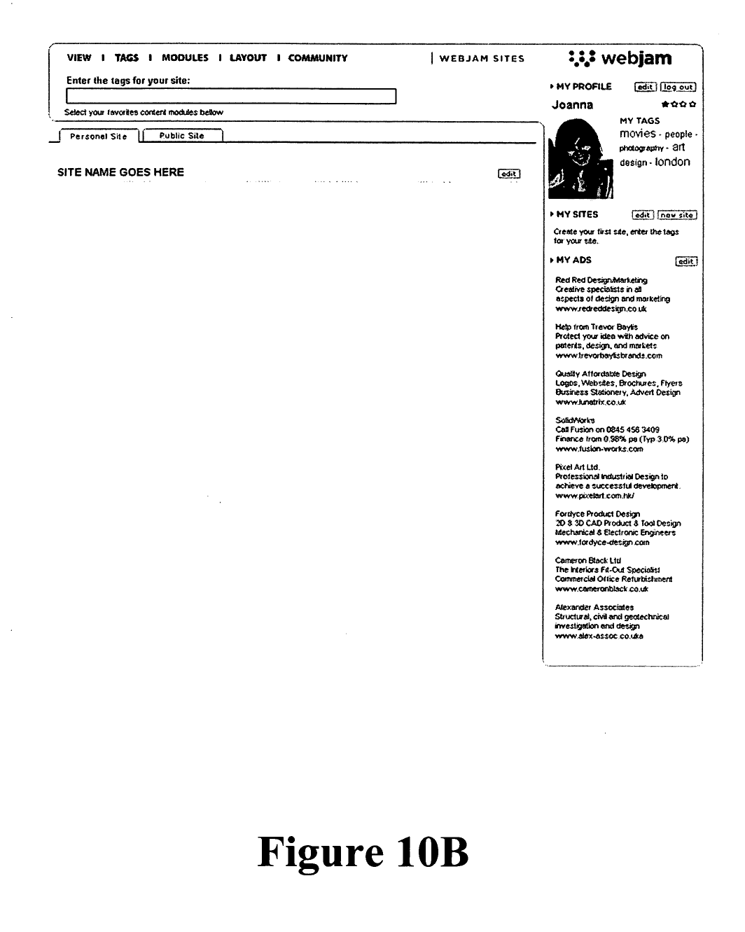

FIGS. 10-16 relate to the generation and editing of a new modular web page by a user. This may be done using another modular web page as a template, and is then referred to as a “replicate” or a “remix” operation. Replicating thus allows a user to copy an existing modular web page and then change it to suit the user's own needs. Any user may replicate a modular web page that they have selected.

Alternatively, a modular web page may be generated without using an existing web page, e.g. by adding modules to a blank page, or using predefined templates. For example, this option may be made available via a menu on an administration web page, or via a link on one of the user's existing web pages. A blank page may then be presented to the user, to allow the user to select modules to be added, or the user may be presented with a selection of templates. FIGS. 10A and 10B show examples of screenshots where a user is presented with a blank page to allow them to create their own site without using an existing web page. FIG. 10A shows a screenshot where a user is not yet logged on. A blank input box is provided for the user to enter tags for the new site, and tabs are provided at the top of the page to allow a user to add modules to the page and to modify the page layout. An “edit” button is provided to allow the user to modify the site name. The user may create a web page before logging on to the system, but this web page will only be published on the internet after the user has logged on.

FIG. 10B shows a screenshot where the user “Joanna” is logged on. The left hand part of the screen, where the new web page layout will be created, is identical to that in FIG. 10A. However, in the right hand part of the screen, Joanna's profile is shown, including her name, photo, rating and tags. Below her profile, a screen area is allocated to listing the modular web sites that she has previously created. In this case, the list is empty. Below the “My Sites” section, a selection of adverts is shown. These adverts have been selected and saved by Joanna for future reference. If no adverts had been saved by the user, this section of the screen may show a selection of adverts that had been selected using the particular user's mood cloud.

In preferred embodiments, it is likely that many modular web pages will be created using the replicate functionality. When a user views any modular web page, regardless of how it was originally generated, the user is preferably presented with the option of creating a new modular web page by editing the current modular web page. Thus, any modular web page may be made available for use as a template for creating and publishing new web pages. Preferably, each modular web page is provided with a “remix” button for this purpose, which a user may select in order to create a copy of the web page for editing and modifying according to the user's preferences. For example, in FIGS. 4 and 5, the “Remix” button is displayed at the top of the right hand column on the screen, when a user browses a modular web page. When the user clicks on the “remix” button, they are prompted to enter a name for the new modular web page and then given a choice of URLs that are available. Once the user selects a URL, the process of remixing the site begins.

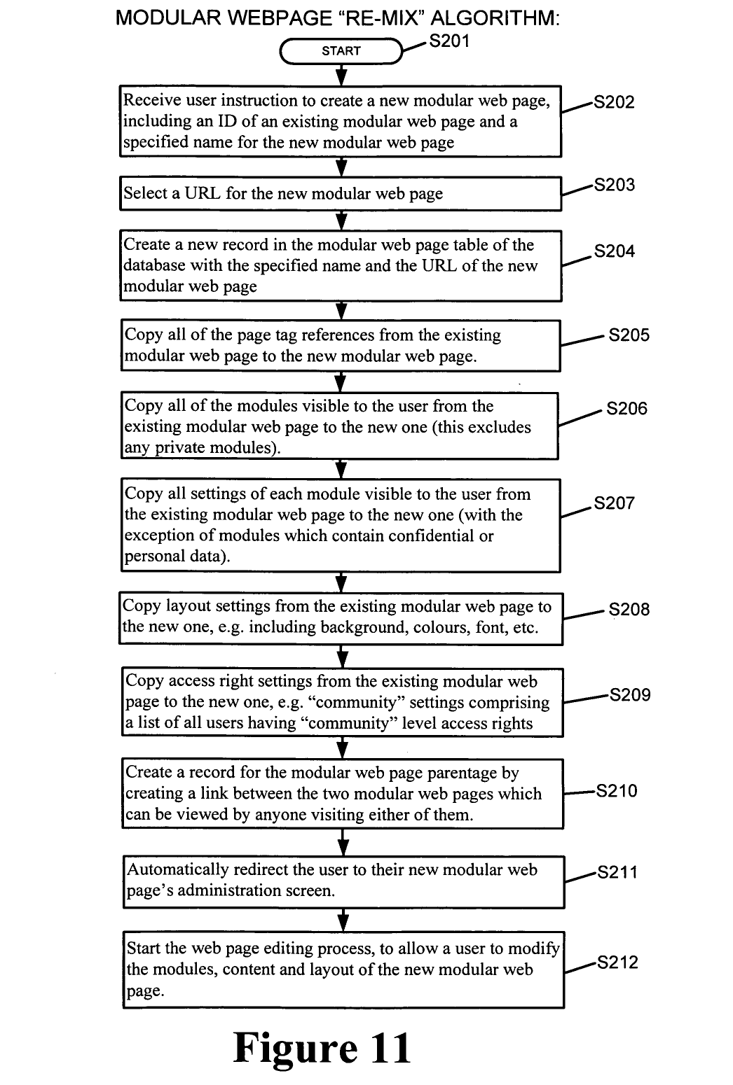

FIG. 11 is a flowchart showing an example of the “re-mix” process, in which a new modular web page is created. The process assumes that a user has already logged in, and can be identified by the system, although in practice, it is not essential for a user to log in before starting to create a new web page. The process begins at step S201. Then, at step S202, the server receives a user instruction to create a new modular web page. The server also received an identifier of an existing modular web page that is to be used as a template for the new modular web page. This is preferably included as part of the instruction to create a new page. The server also receives a specified name for the new modular web page from the user.

Then, at step S203, the server selects a URL for the new modular web page. In one embodiment, all allocated URLs may have a common domain name (e.g. www.modwebpages.com) and the URLs are specified as locations within that domain name (e.g. www.modwebpages.com/Joanna/homepage.htm). Alternatively, a plurality of domain names may be available for allocation (e.g. all having the same root), or a user may be given the option of purchasing, registering and using their own domain name if this domain name is available.

Next, at step S204, a new entry is created in the database 101, in the “Modular Web Page” table, specifying the name and the URL of the new modular web page. The process then continues to step S205, where all of the page tag references are copied from the existing web page to the new modular web page. These page tag references identify the subject matter of the current web page. Next, at step S206, all of the modules from the existing web page that are visible to the user are copied to the new modular web page. This means that if the user is a member of a “Community” group for the original modular web page (e.g. as a result of being on the “friends” list for the original web page), then any modules with “community” level access will also be copied to the new web page. If the user is not a member of the “friends” list, then modules with “community” level access will not be copied. All public modules will be copied to the new web page. However, unless the publisher and relevant friends have given explicit permission, none of the private modules will be copied to the new modular web page.

The settings of all copied modules are also copied to the new modular web page, at step S207. Normally, all settings are copied except for private settings or those which contain confidential or personal data, e.g. the settings of the email checking module would not be copied over (unless the owner of the original modular web page has decided otherwise).

Next at step 208, the layout settings are also copied from the existing modular web page to the new modular web page, allowing it to keep the same background, colours, font, etc.

Next at step 209, the user access settings, such as the community settings, are also copied from the existing modular web page to the new modular web page, e.g. including a list of all users having rights to access the initial page. In some embodiments, users may be given the option of opting out of having their access rights copied during the replication of a web page. For example, a web site owner may choose not to have access settings copied to any web page replicated from their web site, or an individual member of a community access list may choose not to be given access rights to some or all new web pages that have been replicated from the web page to which they originally had community access rights, e.g. dependent on the identity of the new web page's owner.

Next, at step S210, a record is created in the database, linking the original “parent” modular web page with the new modular web page. In preferred embodiments, a hyperlink is provided from the original web site to the new web page, and from the new web site to the original web page, to allow a user viewing one page to access the other. This feature may be present on all modular web pages. Alternatively, this link may not be directly present on the web page itself, but may be accessible using a selection tab on the web site to access “related web sites”.

The web site creation process is now completed, at step S211, and the user is automatically directed from the original modular web page to the new modular web page. From now on the new modular web page is treated just as if it were one of this user's existing modular web pages. At this stage the new modular web page will have exactly the same public modules and tags as the existing modular web page which is being remixed. At step S212, the user may then begin the process of editing and customising their new modular web page, e.g. by changing the modules, content and layout. When a user enters “new page edit mode”, they can chose between entering or modifying page tags, adding or removing modules, changing layout and colours, selecting publishing preferences, entering text, etc.

The above described steps may be performed in a different order from that described above, or some steps may be combined, e.g. the layout and access settings may be copied before or at the same time as the module settings, and a URL may be selected after the components of the new modular web page have been copied.

When a user is ready to have a web page published, they must register with the system if they haven't done so already. The new page will then be published with that user's ID as page author.

Users may enter tags which specify the content of their web pages using the tag entry screen provided by the administration system. Tags are entered by typing into a text field. The text field may suggest matching tags that are already found in the database after 3 characters to help the user select tags more quickly. If a tag is entered that does not currently exist in the database, it may be automatically created when the user has finished typing into this field.

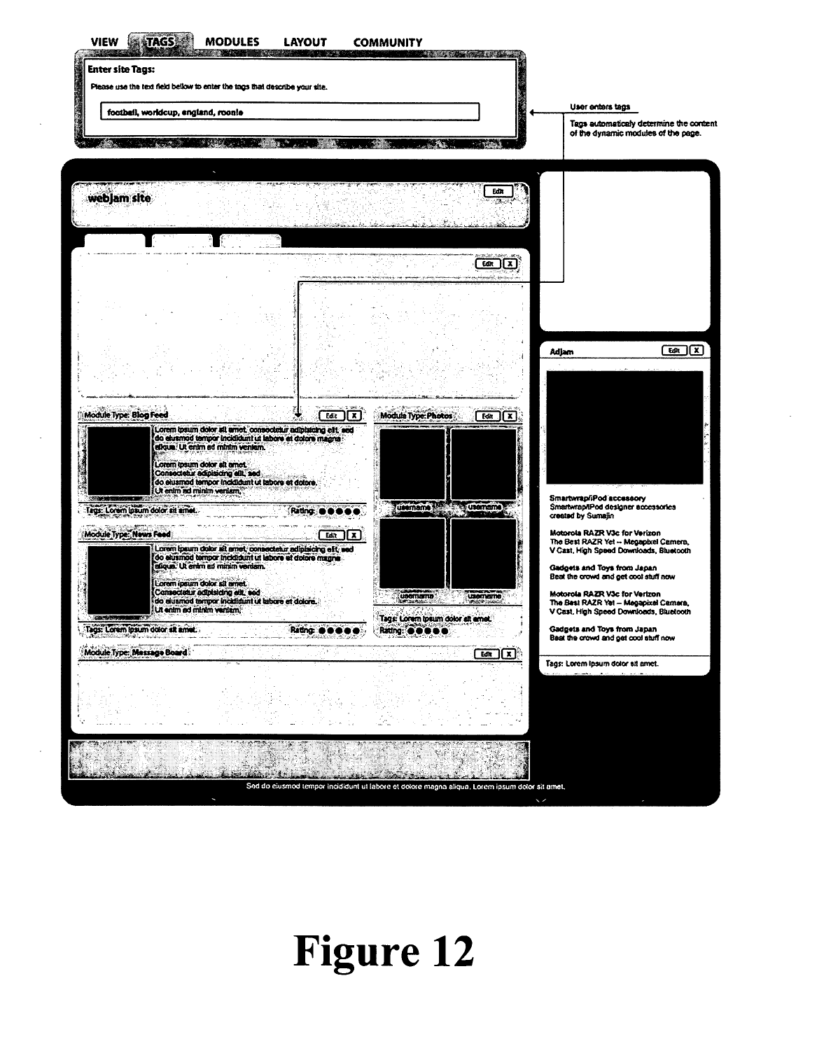

FIG. 12 is a screenshot of a new page creation process, in which tags are being entered. The screenshot shows a menu at the top, containing tabs labelled “view”, “tags”, “modules”, “layout” and “community”. The “tags” tab is selected. Below this menu is a text entry box with entry fields for site tags The tag entry box has the following tags entered by a user: “football”, “worldcup”, “england”, “roonie”. Below the tag entry box is displayed a module layout. The module layout may initially be the same as that of a remixed source web site, and may be edited by a user as required. To edit the module layout, the user may select the “modules” tab in the menu at the top of the screen.

In one embodiment, users may edit their modular web pages using a Drag & Drop GUI (graphical user interface) which is displayed when the user is surfing one of their own modular web pages. This enables the editing of the position and size of modules, the content within each module, the type of content in the module and any settings that apply to it. The user may drag new modules into their module list by utilising the JavaScript and AJAX interface.

A user may set up new modules by dragging and dropping from a list of available modules. Each module may have its own “edit” button, to allow a user to edit the module. Activation of the “edit” button may initiate an edit mode, in which interactive controls are displayed on the user's computer screen to allow the user to make edits, e.g. changing colours and graphics within a module, or editing the style sheet. Preferably, these controls permit drag and drop editing. When a user edits a module, that module may in some embodiments be automatically resized to occupy a larger area of the screen, or may simply be displayed within the currently allocated window.

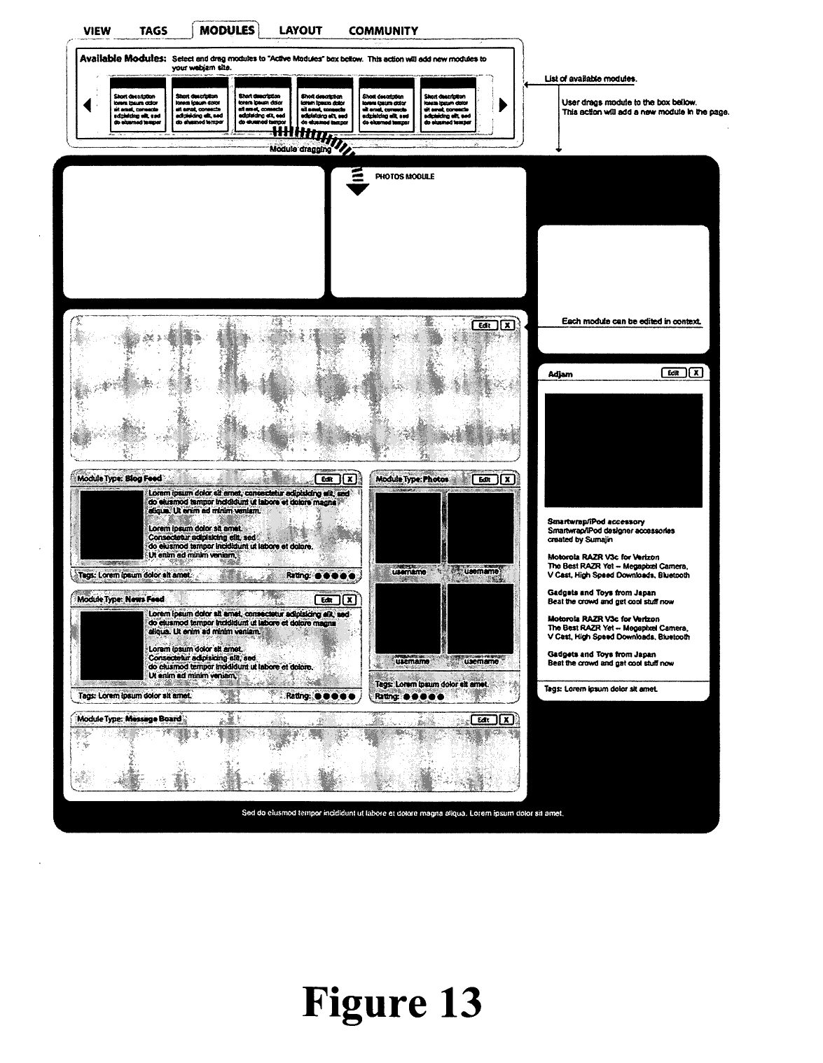

FIG. 13 shows a screenshot of module editing, after a user has selected the “modules” tab. The same menu as in FIG. 12 is also displayed in FIG. 13, with the “modules” tab now highlighted. Below the menu, a scroll box is displayed, showing a selection of available modules for addition to the web site. Six different modules are shown in this scroll box. In this example, these are “Blog Feed”, “News Feed”, “Photos”, “Rich Text”, “Mood” and “Search”. Scroll arrows are provided on the sides of the scroll box, to allow a user to display further module options. Each module is displayed in the scroll box as a square with a title bar containing a module title and text describing the module in more detail. To add a module to the web page, a user may drag one of the modules from the scroll box to an “active modules” area of the screen. In some embodiments, by dragging the module onto the active modules area, the module is automatically positioned on the page. Alternatively, the user may drag and drop the module to a desired location on the page.

After a user has selected desired modules for a page, these modules may be edited. Each module area on the screen is provided with an “edit” button and a “delete” button, to allow a user to select particular modules for individual editing or for deletion. Each module area may also be provided with an “access level” button and/or an “add this module to my page” button. Each module area on the screen is also displayed with a module title, module tags, a module rating, and the module contents. The module title in FIG. 13 is the module type, but alternatively, the title may customised for each individual module. The rating will be discussed in more detail below. The module tags and content may be edited by selection of the “edit” button.

In some embodiments, a user may publish new content to their modular web page by using a publishing system such as a standard blogging platform which is integrated into the administration system. After creating a blog entry, the user may then specify the tags in the same way as specifying tags for a modular web page. Users visiting a modular web page may also tag content that they have not created. These tags will have a lesser weighting than those added by the author of the content.

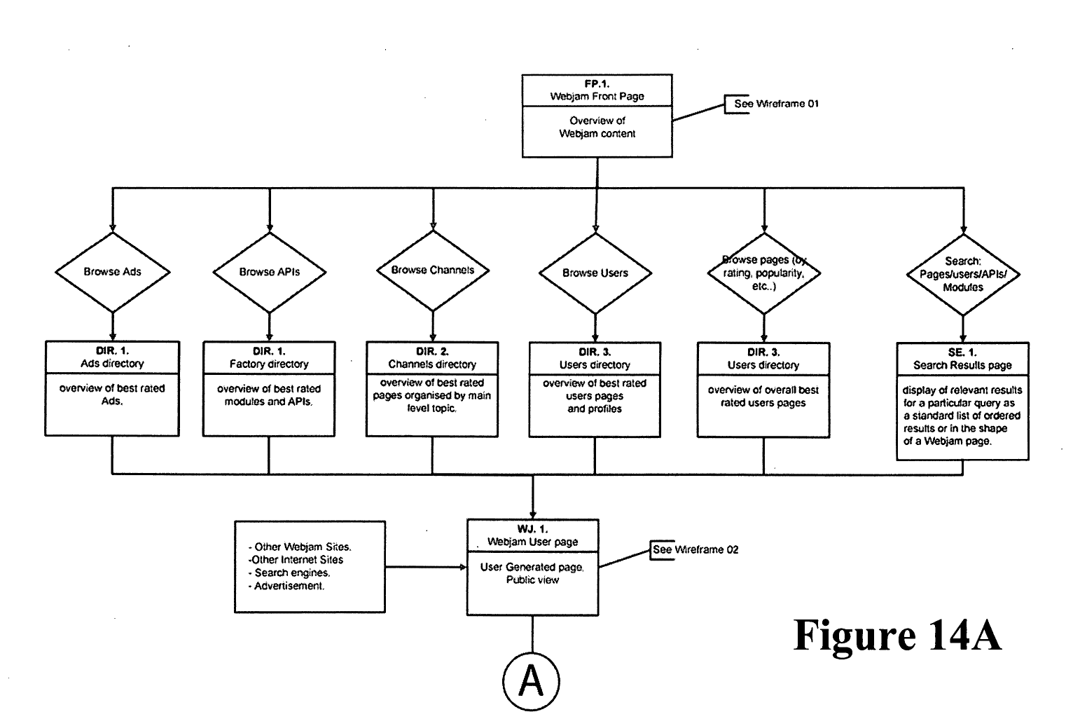

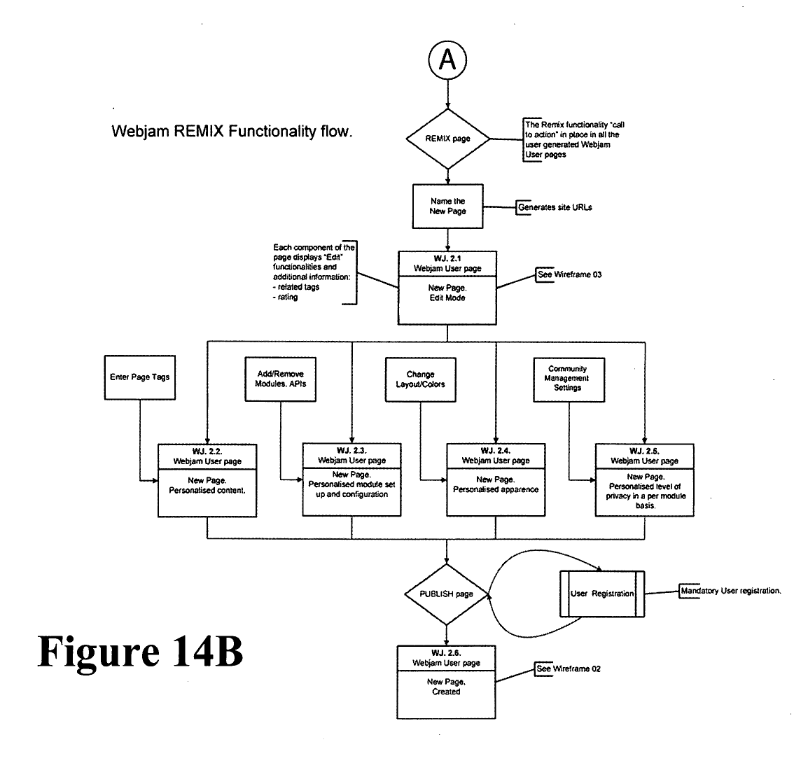

FIGS. 14A and 14B show a flow diagram of some of the features available to a user of the modular web page system. These two figures link at reference (A) to form a single flow diagram. In this embodiment, a user may start either by viewing a homepage of the system, which provides links for browsing through the available modular web pages, or alternatively a user may start by navigating to any one of the modular web pages, e.g. by following a link from other web sites, search engines, advertisements, etc.

From the homepage of the modular web page system, a user may select to browse through the available web pages, adverts, modules and layouts (including those that have been made available by third parties by using APIs), channels, users pages and user profiles (e.g. by subject matter, popularity, rating, etc). For example, when a user selects to browse a particular type of material, this material may be presented to them with an overview of the best rated examples. The user may select a broad subject area, and be presented with a list of sub-topics, together with the best rated content in each. A user may also be provided with a search interface, to allow searching for particular content within any web pages, modules, adverts, etc. The user may specify where they would prefer to search for content, as well as the type of subject matter they are searching for. Again, the results may be presented in order of rating. Alternatively, the results may be presented in a different order, such as according to creation date, author, geographical location, correlation with the user's interests, etc, or some combination of factors.

A user viewing a modular web page may be able to rate the web page, to provide a means by which other users can assess its perceived quality. In one embodiment, any of the following elements can be rated by users viewing a modular web page:
Individual web pages
Individual modules within a web page
Layout of a page
Particular content
Other users
Adverts

Where individual users are given ratings, these ratings may be used to calculate a user reputation score, which may be calculated as the average of the ratings given to the users themselves, the ratings given to their modular web pages, the content of their modular web pages and any custom modules that they have created.

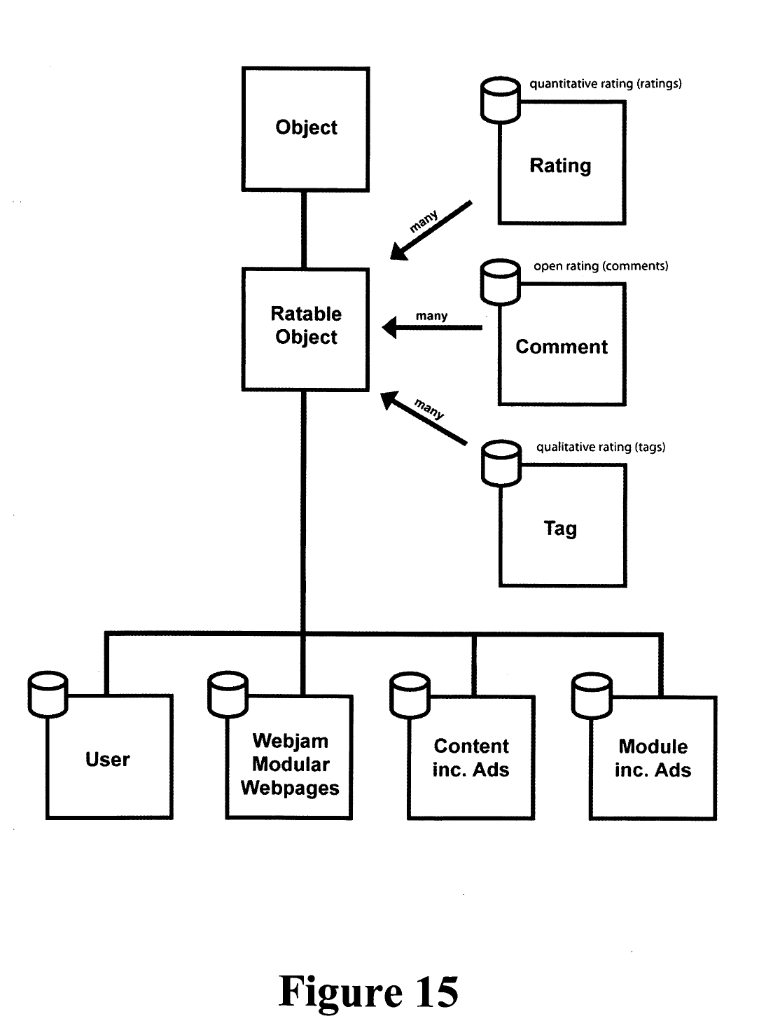

FIG. 15 is a block diagram showing the user ratings and reputation system. The system comprises objects, as represented by the top box, and some of these are rateable objects, as represented by the box below. The bottom four boxes, from left to right, show the particular options for rateable objects, which comprise users who own modular web pages, modular web pages themselves, modular web page content (including adverts), and modules (including advert modules and layouts). Each web page, content item and module may also be associated with a particular user, e.g. the author. The right hand side boxes represent different types of ratings. Ratings may be allocated to any rateable object. Ratings may include quantitative ratings (top right box), open ratings comprising comments by users (middle right box) and/or qualitative ratings comprising tags allocated by users (bottom right box), thus forming a tag cloud which is known in that case as a “reputation cloud”.

For the quantitative ratings, users may rate items by selecting a score for each item (e.g. a number of stars out of 5 stars), which creates rating meta data associated with the item. In one embodiment, a score selection popup window may be configured to appear on the user's computer screen when the user's mouse is hovered over a rateable item, and a mouse click may enable selection of a score.

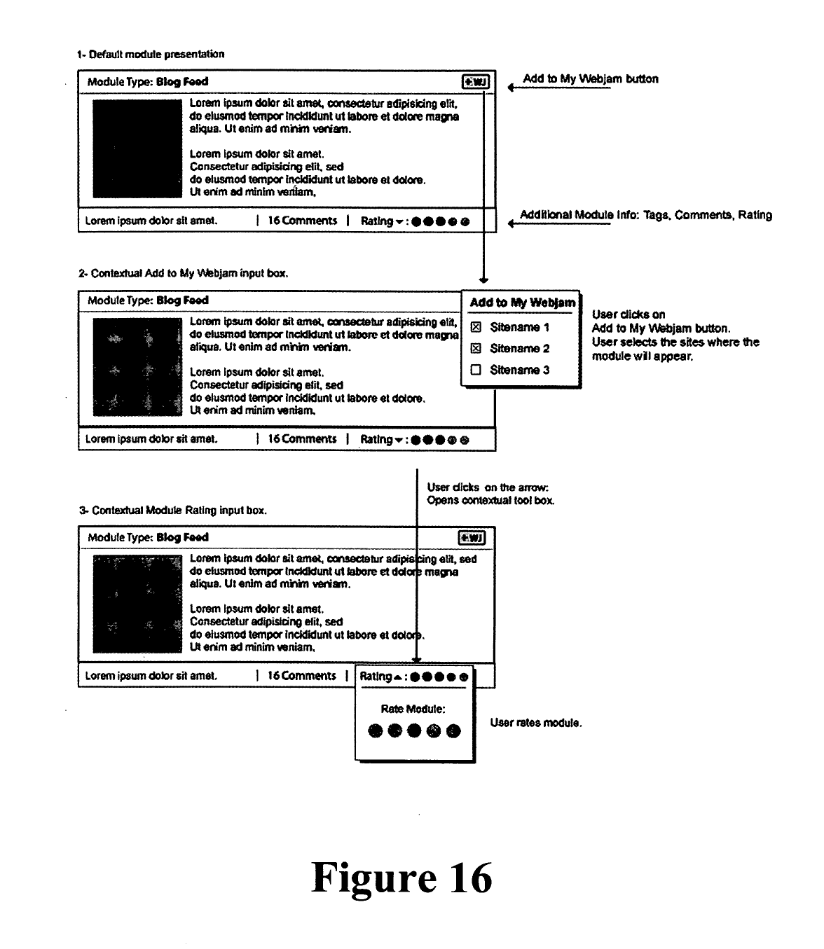

FIG. 16 shows a user interface to allow a user to rate modules. In this example, three partial screenshots are shown, each relating to the same “Blog feed” module. Firstly, a default presentation of the module is shown, in which only module is displayed, with a module title at the top of the module area, an image area at the left hand side, and module text on the right hand side. Of course, the actual layout depends on the module type, for example, an email module may not have any associated image, and a search module may have a user input text box. An area for module tags, module ratings and user comments is shown at the bottom of the module area. The tags part of this area is shown as containing 5 tag words which have previously been entered by a user. The user comments area has a single line of text displayed, with a “more” button to expand this. The user ratings area shows five small circles arranged in a line, with three out of the five selected in a darker colour to indicate a score of three out of five. Each of the tags, ratings and comments areas is provided with an edit control, in this case a triangular button, which a user can activate to edit the tags, rating or comments. The tags and ratings can be edited by adding more text, or deleting text that a user has previously added. The ratings area may show an overall rating which is an average of the ratings allocated by several users, or may show a rating given by one particular user. A user may add a new rating to a module that they have not previously rated, or may edit a rating that they have previously allocated to a module.

A module copy button is shown in the top right part of the module area, labelled “WJ”. This button can be activated to copy the module into selected web pages. Copying the module into the selected web pages involves replicating the module by including the relevant code within each of the selected web pages.

The second part of FIG. 16 shows a module identical to the first, but where the module copy button has been activated to display module copy options.

The third part of FIG. 16 shows the same module as before, in which the rating button has been selected to display a box allowing the user to rate. The newly displayed box contains a row of five circles, and the user may rate the module by selecting an appropriate number of circles. In alternative embodiments, alternative rating displays or systems may be used, e.g. giving a score out of three, four, six, or some other number, instead of a score out of five, and using a different presentation of the rating values such as a different shape or geometrical arrangement.

Users may also rate each item by adding a tag to the item's tag cloud. This will allow qualitative information about the item to be aggregated.

The tags, as discussed above, may be used for indexing appropriate content for a web page or module. A tag may be related to any data object in the database, including individual modules. In an embodiment of the invention, each web page is defined with a set of module tags, content tags and a set of user IDs defining access rights of certain users to the web page. A user can change some of these tags, in order to edit the web site. For example, the following tags may be used for page replication:
Site content tags—multiple tags to define the content of a site
Module content tags—tags relating to the content of a module within a site. These are associated with each module. By default, the site content tags are used to tag each new module that is added to a page. The content tags can be edited by a user.
Module ID—this is unique for each different module
Stylesheet ID—this is unique for each different style sheet.

The site subject tag and site content tags are normally chosen by the site author. The user interest tags are selected by the user. The user “mood” cloud may be used both to select adverts for display and to select content for modules. The content description tags may be automatically generated from the content of a module in one embodiment, or may be at least partially entered by a user in another embodiment. Tag bundles may be set up by each individual user to group together common tags.

Users may populate the content of their modular web pages in two ways. One way is to enable the user to display their own content e.g. from their blog or allow them to specifically select which content they want to display in each module. E.g. for an RSS feed module, a user may enter the specific URL for the feed they wish to display. The other way to populate content for a module is to specify the module as a Discovery Module. This means that the content to display is automatically determined by a Content Selection Algorithm.

In one example, content is selected for a particular module according to the relative ratings of any relevant available content. In another example, content may be selected at least partially according to any available information relating to a user viewing the site, e.g. by using the user's interest tags to dynamically select the content for that particular user. For example, in some embodiments of the invention, the displayed content of a web site is selected to be dependent on the interest tags of a user who is viewing the web site. If a user has an interest tag set to “Liverpool”, and that user views a web site on Chelsea football club, then the content displayed to the user may be adapted to focus on Liverpool v Chelsea fixtures, and any other connections or common material between the user's tags and the site tags. A different user with an interest tag set to “Arsenal” may see different content when they view the same Chelsea football club web site, where the content is now focused around Arsenal v Chelsea matches and fixtures. This personalisation element doesn't need to be specified individually for each site, unlike prior art personalisation of web sites, but instead, it happens automatically.

The personalisation aspect may simply comprise selecting one of a plurality of display options, according to whether the user viewing the page has an interest tag set to one of a plurality of predetermined keywords. If none of the keywords are present, a default option is displayed. Alternatively, a more complex algorithm may be used, to combine and weigh different interest tags of the user, and determine which content to display. In a further option, a search query may be generated using a user's interest tags, and content with a sufficiently high match may be displayed in preference to the default content.

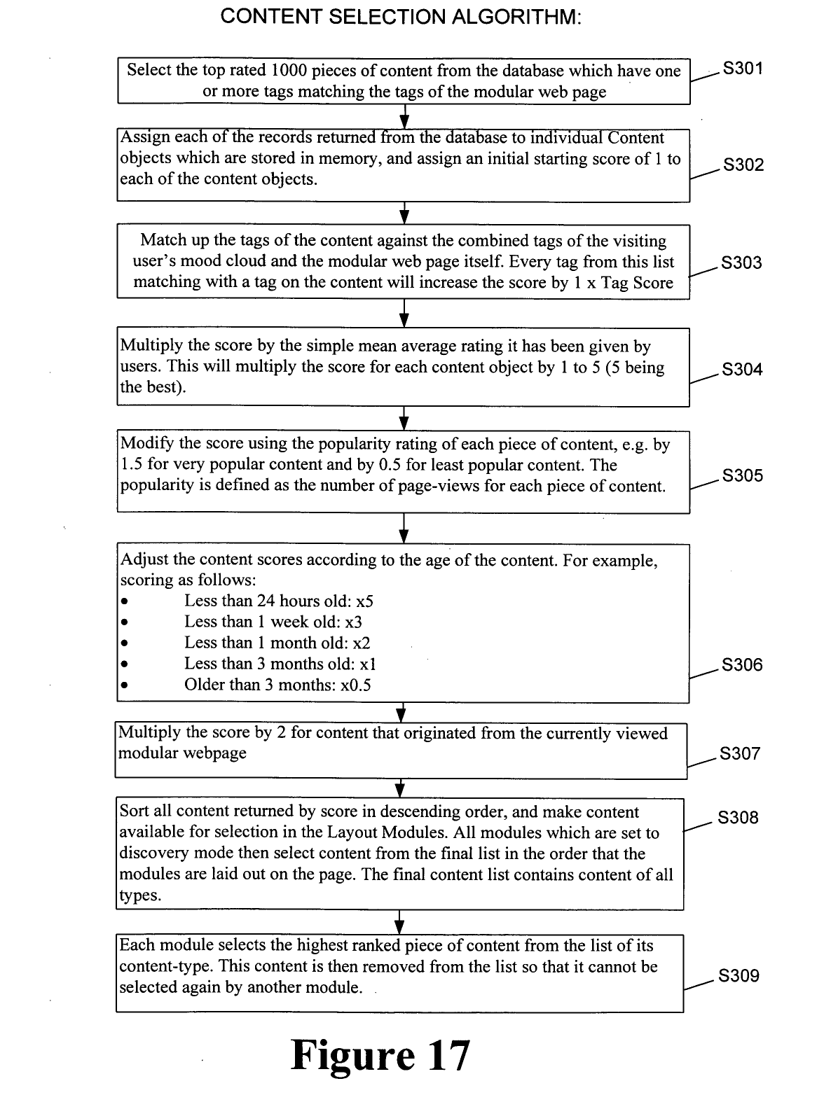

FIG. 17 is a flowchart showing one example of a content selection algorithm. The process begins at step S301 with a matching process, wherein the content selection algorithm compares the tags of content that is stored in the database with the tags of the modular web page. The algorithm selects a predetermined number (in this example, 1000 items) of the top rated pieces of content from the database which have one or more tags matching the tags of the modular web page. For example, the selection process may be via a simple SQL query, such as the following, where “@CurrentWebpageID” is the ID of the Modular web page being viewed:

| | |
|---|---|
| SELECT | TOP 1000 |
| | Content.* |
| FROM | Content |

| | |
|---|---|
| WHERE | ContentID IN |
| (SELECT | ContentID |
| FROM | ContentTags |

| | |
|---|---|
| WHERE | TagID IN |
| (SELECT | TagID |
| FROM | WebjamTags |
| WHERE | WebjamID = @CurrentWebjamID) |
| ) | |

ORDER BY Content.DatePublished

At step S302, the content selection algorithm then assigns each of the records returned from the database to individual Content objects which are stored in memory. In this embodiment, an initial starting score, e.g. of 1, is assigned to each of the content objects.

At step S303, the tags of each piece of content that has been stored as a content object are then matched up against the combined tags of the visiting user's mood cloud and the tags of the modular web page itself. Every tag from this list matching with a tag on the content will increase the score by 1×Tag Score, where tag scores are allocated according to the source of each tag and/or other factors.

At step S304, the scores for each piece of content are then multiplied by the mean average rating that the piece of content has been given by users. This will multiply the score for each content object by a factor of 1 to 5 (5 being the best).

At step S305, the score for each piece of content is then modified using the popularity rating of each piece of content. For example, very popular content may get its score multiplied by up to 1.5 and the least popular content by as low as 0.5. The popularity may be defined as the total number of page-views for each piece of content, or the rate of page-views in any specified time period.

At step S306, the content scores are then adjusted according to the age of the content. For example, the adjustment may involve multiplication of the score by the following factors:
Less than 24 hours old: ×5
Less than 1 week old: ×3
Less than 1 month old: ×2
Less than 3 months old: ×1
Older than 3 months: ×0.5

At step S307, content which originated from the modular web page currently being viewed is given a weighting, e.g. in this case, its score is multiplied by 2.

At step S308, all content returned is then sorted by total score in descending order. Content is then made available for selection in the Style sheets. All modules which are set to discovery mode will then select content from the final list in the order that the modules are laid out on the page.

In this embodiment, the final content list contains content of all types (Individual blog posts, RSS feeds, message boards, photo-sets etc), sorted in order of score. At step S309, each module is provided with the highest ranked piece of content from the list, which has the appropriate content-type. The content supplied to the module is then removed from the list so that it cannot be selected again by another module on the same page.

In further embodiments of the invention, different score multipliers may be used, instead of the ones given in the example above. Any combination or variation of the steps above may be used to obtain scores for content items, e.g. any of the rating factor, the tag count, the popularity factor, the age factor, and the current web site factor may be omitted from the process, the weighting levels for any factors may be changed, and/or additional factors may also be used to provide final scorings for each content item.

In embodiments where less than the predetermined number (e.g. 1000) content items are found for a particular tag, it is possible for the scope of the search to be expanded by association of tags. For example, a tag cloud may be generated for the selected tag (this is described in more detail below), and other associated tags in the tag cloud may also be used to search for content. This is particularly useful in a situation where the original tag is a newly created tag, with few or no matches on content items. The matches found during the content selection algorithm search may be used to expand the tag cloud of the original tag, in some embodiments.

Although remixing a modular web page will copy all tags and modules, this does not necessarily mean that the content displayed on the new modular web page will be exactly the same as on the original web page. The content created on the originating modular web page may be based on a different set of tags or weightings than is used in the content selection process for the new modular web page.

Content may be aggregated together into so-called “channels”. The channels are modular web pages in their own right which bring together the best and most up-to-date content on a broad topic. These content channels may thus be provided to automatically aggregate the best features from the modular web pages.

A channel may contain a selection of different modules of different types. All of these modules are set to ‘discovery mode’. This means that all of the content is selected by a Content Selection Algorithm. Therefore, because of the way the selection algorithm works, the channels automatically aggregate all of the newest and best content around a specified topic.

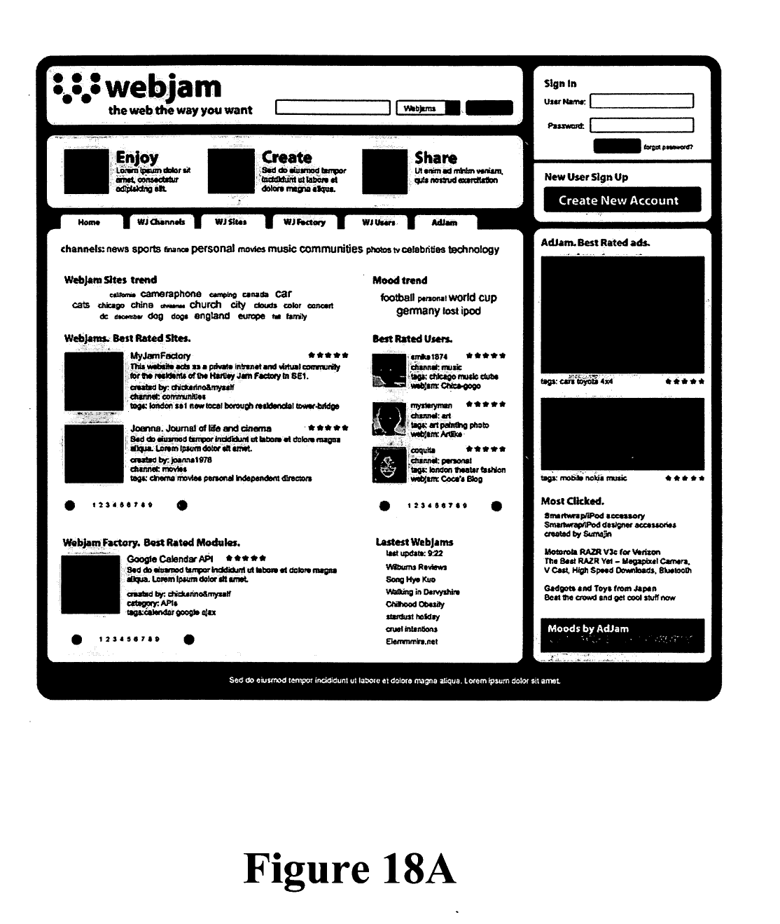

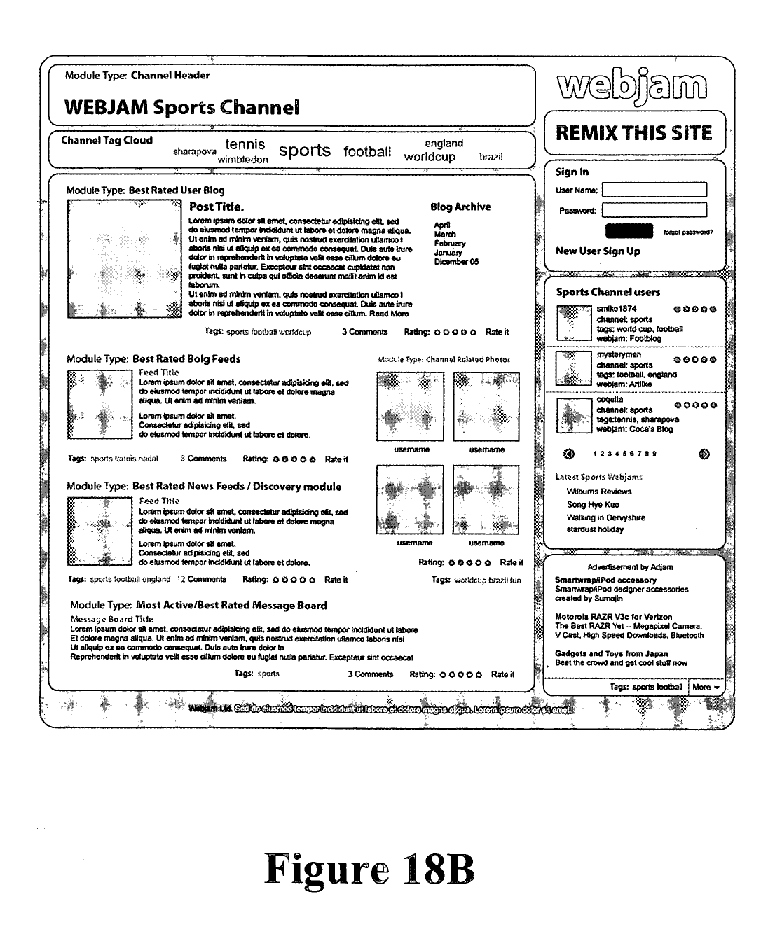

FIG. 18A shows an example screenshot of a modular web page using channels to obtain content for display. The web page shown in FIG. 18A is a general “home” web page, relating to the “best of” all different modules. However, this web page includes a list of selected channels on specific topics (e.g. the most popular topics), including news, sports, finance, personal, movies, music, communities, photos, TV, celebrities and technology. A user may click on any of these topics to obtain a channel web page for the selected topic, where each module contains automatically selected content for that topic.

The web page in FIG. 18A also includes a series of tabs to allow a user to navigate to a “Channels” page, a “Sites” page, a “Factory” page, a “Users” page and an “Adverts” page. Each of these pages may provide automatically selected content on the best channels, the best sites, etc, plus a list of other channels, sites, etc that are available. However, the channels are not restricted to a fixed list, and a new channel may be created by a user at any time, by selecting an appropriate tag for that channel. If a suitable tag does not exist, the user may create a new tag, and where necessary, tag associations can be used to broaden the search for content. The “factory” page relates to best rated style sheets, the “users” page relates to best rated users, and the “adverts” page relates to best rated adverts.

The modules shown in FIG. 18A include a “Site trends” module, which shows some of the tags most commonly used in modular web pages, e.g. within a predetermined recent time period. The size of the tags may indicate their popularity or rating. Also shown is a “Best rated sites” module, which shows a brief summary of two of the most highly rated sites, together with an image, rating data, the site author, and a channel in which the site appears. Scroll arrow controls are shown within this module, to allow a user to scroll through and view additional best rated sites.

FIG. 18A also shows a “best rated modules” module, which in this example, has selected a Google calendar as the best rated module. Data such as rating data, the module author, the module category (which is API in this case), and the module tags are shown. Again, scroll arrow controls are shown, to allow a user to scroll through and view additional best rated modules.

FIG. 18A shows a “mood trend” box, which shows the aggregated mood cloud of the community. In this example, the mood trend tags include football, world cup, germany, lost, ipod and personal. Below the mood trend box is shown a “best rated users” module. Three user profiles are shown in this box, with user IDs, photographs, ratings, web site names for the users, user tags, and channels which are most relevant to these users. Again, scroll arrow controls are shown, to allow a user to scroll through and view additional best rated users.

Below the “best rated users” module, a list of the latest new modular web site is provided. In some embodiments, this list may include the dates at which these web sites were created.

In the adverts section on the right hand side of the page, the best rated adverts are shown first, followed by a selection of the most clicked-on adverts.

In FIG. 18B, an example screenshot is shown for a “sports channel”. This view may be obtained by clicking on the “sports” channel link on the web page of FIG. 18A.

The sports channel shown in FIG. 18B includes a channel tag cloud, in which “sports” is the central and largest tag shown. Additional tags in this tag cloud include tennis, sharapova, Wimbledon, football, england, world cup and brazil. The tags are arranged by subject matter, e.g. the tennis related tags are shown to the left of the “sports” tag, and the football related tags are shown to the right of the “sports” tag.

The modules shown in this sports channel include a “best rated user blog”, which shows a sports blog written by a best rated user. The blog includes links to the blog archive, and shows tags, user comments and ratings. Below the “best rated user blog” is a “best rated blog feed”. This shows a best rated sports blog. Below this is shown a best rated news feed, relating to sports news. Also shown in a module for channel related photos, in which a selection of the best rated sports photos are shown. The sports module also shows a list of best rated sports channel users, and a list of the most recently created new modular web sites on sports related topics.

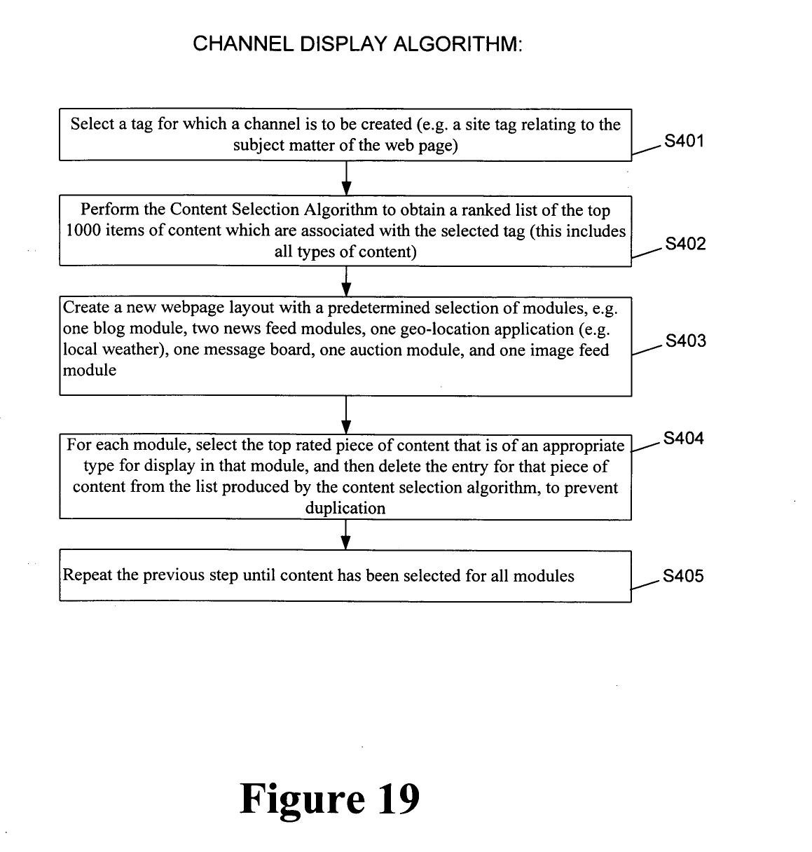

The channel creation process is illustrated in the flowchart of FIG. 19. In the first step S401, a tag is selected for which a channel is to be created. This tag may be selected manually by a user, or it may be obtained automatically, e.g. by copying a site tag of a web site. At step S402, the content selection algorithm is performed to obtain a ranked list of content for the channel. This content includes content suitable for different types of modules. If content for a particular module type is needed, but is not found on the list, then it may be possible to run the content selection algorithm again for either a broader search, or to obtain a larger number of search results.

At step S403, a new web page layout is created with a predetermined selection of modules. Normally, a default choice and layout may be used, although a user may be able to over-ride this default and select the particular modules to be included in the channel web page. Alternatively, the number of different modules in the channel web page may be determined using the distribution of module types found in the search results. For example, if most of the highly rated content is blog content, then two different blogs may be displayed on the channel web page, and only one news feed. However, if most of the highly rated content is news feed content, then two news feed modules may be displayed, but only one blog.

At step S405, the step of selecting appropriate content for each module, and then deleting that content from the search results list, is repeated for each of the modules being displayed, until content has been obtained for all of the displayed modules.

As well as providing automatically selected content for modules, the content selection algorithm may be used to provide search results for a search term that is entered by a user. The search term may be treated as a tag, and the content selection algorithm may be run as normal. The search results may be shown as a single ranked list, or may be sorted into different ranked lists for each modules type.

Where a search term is not already a recognised tag, it will not be linked to any items of content. However, by the creation of a tag cloud for this search term, different tags in the tag cloud may be used in the search to improve the quality of the results. Tags clouds are now discussed in more detail.

A Tag Cloud is a weighted list of tags. In embodiments of the invention, a tag cloud may provide a visual representation of a topic, where the topic is itself a tag. All of the tags in the tag cloud are related in some way to this topic. The tags may be displayed and arranged according to their weightings, where the most popular or highly weighted tags are visually indicated according to the font size. The order of display of the tags in a tag cloud can be selected by a second criteria, such as alphabetical order, to give users more than one order for scanning through them. Selecting a tag within a tag cloud may lead a user to a collection of items associated with that tag. Technically, a tag cloud is a group of tags related to a subject with a weighting assigned to each one. Tag Clouds may be represented easily using XML. For example:

```
<TagCloud>
    <TagRecord>
        <Tag>Cars</Tag>
        <Weight>5.0</Weight>
    </TagRecord>
    <TagRecord>
        <Tag>Porsche</Tag>
        <Weight>3.0</Weight>
    </TagRecord>
    <TagRecord>
        <Tag>Ford</Tag>
        <Weight>2.0</Tag>
    </TagRecord>
    <TagRecord>
        <Tag>Engine</Tag>
        <Weight>2.0</Weight>
    </TagRecord>
    ...
    ...
    ...
</TagCloud>
```

An owner of a modular web page may choose to place a tag cloud onto their modular web page as a module. The owner may initially specify the topic tag, but other users may be able to contribute to the tag cloud. For example, if the web page provided access rights for only a particular community, then users within this community could add to the tag cloud.

In embodiments of the invention, tag clouds may be used in the following ways:

(1) “Perception clouds”—to reflect user opinions and perceptions, e.g. by allowing users to edit tag clouds for ideas, people, etc.

(2) “Mood clouds”—to reflect the user mindset at a given time, and generated by the mood algorithm (which is discussed in more detail below)

(3) “Reputation clouds”—a quantitative way to rate sites, users, content, etc, by characterisation through words

(4) “Trend clouds”—to show trends and enable users to discover what the community is interested in. These can be obtained by aggregating the mood clouds of all users in a community, to get a community trend cloud.

In some embodiments, each tag within the tag cloud can be individually ranked, e.g. by clicking on it to give it a value from 1 to 5, to symbolise the perception for that word from a very negative perception to a very positive perception. This may be done as tags are inputted into the tag cloud characterising a particular topic. It is possible to boost the possibilities of representing various opinions by having tag clouds include more criteria, while giving users the possibility to sort and extract from these criteria

Tag Clouds for a given topic may represent information as follows:
Size may be used to indicate popularity of a tag. The more often a tag is entered, the bigger it will appear
Shade may be used to indicate time, e.g. 6 shades may represent freshness from completely opaque to almost transparent, for timescales ranging from the last hour, day, week, month, quarter, year
Colours may be used to indicate User Perception. Each tag in the tag cloud may be rateable by users in a scale from 1 to 5 from offensive to sympathetic/complimentary. This may be shown by colours, based on how users actually rank each tag in the cloud from positive to negative. For example, green shades may be used to show positive ratings and red shades may be used to show negative ratings.
Priority: instead of listing tags by alphabetical order, tags may be arranged closer to the centre based on the combination of Popularity & Time

Alternatively, any other combination of colour, transparency, brightness, shade, size, position, or other visual factors may be used to represent any features of the tags.

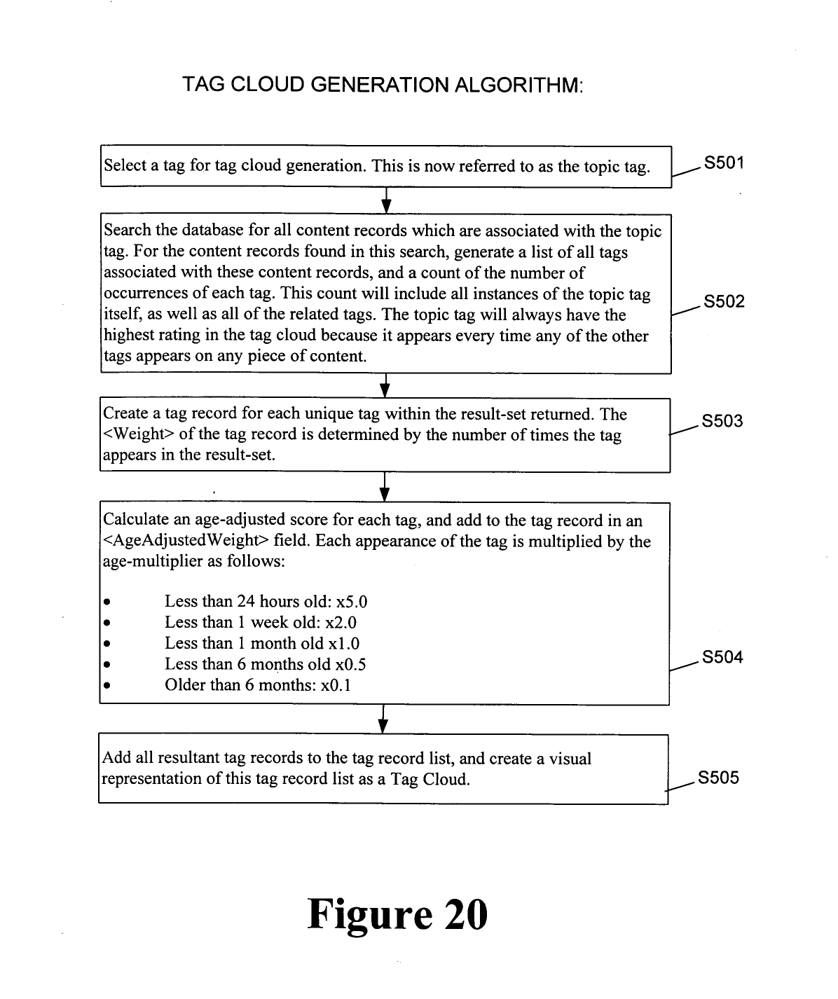

FIG. 20 shows an example of a Tag cloud generation algorithm. Firstly, a tag is selected for tag cloud generation, at step S501. This is referred to as the “topic tag”. At step S502, the database is searched for all content records which are associated with this topic tag. This process may use the content selection algorithm. For content that is found in the search, a list of all associated tags is generated. Each tag in the list is awarded points according to how often it is found associated with any item of the content found in the search. Assuming that @TopicTagID is the ID of the topic tag for the tag cloud, the SQL to select the tags from the database might be:

| | |
|---|---|
| SELECT | Tag.* |
| FROM | Tag |

| | |
|---|---|
| WHERE | TagID IN |
| (SELECT | TagID |

| | |
|---|---|
| FROM | ContentTag |
| WHERE | ContentID IN |
| (SELECT | ContentID |
| FROM | ContentTag |
| WHERE | TagID = @TopicTagID) |
| ) | |

This will also select all instances of the topic tag as well as all of the related tags. This is intentional because it means that the topic tag will always have the highest rating in the tag cloud, because it is found associated with every item of content in the search results. The other tags will appear less frequently.

At step S503, a tag record is created for each unique tag within the result-set returned from the search. The tag record includes a weighting for the tag, which is determined according to its score determined as above. The weighting may simply be equal to the score, or it may be scaled or adjusted in a suitable manner.

At step S504, the age adjusted scores are calculated, according to the age of the content associated with each tag. Each appearance of the tag is multiplied by an age multiplier, for example as follows:
Less than 24 hours old: ×5.0
Less than 1 week old: ×2.0
Less than 1 month old >1.0
Less than 6 months old ×0.5
Older than 6 months: ×0.1

An overall “AgeAdjustedWeight” is determined from a sum of these age adjusted scores for each tag.

At step S504, all resultant tag records are added to the tag record list in the database, and a visual representation of the tag record is generated and displayed as a tag cloud. The data within tag clouds may be altered by placing filters on it. These filters can be any piece of information relating to each tag, the content that was tagged, the user who tagged the content or the date the content was tagged. For example it is possible to restrict the data in a tag cloud so that a tag cloud about ‘football’ is created only by tags placed by:

Male users-
TagRecord.Content.User.Demographics.Sex = ‘Male’
Under 30 years old-
TagRecord.Content.User.Demographics.Age < 30
In the last 2 months-
TagRecord.Date > DateTime.Now.AddMonths(−2)

This will cause a filter to be applied so that only tag-records matching these criteria are used to build up the tag cloud.

To setup criteria such as these, the creator of the tag cloud may specify the settings for the module. When a user views the tag cloud, they will also be able to change these settings, but only on a temporary basis—i.e. the tag cloud reverts to its saved settings when someone else views it.

Tag Clouds may be generated for a large range of topics, including external topics such as people (from politicians to sport or showbiz stars), companies, brand, products, ideas, opinions, events, and internal topics relating to elements of the modular web page system. Each web page may have its own tag cloud, which could help in filtering out pages with abusive content. Each user may have their own tag cloud, and users may have the option to publish or not how they are perceived by the community. A Tag cloud system may be used for a user's mood cloud, to describe a user's mood and current interests. In principle anything that a user wants to be tagged could be represented as a tag cloud. Editors may review all the tag clouds to delete inappropriate ones and highlight the best ones.

Any publisher of a modular web page may be able to create as many tag clouds as they want, each cloud being a module in its own right. The publisher, “friends” with access rights to the web page, or the overall public may contribute to the tag cloud, according to the access settings for that particular web page. Various tag clouds may be aggregated from all the modular web pages to give an overall view of the “tagcloudsphere”, allowing users to choose their preferred view with tagcloud “controls”, which are discussed below. This aggregation may be provided as another channel.

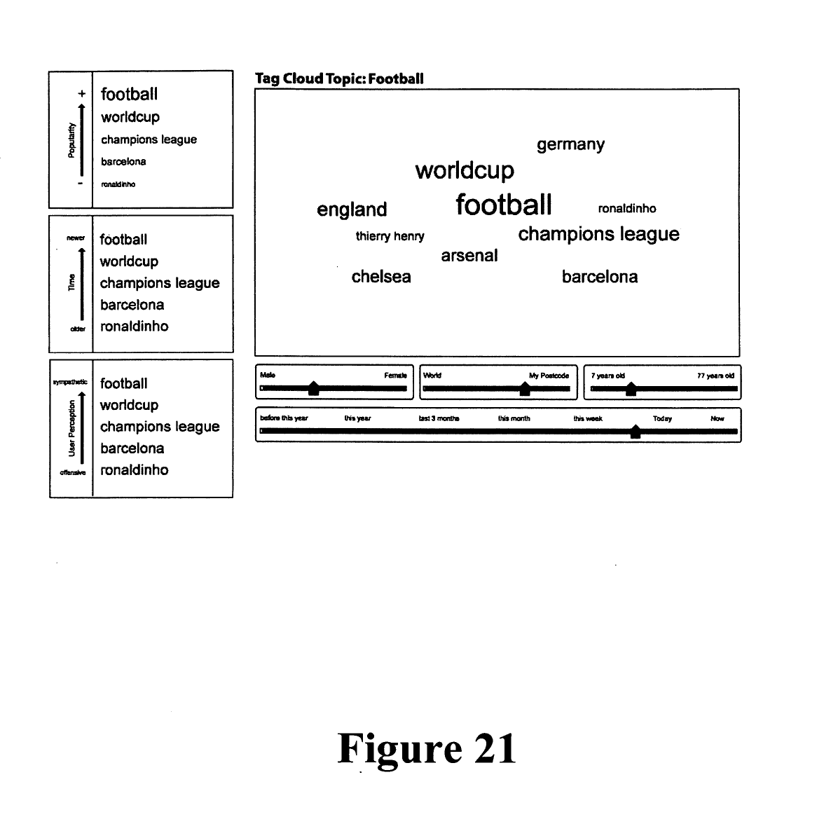

FIG. 21 shows an example of a Tag cloud. This tag cloud relates to “football” and includes tags for worldcup, england, thierry henry, chelsea, arsenal, germany, champions league, ronaldinho and barcelona.

In a preferred embodiment, the size of the tags may be represented by the tag weight and the opacity and the distance from the centre represents the recent popularity of the tags (age). This is increased for topics which are more popular in the short term. The colour represents the perception of each tag (from good to bad) by the user viewing the tag cloud.

When a user clicks on a tag within the tag cloud, a search may be performed upon that tag. At the top of the search results a tag cloud may be shown for the tag searched upon, hence allowing the user to navigate through related tags and discover related content.

Tags records may be set up to be able to track time-based data for each tag. An example of a TagRecord is:

```
<TagRecord>
    <Tag>Cars</Tag>
    <Weight>5.0</Weight>
    <AgeAdjustedWeight>13.0</AgeAdjustedWeight>
    <Priority>8.0</Priority>
    <Perception>0</Perception>
</TagRecord>
```

The ‘AgeAdjustedWeight’ field, as discussed above, is a weighted average of the popularity of the tag giving a much higher weighting to more recent usage of the tag. Hence in this example it shows that although the tag weighting is 5.0, more recently this tag has been popular so the age-adjusted weighting is increased to 13.0.

The ‘Priority’ field is a simple average of the Weight and the AgeAdjustedWeight. It determines how close to the centre of the tag cloud this tag appears.

The ‘Perception’ field tell us whether the user viewing the tag cloud perceives this tag as good (−1.0 to 0), neutral (0) or bad (0 to 1.0). Perception determines the colour of the tag. Perception of a tag can be selected by hovering over it and clicking the thumbs up or down symbol. The perception shown is an average of all perception selected by users—unless the viewing user has selected their perception of the tag—in which case it shows their value only.

The ratings given to each piece of content, module or modular web page created by a user may also influence the overall tag cloud for this user. The perception of each tag can also be aggregated at this level to give an overall good/bad score.

The Tag cloud view may be adjustable using the following criteria:
Time: with a control provided to set a time snapshot for a given time, or a slideshow for a given period with a given frequency
Location: based on users geo-data, this may provide the possibility to zoom from the world to a continent, country, region, city, postcode
Age & Gender with sliders
Other criteria can be added, notably occupation, marital status, political inclination, etc.

Below the tag cloud in FIG. 21 is shown three filter different controls. These allow a filtered tag cloud to be shown. Each filter comprises a horizontal bar with a sliding indicator. The first filter is labelled “Male Female”. When the sliding indicator is positioned centrally, no filter is applied. However, when the sliding indicator is positioned next to the word “Male”, then only tag ratings that have been provided by male users are included in the tag cloud weighting calculation. The gender of the users is obtained from the user profiles. Similarly, when the sliding indicator is positioned next to the word “Female”, then only tag ratings that have been allocated by female users are included in the tag cloud weighting calculation. Intermediate positions may use different weightings for ratings from male and female users, where the weighting is dependent on the position of the sliding indicator.

The next filter control relates to geographical location. The horizontal bar is labelled with “World My Postcode”. When the sliding indicator is positioned next to “World”, then the tag ratings provided by all users is used to determine the tag cloud weightings. However, when the sliding indicator is positioned next to “My Postcode”, only the tag ratings provided by that particular user and any other users with the same postcode are used when determining the tag cloud weightings. For intermediate positions of the sliding indicator, the ratings from users within a certain geographical area may be used, where the geographical area size is dependent on how far the sliding indicator is moved.

The third filter relates to the ages of the users providing the ratings. In this example, the age range is 7 years to 77 years, although any age range could be made available in alternative embodiments. In this embodiments, a single age grouping is selected by the position of the sliding indicator. The age grouping size may be predetermined, e.g. in 15 year age bands, or the user may be able to set up their preference for age grouping size. In an alternative embodiment, two different sliders may be provided on this control to indicate a maximum age and a minimum age.

In addition to the tag cloud itself, FIG. 21 shows tag rankings. In three separate screen areas, the tags of the tag cloud are ranked in order of popularity, time and user perception, with the most popular tags, the newest tags, or the tags with the best user perception being displayed above the other tags.

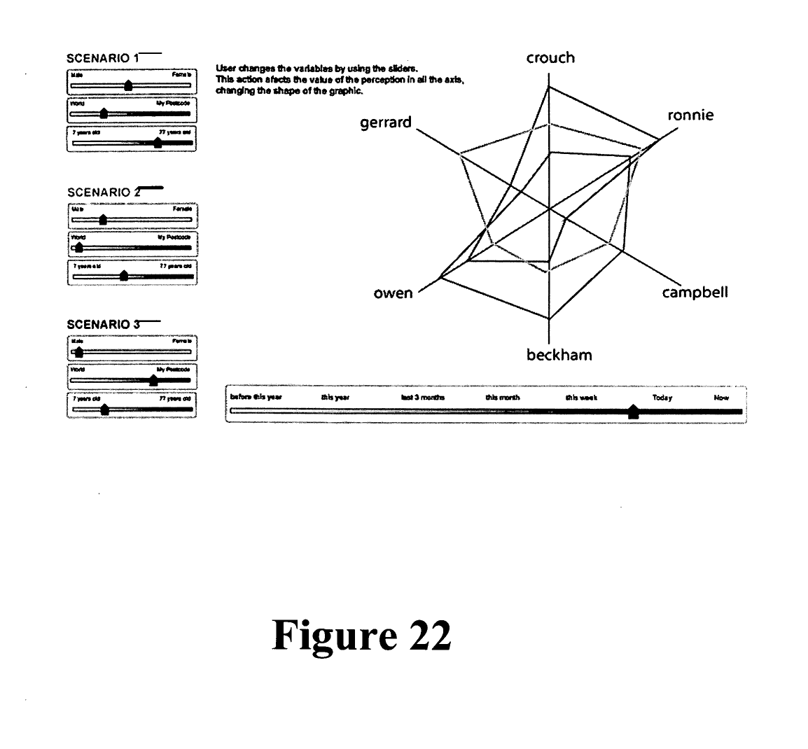

Tag clouds may be used for filtering, and some embodiments may also allow users to compare two or more tags over any number of demographics. By clicking on a “TagJam” button at the top of the tag cloud, the tag cloud enters “TagJam” mode. The user may then select two or more tags to “Jam” with, e.g. up to a total of 10. Once they have selected their tags, the user may click the “Create TagJam”. This creates the TagJam spider chart, as shown in FIG. 22.

FIG. 22 shows a screenshot of a “spider graph”, where the tag clouds for different user demographics may be graphically compared. The left hand side of the figure shows three sets of slider controls, labelled “scenario 1”, “scenario 2” and “scenario 3”. Each set of controls contains three separate sliders, which correspond to the sliders shown in FIG. 21. Thus, the top slider is a “Male Female” setting, the middle slider is a “World My Postcode” setting, and the bottom slider is an age slider.

A user may select different settings of the sliders for each of the three scenarios. On the right hand side of the figure, six tags are arranged in a hexagonal pattern at the ends of three intersecting axes, although in alternative embodiments, a different number of tags, e.g. from two to ten tags, may be used. These three axes thus are each divided into two parts, so that each tag labels a radial line, where all the radial lines intersect at a central point between the tags. The radial lines represent a weighted tag rating of zero (at the central intersection) to 100% (at the extremity of the line, next to the tag label). The tag weightings may be shown as points on the radial lines, and these points may be connected to create a shape indicating the tag weightings. Thus, if all tags had high weightings, an approximately hexagonal shape would result from the connections, but some of the tags had much higher weightings than others, a skewed shape would result.

In FIG. 22, a comparison of the tag weights is shown for the three different scenarios, using three different thicknesses of interconnecting lines, which connect the points on the radial lines corresponding to the tag weights. Scenario 1 is both male and female users within the present user's country, of an age group of around 50 years old. This is shown by the thinnest line on the spider graph. The results for scenario 2, which uses a weighting of two thirds for male users and one third for female users, within the entire world, of an age group of around 30 years old, is shown by the thickest line on the spider graph. The results for scenario 3, which is all male users within the present user's town with an age group of around 20 years is shown on the spider graph with a line of intermediate thickness.

The user may alter the demographics criteria. When the user alters the demographic the results are reflected on the spider chart showing the new popularity of each tag for that demographic. The user may save a demographic setting and create a new one, thereby overlaying a new spider chart on top of the old one.

If the user altering the tag cloud with TagJam is the owner of the module (i.e. it is on one of their modular web pages), they may save its settings so that the tag cloud appears as a tag jam as its default appearance. If the user altering the tag cloud is a visiting user, then they will have the option to add the resultant tag cloud to one of their modular web pages.

FIG. 22 shows a sliding bar directly below the spider graph, which allows a user to change the time period and thus view the history of how the tag cloud has developed for different users. The user may simply adjust the position of a sliding indicator on this slider control to change the date from “before this year” to “this year”, “last 3 months”, “this month”, “this week”, “today” or “now”. In alternative embodiments, difference choices of time period may be used. In some embodiments, an animation may be available to automatically show the changes with the progression of time.

One particularly useful feature provided in some embodiments of the invention is to select and display targeted advertising material to individual users. Embodiments of the invention have significant advantages over the prior art for improving the effectiveness of the targeting. In existing advert selection software, such as Google AdSense, advert selection can be based on the content of a web site, for example, relevant words or phrases (i.e. “selection terms”) are extracted from the web page and used in a matching process to select the most relevant adverts from an advert database. Each advert in the database is associated with one or more keywords relevant to that advert. For example, a travel advert for London may be associated with the keywords “Travel” and “London”. An online video store advert may be associated with the keywords “Video” and “DVD”. The matching system finds a best match between the selection terms (extracted from the web site) and the advert keywords. This ensures that the displayed advert content will be relevant to the content of the web site.

However, in embodiments of the present invention, advert selection terms (also referred to as “mood tags”) may be generated using many other factors as well as simply the content of a web site. A Mood Cloud for a user is a tag cloud, comprising “mood tags”, where the cloud describes the “mood” of the user. A users “mood” may include their long term interests, their short term interests, the type of advertising that they have recently viewed, or any other factors specific to that user's preferences or behaviour. A user's mood cloud may be displayed in an area of the web page, referred to as a mood cloud module. Tags within the mood cloud may be taken from the user's interest tags, their advertising tags (particularly if the mood cloud is used to determine what advertising should be selected for display to a particular user), viewer tags (i.e. content tags of the page the user is viewing or has recently viewed e.g. within the last week, day or some other time period) and publisher tags (i.e. the content tags of the pages the user has published). In an embodiment of the invention, user interests may be collected as a result of users entering and editing, at any time, interest tags to identify these interests.

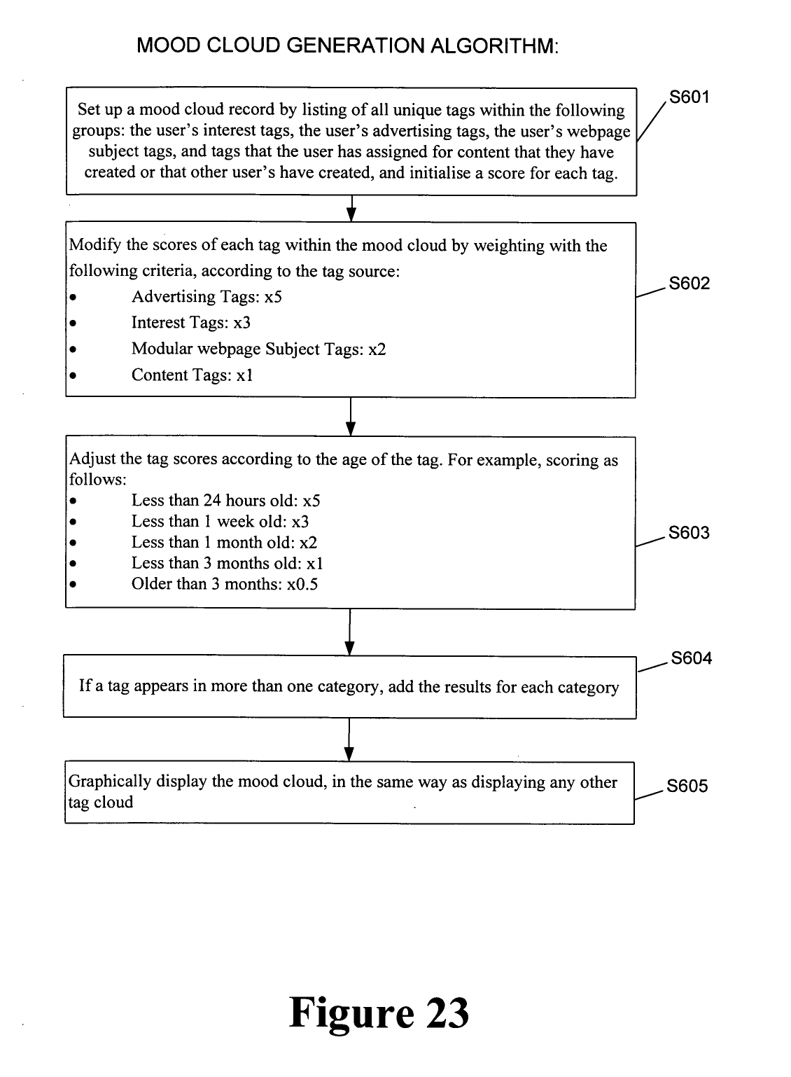

FIG. 23 is a flowchart showing an example process for generating a mood cloud for a particular user. The process starts at step S601, where a list of unique tags within the mood cloud is set up, by copying the user's advertising tags, interest tags, publisher tags, and viewer tags. Tags within the mood cloud may additionally be weighted with the following criteria, according to their source, as shown at step S602:
Advertising Tags: ×3 (where applicable)
Interest Tags: ×2
Publisher tags Tags: ×1
Viewer Tags: ×0.5

These “mood tags” comprise the tags of the user's mood cloud, as discussed above. When using a mood cloud for selection of adverts, it may be particularly relevant to take account to how recent the selected tags are, to avoid adverts being selected for products which the user has already bought and will not wish to buy again in the immediate future. For example, mood tags may be generated using a user's weekly interest (e.g. baby cots), a user's general interest and/or the web site content.

Thus, additional weightings may optionally be applied, such as using the time at which the tags were created or used to label content, and ratings data. This is shown in step S603. If a tag appears in more than one category, the scores in each category may be summed to give a total for the tag, as indicated in step S604. The final mood cloud may be displayed graphically in the same way as any other tag cloud, as indicated in step S605.

The number of points may then be weighted according to how recent the tags are. For example, content created within the last one day may be allocated a weighting of 10. Content created within the last week may be allocated a weighting of 5. Content created within the last month may be allocated a weighting of 2. Content created within the last year may be allocated a weighting of 1. Content older than one year may not be taken into consideration at all. A user may be given an option of updating the “creation date” of their interest tags, e.g. at regular intervals, to ensure that long term interests maintain a high weighting.

The following table shows an example of how scores for mood tags may be calculated, according to the above criteria.

| Tag | Source | Score | Time | Subtotal |
|---|---|---|---|---|
| car | ad tag | 3 | 5 | 15 |
| holiday | ad tag | 3 | 2 | 6 |
| Bahamas | ad tag | 3 | 2 | 6 |
| car | interest tag | 2 | 1 | 2 |
| Porsche | interest tag | 2 | 1 | 2 |
| football | interest tag | 2 | 1 | 2 |
| Liverpool | interest tag | 2 | 1 | 2 |
| football | publisher tag | 1 | 2 | 2 |
| Liverpool | publisher tag | 1 | 2 | 2 |
| Liverpool | viewer tag | 0.5 | 10 | 5 |
| Chelsea | viewer tag | 0.5 | 10 | 5 |
| Liverpool | viewer tag | 0.5 | 2 | 1 |
| Arsenal | viewer tag | 0.5 | 2 | 1 |

Identical tags from different tag clouds may then have their scores summed, as follows:

| Tag | Total score |
|---|---|
| car | 15 + 2 = 17 |
| holiday | 6 |
| Bahamas | 6 |
| Porsche | 2 |
| football | 2 + 2 = 4 |
| Liverpool | 2 + 2 + 5 + 1 = 10 |
| Chelsea | 5 |
| Arsenal | 1 |

The tag ranking in this situation is thus: car, Liverpool, holiday, Bahamas, Chelsea, football, Porsche, Arsenal. These now become the mood tags, used for matching with advert keywords in the database to select the most relevant adverts.

To identify adverts of greatest relevance, a number (e.g. three, four or five) of the highest ranked tags may be matched to advert keywords. In some embodiments of the invention, Ad IDs are stored in a database, rather than the full content of the advert itself, which is known as a “creative”, and may include images, video clips, text, hyperlinks, audio, etc. The creative may be stored in the database as well, but alternatively it may be stored externally, and may be accessed using the Ad IDs. In one embodiment, an ad creative comprises text content, formatting information and a URL. In another embodiment, one or more images are included as well as or instead of the text and/or formatting information. Each Ad ID is associated with one or more keywords that are relevant to the ad. Thus, all Ad IDs with the keyword “car” are found in the advert database, as well as all Ad IDs with the keyword “Liverpool” and all Ad IDs with the keyword “holiday”.

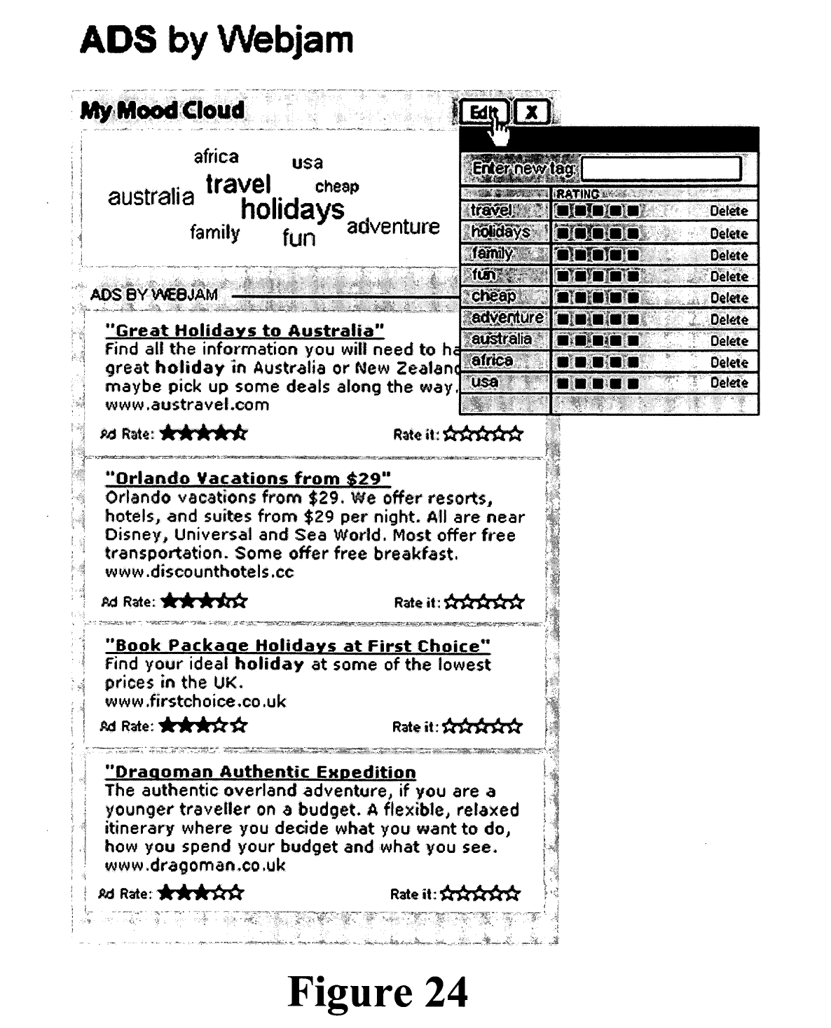

FIG. 24 shows a partial screenshot with an example of advertising material. This may, for example, correspond to the right hand side advertising panel on the screen layout of FIG. 5-7. The top part of FIG. 24 shows a user's mood cloud. In this example, the mood cloud consists of nine different words displayed in a rectangular area of the screen. The most relevant words, “travel” and “holidays” are displayed in a large bold typeface, in the middle of the moodcloud area. The next most relevant words “australia” and “fun” are displayed in a smaller, lighter font, and are located nearer the edges of the mood cloud. Each of the other words, “adventure”, “africa”, “family”, “usa”, “cheap” are displayed in smaller again fonts, at the edges of the mood cloud.

In the top right area of the moodcloud area, an “edit” button is provided to allow a user to edit the mood cloud. In FIG. 24, a popup box is shown, which appears as a result of a user clicking on the “edit” button. The popup box has a text input box to allow a user to enter a new tag for addition to the mood cloud. Each of the current tags is displayed in a list in the popup box, with a rating control displayed next to it, and a “delete” button. A user may change the tag's rating using the rating control, or delete the tag altogether using the delete button. In this example, the rating control for each tag shows five squares aligned in a row, to allow a user to allocating a rating as a score out of five. The user may select a particular number of squares by clicking on an appropriate one. The left hand squares, up to and including the clicked-on square, are shown in a first colour to indicate their selection, and the remaining squares are shown in a second colour to indicated that they are not selected. In this example, the tag “holidays” has the highest rating of 5/5, “travel” has 4/5, “family”, “adventure” and “australia” have a score of 3/5, “cheap” and “africa” have a score of 2/5, and “fun” has a score of 1/5. When displayed on a user's mood cloud, these ratings are taken into account when determining the position, size and font used for each tag. However, other factors may also be taken into account, such as how recent the particular tags are.

Below the mood cloud in FIG. 24 is shown a selection of four text based adverts. Each advert is shown on a rectangular screen area with an underlined title at the top, descriptive text below the title, a web link below the descriptive text, and a rating panel below the web link, where the rating panel shows the average rating previously allocated to the advert as a selected number of stars out of five stars, and a user control for allowing a user to input their own rating of the advert. Average ratings may be shown as partial numbers of stars or whole numbers of stars. The number of stars is indicated by the stars on the left hand side having a first colour, up to a point which is proportional to the average rating score, and the remaining stars having a second colour. If the average rating is not a whole number, then half a star, or some other fraction of a star may be displayed using the first colour, and then remaining part may be displayed using the second colour.

The adverts shown in FIG. 24 have the titles: “Great Holidays in Australia”, “Orlando Vacations from $29”, “Book package Holidays at First Choice” and “Dragoman Authentic Expedition”, which are all travel or holiday related, some of which relate to australia, usa, cheap, etc. These adverts are rated 4.5 stars, 3.5 stars, 3 stars and 3 stars respectively. Thus, the highest rated advert is displayed at the top, followed by the rest of the adverts in ranked order.

In some embodiments of the invention, a facility is provided for a user to save links to the best adverts, to allow them to be viewed at a later time. For example, a user browsing the internet at work may wish to wait until they get home to view adverts relating to leisure interests. However, the user may wish to save a link to the advert at the time, to avoid losing it. A facility may be provided for emailing adverts to a selected email address, for example to forward the ad to a friend. Adverts may be ranked by a user before or after saving or forwarding them.

In some embodiments of the present invention, adverts may be served to a site by RSS feed. This would be useful in a situation where a user is tied into the use of another ad-server. The use of an RSS feed can allow advertising to bypass this current ad-server, and allow a user to display better quality, high ranked adverts on their site without turning the site into a Modular web page site.

Embodiments of the invention may be provided with means for abuse management. For example, tag clouds associated with particular web pages or users may indicate a likelihood of abuse on that web page or by that user. Profanity filters may be implemented, and a default view may be provided in which bad words are filtered out.

Embodiments of the present invention may use an affinity algorithm, to suggest new web sites or modules that may be of interest to a user. For example, such an affinity algorithm may allow a user to find other users with similar mood tags, or to broaden their search on adverts. Although sites such as Amazon.com and music engines currently provide affinity links, these are generally just for linking of particular products.

Users may discover new products and services based on each other's recommendations, i.e. “serendipity marketing”. A network of such ad-serving web sites all using UDA (Universal Data Access), may be flagged and recognised as such, in order to prompt users to request that other web sites also use this ad-serving system.

In prior art advertising systems, adverts either have a fixed price (e.g. per time period or per click), or they follow a dynamic/auction pricing where whoever bids the highest appears first. Embodiments of the present invention provide significant advantages over these prior art methods, by using a pricing system that takes an advert's rating into account, to ensure that the highest rated adverts are most likely to be displayed. Adverts may be rated by users in the same way that modules, web pages, content and other users can be rated. Where a particular advertiser has different formats of adverts available, e.g. text only ads, graphical ads, video ads, etc, then each advert format may have its own independent rating. In an embodiment of the present invention, particular adverts may be rated both by the users of the web site and by the users of other web sites that are served the same ad. The advert pricing may be dependent on the associated advert keywords. Each advert keyword may have a pricing structure according to the rating of the ad.

The advert pricing algorithm used in an embodiment of the invention will now be described in more detail. The idea behind this pricing algorithm is that users can influence the price paid by advertisers when they buy advertising, according to the rating that the users give to each advert. Thus, advertisers are given incentives to always serve the best adverts, which will be most highly rated by the users.

This will have the effect of increasing the relevancy of adverts to the users viewing a particular web site, and hence the advert success will improve, e.g. the number of click-throughs to the advertiser's web site should increase. Advertising will become a reason for users to view a particular site, as it is selected by relevance and quality, just like any other content on a web site is selected for relevance rather than randomly inserted on a web page. The best adverts will also benefit from viral recommendations between users. Advertisers will need to continuously improve their ads, to avoid bad image through poor rankings. Users may judge adverts on content, message, format, etc, or any other personal preferences.

In one example, advertisers may choose between only a few fixed prices per click on their advert, e.g. (in GBP) £0.10, £0.25, £0.50, £0.75, £1.00, £1.25, £1.50; £2.00, £2.50, £3.00, £4.00; £5.00. The number and size of price increments may be different in different embodiments of the invention, e.g. only 5 or 6 prices may be available in some embodiments. For each category of advert (e.g. travel, finance, cars), there may be a different number of increments and different prices. When buying advertising for a particular product, an advertiser may select a single price within the range of available prices for their advert.

In prior art systems, the display priority of the advert would now simply be determined by the price paid by the advertiser, sometimes combined with the click-through rate. However, in embodiments of the present invention, each advert is rated by users, and the rating also contributes to the display priority of the advert. For example, each user may rate any adverts as follows:
Overall quantitative rating (OQuant), from 1 (bad) to 5 (good) stars
Qualitative through a tag cloud
Specific quantitative rating (SQuant) from 1 (bad) to 5 (good) stars, independently on advert format, relevance, creativeness or other criteria

If there is more than one advert in an ad module, e.g. which contains up to 5 text links, then each of the links may be independently rateable. Logged-in users may be given a higher weighting than a random user, e.g. in a 3:1 ratio, in order to foster community spirit, and to take into account the fact that they should know the system better. For a given ad, ratings will show as soon as more than a predetermined number of users (e.g. 10 users) have provided their Overall Quantitative assessment; until that time, the rating will be deemed neutral with a value of “3”. The predetermined number may be adjustable, and may be different for different advertised products.

The average ratings for a number of users may then be calculated, e.g. OQuant may have the following ranges:
From 1 to 1.5 included: “very bad” (VB)
From 1.5 excluded to 2.5 included: “bad” (B)
From 2.5 excluded to 3.5 included: “average” (A)
From 3.5 excluded to 4.5 included: “good” (G)
From 4.5 excluded to 5: “very good” (VG)

The Ad serving system may then serve the ads based on price points & ratings. In one embodiment, adverts of the highest price category may be served first, then if some inventory is left, the next highest price category, and so forth. Within these price categories, the adverts may be ranked by their rating.

Alternatively, ads in any price category may be prioritised in the same way as ads in a higher or lower price category, based on their rating. For example, VG ads may be prioritised in the same way as “A” ads that are two price categories higher. G ads may be prioritised in the same way as “A” ads that are one price category higher. “A” rated ads may be prioritised according to their actual price category. B ads may be prioritised in the same way as “A” ads that are one price category lower. VB ads may be prioritised in the same way as “A” ads that are two price categories lower.

In practice, the prioritization may happen as follows, assuming five price categories and five ratings categories. Each advert may be allocated a score by adding the price points (from 1 to 5) to the rating category score (from 1.1 to 5.5).

Initial price
points (£)

| rating | | 0.1 | 0.25 | 0.5 | 1 | 2 |
|---|---|---|---|---|---|---|
| category | rate | 1 | 2 | 3 | 4 | 5 |
| VG | 5.5 | | | 8.5 | | |
| G | 4.4 | | | | | |
| A | 3.3 | | | | 7.3 | |
| B | 2.2 | | 4.2 | | | |
| VB | 1.1 | | | | | |

For example, a VG Ad bought for 0.5 will be allocated a score of 3+5.5=8.5

The adverts with the highest score are preferably served first. If there is a tie in any of the final categories, the ad with the higher click-through rate will be prioritised. Below a certain threshold, ads with bad ratings won't even show up.

An affinity system may be put in place, such as “if you liked that Ad, you should like this one too”. The actual Ad serving, i.e. matching how the Ad ID to be used on a specific page viewed by a specific user with the creative actually served, may be done by a third party system.

In summary, the system will firstly select relevant mood tags for a particular user viewing a particular web site, e.g. using the “Mood Algorithm”. Each mood tag is associated with the relevant Ad IDs using an AdRating process. Each Ad ID is associated with the creative to be served on the web page via the AdServer.

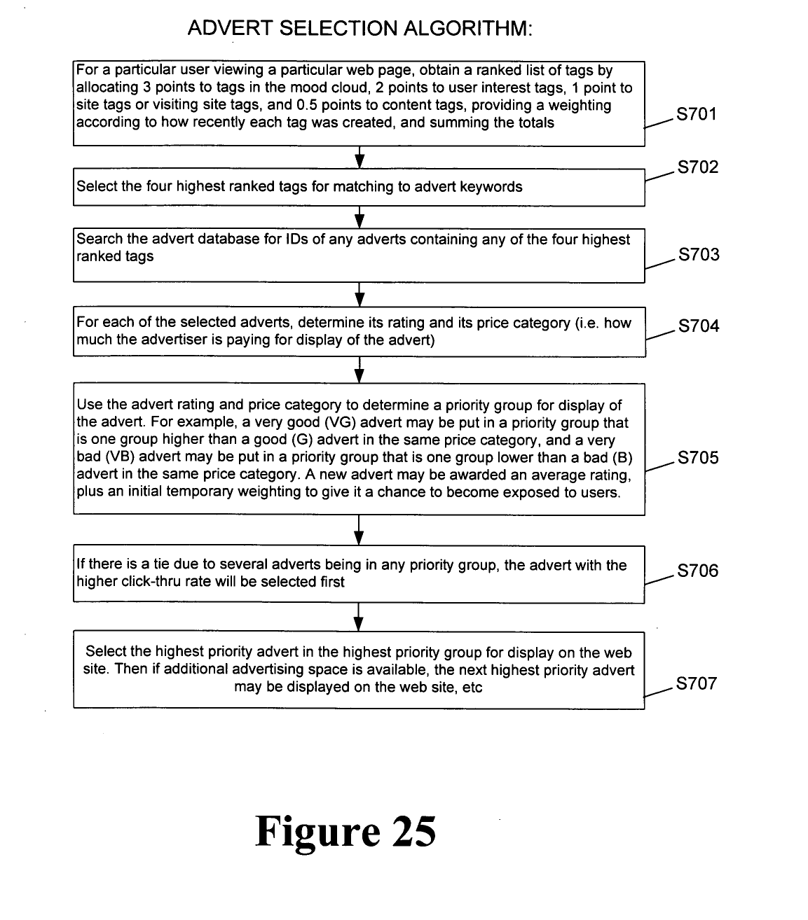

FIG. 25 shows an algorithm that may be used to select and serve ads. Firstly, at step S701, a ranked list of tags is obtained using the mood algorithm. Then, at step S702, the four highest ranked tags from the mood cloud are selected for use in the advert selection process. In alternative embodiments, a different number of tags may be used.

At step S703, the advert database is searched to find advert records containing any of these four highest ranked tags. The advert IDs of any adverts having relevant keywords are returned from the search. Then, in order to determine the display priority of each advert, the price that the advertiser is paying for the advert, and the rating of the advert are obtained in step S704. For example, the advert rating may be taken as the ad click-through rate. At step S705, the advert priorities are determined, where very highly rated adverts are given a significant advantage in priority over less highly rated adverts. For example, highest price and highest ranked adverts would be in the top category, e.g. followed by next price or highest ranked adverts, etc.

Each of the adverts displayed on the web site may be selected from the highest ranked priority category, if a large enough number of adverts is available in this category. Alternatively, the top slots may be reserved for top priority adverts, and lower slots may be reserved for lower priority adverts. In embodiments where adverts are changed after a time period, the top priority adverts may be displayed first, and lower priority adverts may be displayed later. Alternatively, only top priority adverts may be displayed, provided that enough are available, and lower priority adverts may not be displayed at all, unless there is a lack of top priority adverts.

If lots of highly rated adverts exist in the database, it may be difficult for new adverts to obtain enough exposure to build up their own ratings. These new adverts may seldom, if ever, be displayed, because new adverts are normally given a default rating of “average”. Thus, in some embodiments of the invention, the scores allocated to new adverts (to determine their rankings) may be modified using an additional weighting, to give them a higher score than they would otherwise have. This will improve the ease of discovery of new adverts. The additional weighting may be applied only to adverts that are newer than a threshold time limit, or the additional weighting may be determined as a function of time, which decreases as the advert becomes older. Different types of advert (e.g. different formats) and different subject areas of advert (e.g. as determined by the keywords) may be weighted in different ways.

If there is are several adverts with the same display priority, the advert with the highest click-though rate is selected first, as indicated at step S706. However, in alternative embodiments, this may not be the case, and a different or random selection criteria may be used.

Finally, at step S707, the highest priority advert in the highest priority group is selected for display. If additional advertising space is available, the next highest priority advert may be selected, and this may continue to fill all the available advertising space.

In another embodiment, AdModules may be served in a user driven way, where users decide everything and get the adverts as an RSS feed, meaning the advert serving system does not share anything with the web site publisher. Alternatively or additionally, AdModules may be served in a publisher driven way, where the web site publisher creates an “Ad module” on their web page, and revenues from advertising may be shared.

The ad module created by a web site publisher may have a format, size and interactivity chosen by the user, including any of text, image, audio, video or a combination thereof, such as image and text. In addition to the Ad in itself, each Ad module may include the following:
A “mood” editing button
Shortcuts to the user's modular web pages
A sign-up link, if the user is not logged-in
For each Ad (or for text ads in an Admodule), user controls to:
Rate the ad quantitatively (1 to 5 stars or anything else like colours) overall and on other criteria such as topic, timing, relevance, intrusiveness
Categorize the ad qualitatively with keywords, leading to “AdClouds”
Blog the ad by adding it to a blog with comments
Send the ad to one or more other users

In addition, the format of an advert served to a user may depend on whether the tag associated with the advert is an Advertising Tag, Interest Tag, Publisher Tag, Viewer Tag, or a combination of these categories. In particular embodiments, if the tag falls within more than one of the categories, the advert may be given a more intrusive format. This concept for advert formatting may be referred to as the “Ad Boost” mechanism.

The format of the advert may thus be dependent on the number of categories in which the tag appears, such that the more frequently the tag appears, the more the format of the advertising can be intrusive. For example, if the tag only appears in a small number of categories (e.g. one), text advertising may be displayed. It the tag appears in more categories (e.g. two or three) then pictorial advertising or branded advertising (with brands & pictures) may be displayed. If the tag appears in many or all of the categories (e.g. all four), then rich media advertising may be displayed, e.g. the adverts may include video content.

For example, if the tag “BMW” appears in all four categories, then the user, having shown a key interest in BMW, would be served an intrusive advertisement about BMW such as a video showing a specific new car, rather than just a bare text advert mentioning the new car. In effect, the instructions sent to the Ad serving system may include not only the tags to be used in selecting the topic of the adverts to be served, and the relevant ratings values, but also the number of categories of the MoodCloud in which each tag appears. In alternative embodiments, other categories may be used for the Ad Boost system, in addition to or instead of the four mentioned above.

All the adverts served may be stored in a “moodbox” user interface that the user can access at any time. The moodbox may store all adverts that a user has been exposed to within a specified time period. A screen area may be allocated to the moodbox, to display these adverts. The moodbox may include a user interface to allow a user to sort and rate adverts. It may include scroll controls to allow a user to scroll through a large number of different adverts. Each advert can be deleted, rated, categorized, forwarded to friends with comments. Adverts may be inserted in a mail, or added directly to a different user's moodbox, e.g. in a recommended by friends folder.

Editors or automatic system thresholds may get rid of ads not performing well, and manage the competition between ads.

Money may be collected by upfront payment by advertisers to their accounts. This may be done online. Specific conditions may be offered to big advertisers in terms of discount and payment facilities. Certain tools may be provided to advertisers, such as a “dashboard” to follow efficiency and add rating and comparison with all other ads for a given keyword.

Advertisers may be provided with the following services:
Compare all ads performance for a given keyword
Most recommended ads
Best/worst or top 10 Ad for Content, Message, Value
Modular web page stamp (and thus logo) of approval for UDA sites

Each advert may be displayed continuously on the web page, at least until a user chooses to reload the web page, or adverts may be automatically replaced by different adverts after a certain time interval. For example, in one embodiment, new adverts may be displayed every 60 seconds or after some other predetermined time interval. This increases the user's exposure to a range of different adverts.

A record may be kept of how often each advert has been displayed. In some embodiments, within any priority category, the advert to be displayed first may be selected as the advert that has so far been displayed least often. This principle may be used to rank the display order of all adverts within each priority category, where adverts displayed an identical number of times may be randomly ordered or order by another criteria such as visual diversity e.g. based on the advert formatting.

In some embodiments, the adverts displayed on a particular web site may be selected to be different on each web page of the web site, or a random selection criterion may be used which takes account of the multiple pages available. Similarly, in some embodiments, the adverts displayed to a particular user may take into account which adverts have already been displayed to that user. For example, if the user has shown an interest in a particular topic of advert, then more such adverts may be displayed to the user. If the user has been shown a particular advert a large number of times in a recent time period without clicking on it, then a different advertising strategy may be selected to reduce the frequency at which that advert is displayed to the user for a next time period.

The adverts displayed on a particular web page may all relate to the same advert keyword. Alternatively, they may relate to different keywords. The number of adverts per keyword may be weighted according to the relevance of each keyword during the tag to keyword matching process, or according to some other criteria. The keywords selected for advert display may be selected as the top few keywords from this matching process, e.g. the top two, three, four, five or six keywords.

In some embodiments, web site owners can choose to add extra advertising modules to their web pages. This may be done in the same way as selecting any other module for a web page. The web site owner may be able to specify in detail the type of adverts that they would like to display, e.g. the subject area, the minimum rating, or even the specific advertiser or advert. Alternatively, a higher bias may be given to site content or to the interests of the user who is visiting the site, when selecting the adverts for display in these modules. Web site owners may generate additional revenue for their site by including such additional advertising modules. In some embodiments, the additional advertising modules are configured to display graphical or video adverts, and thus may have the potential for much more easily attracting a user's attention than a simple text advert.

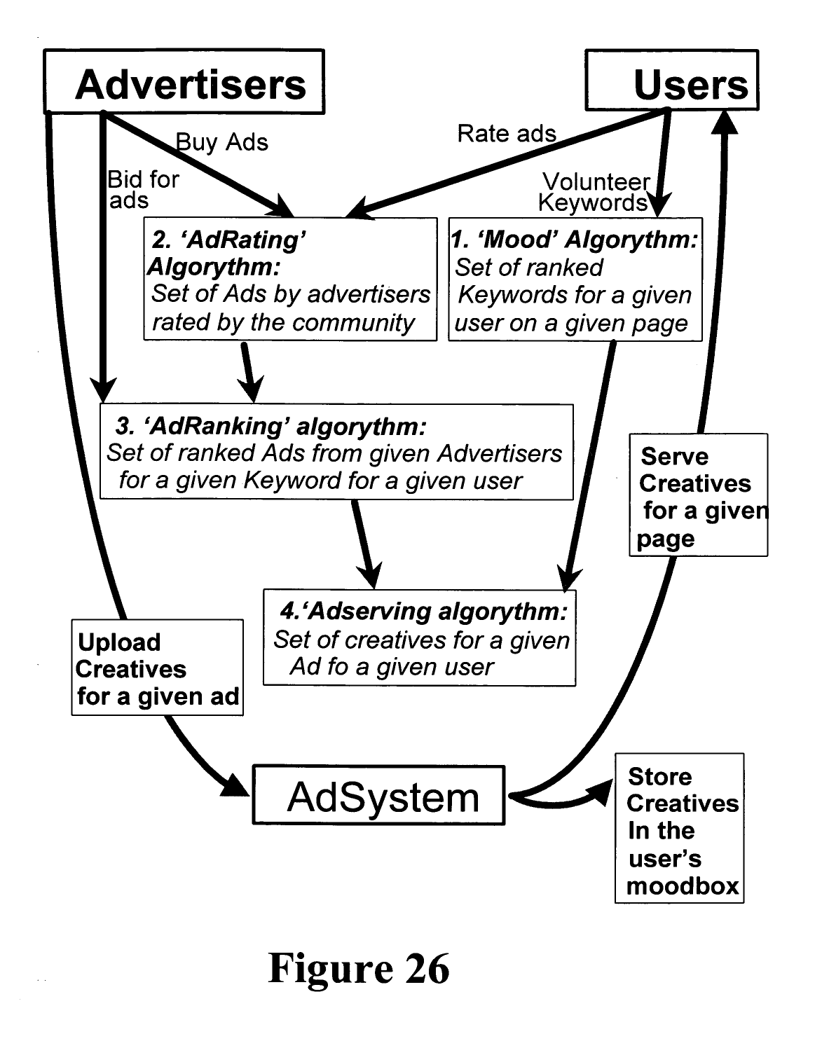

FIG. 26 shows a summary of the code modules that may be used for management of the advert serving system. This figure shows how both advertisers and users may interact with the Ad system. The two boxes at the top of the figure represent Advertisers and users. The box at the bottom of the figure represents the Ad system. An advertiser may upload creatives for a given advert to the Ad system, as indicated by the arrow on the left hand side of the figure. Alternatively, an advertiser may buy adverts, where these adverts are then rated using the Ad Rating process, as described above, and indicated in box 2 of the figure. The ads are then ranked, as shown in box 3 of the figure. The ad serving algorithm is then used to select the adverts for display, as indicated in box 4 of the figure. A further option is for an advertiser to bid for ads that already have a rating.

A user may rate ads, as indicated by box 2 of FIG. 26, or may volunteer keywords for their mood cloud, as indicated in box 1 of the figure, to indicate which sort of ads they would like to see. The Adsystem provides creatives to a user for a given web page, based on the user's mood cloud. The Adsystem may also store creatives in the user's mood box, for future reference by the user.

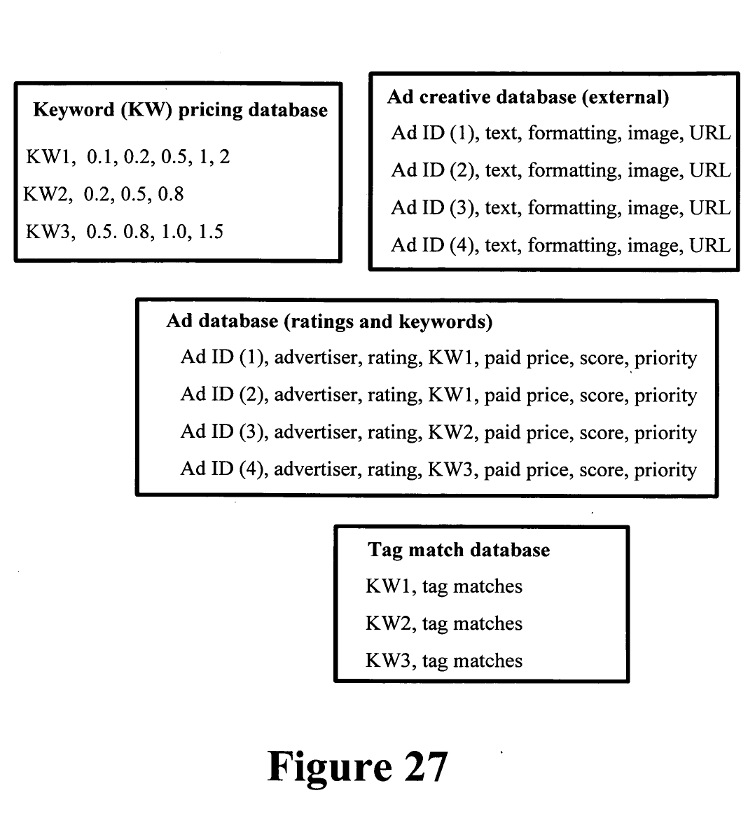

FIG. 27 shows a summary of the data structure in the advert database in one embodiment of the invention. Four tables are shown. The first table indicates the available price categories for advertisers to pay for different keywords. For example, for a first keyword (KW1), the pricing options are £0.10, £0.20, £0.50, 535 1 or £2 per user click. For a second keyword (KW2), the pricing options are £0.20, £0.50 or £0.80 per user click. For a third keyword (KW3), the pricing options are £0.50, £0.80, £1.00 or £1.50 per user click. The pricing options may be modified as required by the system administrator.

The second table is the Ad creative database, and provides links between the Ad IDs and the corresponding creatives. Each row of the table shows a particular Ad ID, plus the text, formatting information, image data and URL link (for users viewing the ad to click on) that is required to actually display the advert on a web site. This second table may be stored on the ad serving system itself, or may be stored externally. Alternative, individual advertisers may maintain their own versions of this second table, and the ad serving system may deal only with the Ad IDs to allow it to reference this information from each individual advertiser.

The third table is the Ad database, which stores ratings and keywords associated with each advert. Each line in this table includes an Ad ID, the name or ID of an advertiser, the advert rating (which may include quantitative ratings, qualitative ratings and/or user comments), a keyword which has been associated with that advert and the price paid by the advertiser to create that association. The advert score and priority are also stored in this table.

The fourth table is the Tag Match database, which is used when matching up tags to adverts. Each row of this table stores an advert keyword, plus the tag matches for this keyword.

Although these particular data structures are used in one embodiment of the invention, this is not essential for all embodiments, and alternative data structures may be used in different embodiments to store the necessary information.

In a further aspect of the invention, a profit sharing scheme is used in which the advertising revenue is shared with both the owner of a web page, and also the owner of a previous web page that was either directly or indirectly used as a template to create the web page on which the advert is displayed. The entire amount of money paid by the advertiser may be shared as described, or the remaining profit may be shared after expenses have been deducted. In either case, the web site owners will each receive a certain proportion of the total advertising income. This proportion may vary according to the total amount of money paid by the advertiser.

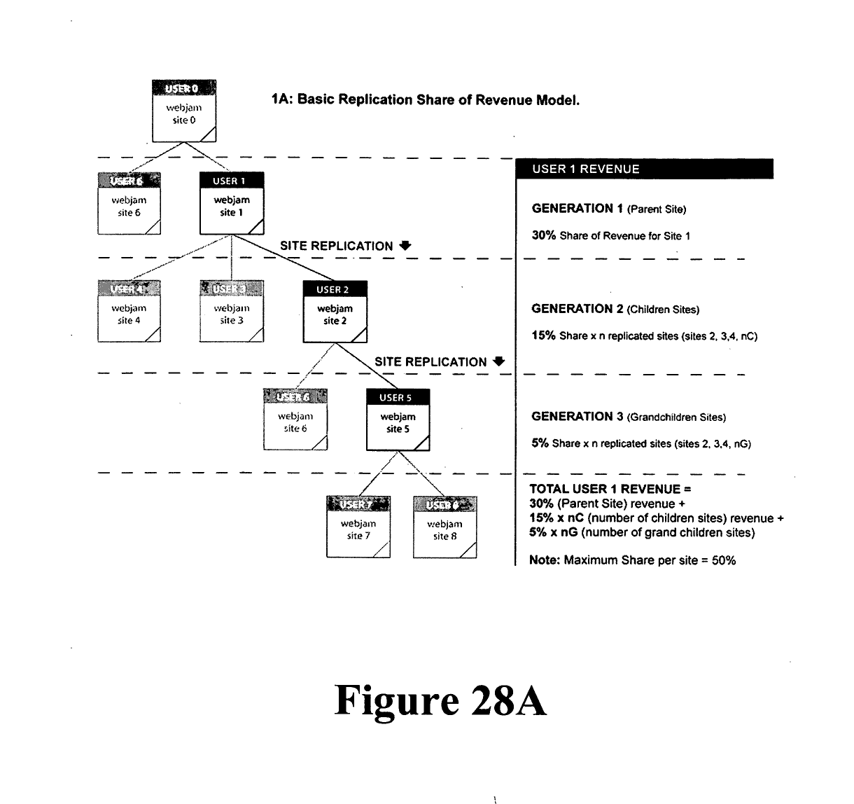

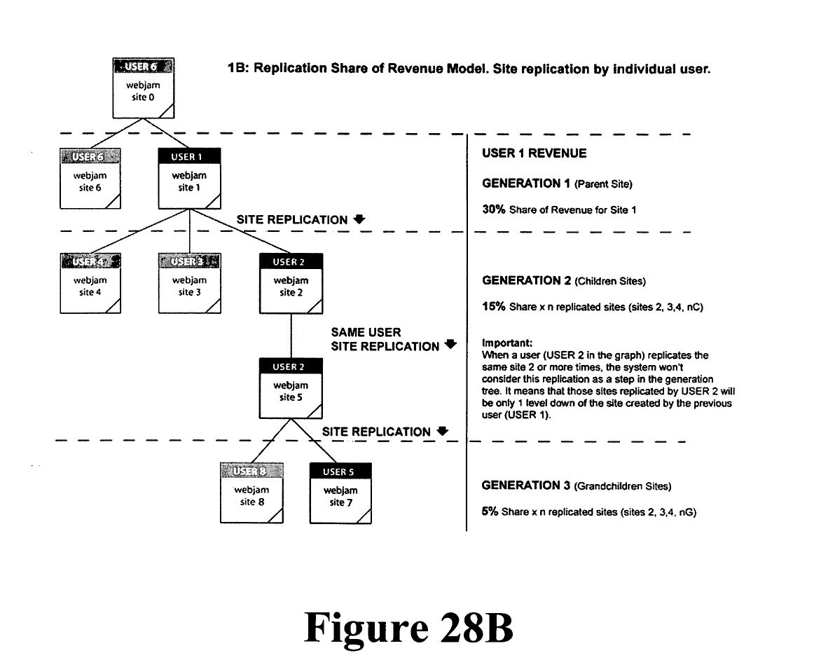

FIG. 28A shows a first example of such a profit sharing scheme. The top, greyed-out box of FIG. 28A shows a “grandparent” web site, which has been used as a template to generate a “parent” web site. The “parent” web site is represented by a black and white box, shown below the grandparent web site in the figure. Below the parent web site is shown a black and white box representing a “child” web site, where the parent web site was used as a template to generate the child web site. Below the child web site is shown a black and white box representing a “grandchild” web site, where the child web site was used to generate the grandchild web site. Additional web sites are shown as greyed-out boxes, for example, a “great-grandchild web site”, and various “sister” web sites.

In the example of FIG. 28A, a share of the advertising revenue of three different web sites is given to a single user, who is the owner of the parent web site. The owner of the parent web site gets 30% of the advertising revenue for adverts that are displayed on the parent site. The owner of the parent web site also gets 15% of the advertising revenue for adverts that are displayed on the child web sites, and 5% of the advertising revenue for adverts that are displayed on the grandchild web sites. Thus, the owner of the web site may actually end up making more money from the adverts displayed on the child and grandchild web sites that on their own web site, e.g. if there own web site is used to generate several child and grandchild web sites.

In the example of FIG. 28A, the revenue from the parent web site may be shared with the owner of the grandparent web site in a similar way, e.g. the owner of the grandparent web site may receive 15% of any advertising revenue from the parent web site. Similarly, the owner of a great grandparent web site, which was used to generate the grandparent web site, may receive 5% of any advertising revenue from the parent web site.

In the example of FIG. 28A, none of the users have replicated their own web sites, and all of the web sites have been replicated from web sites belonging to different users. However, if a user has replicated their own web site, then the system of FIG. 28A may be modified to prevent any individual user from receiving revenue twice for the same web site. This encourages users to copy other user's web sites, in preference to their own, in order to acquire a greater amount of advertising revenue.

In one example, the arrangement described for FIG. 28A operates, but with one difference. Instead of a single user acquiring multiple shares of revenue for any particular web site, that user only acquires the largest share to which they would be entitled. For example, if the user owns the parent and the child web site, then instead of receiving 30% plus 15% of the advertising revenue for the child web site, the user receives only 30% of the advertising revenue for the child web site.

FIG. 28B shows an alternative scheme, in which revenue payments are allocated to the next user in the chain, irrespective of the number of web sites owned by each user. The top three levels of FIG. 28B are the same as those in FIG. 28A. However, the grandchild web site (in the fourth level) in FIG. 28B is owned by the same user as the child web site. The great grandchild web site (in the fifth level) is owned by a different user. In this example, the 30% revenue share and the 15% revenue share are allocated in the same way as in FIG. 28A. However, when a user replicates the same site two or more times, or when the user replicates their own web site, this won't be considered as replication for the purpose of revenue sharing. Thus, the 5% revenue share is applied to the web site in the fifth level of the chain in this example, instead of to the web site in the fourth level of the chain.

In some embodiments, only a maximum of two different users may share the profits. In other embodiments, three or more users may share the profits. The remainder of the advertising revenue may be retained by the owner of the web site hosting the web sites which carry the advertising.

In some embodiments, the revenue from adverts is shared in a way that is independent of the advert ratings. In other embodiments, the revenue from adverts may be weighted according to the rating of the adverts, to encourage web site owners to display high quality adverts on the web pages. This is particularly useful when a web site owner chooses to add extra advertising modules to their web page on a voluntary basis.

The figures of 30%, 15% and 5% discussed above are only examples. In other embodiments, shares of the revenue may be higher or lower, e.g. the owner of the site on which the adverts are displayed may get 10%, 15%, 20%, 25%, 30%, 35% or 40%, or some other value. This user may also get e.g. 5%, 10%, 15%, 20% or some other value, for adverts displayed on another web site that is a “descendent” of the user's web site, e.g. for a child web site. This same user may also get 1%, 2%, 5%, 8%, 10% or some other value for adverts displayed on another web site that is a “descendent” of the “descendent” web site, e.g. a grandchild web site. Preferably, the percentage is highest for the user's own web site, next highest for the descendent web site and lowest for the descendent of the descendent web site.

In further embodiments, revenue sharing may take place over more than three generations of web sites, e.g. with four or more different users receiving shares of the revenue for a particular web site. The amounts of money shared in each case may be adjusted according to the number of users amongst whom it is shared.

The present invention can be implemented in dedicated hardware, using a programmable digital controller suitably programmed, or using a combination of hardware and software. Alternatively, the present invention can be implemented by software or programmable computing apparatus. This includes any computer, including PDAs (personal digital assistants), mobile phones, etc. The code for each process in the methods according to the invention may be modular, or may be arranged in an alternative way to perform the same function. The methods and apparatus according to the invention are applicable to any computer with a network connection.

Thus the present invention encompasses a carrier medium carrying machine readable instructions or computer code for controlling a programmable controller, computer or number of computers as the apparatus of the invention. The carrier medium can comprise any storage medium such as a floppy disk, CD ROM, DVD ROM, hard disk, magnetic tape, or programmable memory device, or a transient medium such as an electrical, optical, microwave, RF, electromagnetic, magnetic or acoustical signal. An example of such a signal is an encoded signal carrying a computer code over a communications network, e.g. a TCP/IP signal carrying computer code over an IP network such as the Internet, an intranet, or a local area network.

While the invention has been described in terms of what are at present its preferred embodiments, it will be apparent to those skilled in the art that various changes can be made to the preferred embodiments without departing from the scope of the invention, which is defined by the claims.

1. A method of automatically generating a web page, the method comprising:
receiving an instruction from a user to generate a first new web page and receiving an identifier of an existing web page that is accessible over a network;
using information defining the existing web page to generate information defining the first new web page;
providing user editing controls to allow a user to input user edits to edit content, layout, modules and/or access rights of the first new web page, and modifying said information defining the first new web page in accordance with said user edits; and
sending said information defining the first new web page to an information store which is accessible over the network.

2. The method of claim 1, wherein the generation of information defining the first new web page comprises copying instructions to invoke code run on a web server from said information defining the existing web page to said information defining the first new web page.

3. The method of claim 1, wherein said receiving an instruction comprises receiving an instruction that has been automatically generated as a result of the user operating a web page replication control in said existing web page.

4. The method of claim 1, further comprising
providing information defining a plurality of web page components;
receiving a user selection of a web page component; and
adding information defining the selected web page component to the information defining the first new web page.

5. The method of claim 1, wherein the first new web page includes a user control which, on activation by a user, sends an instruction to a server to generate information defining a second new web page using said information defining the first new web page, said instruction including information identifying the first new web page to the server.

6. The method of claim 1, wherein said original web page comprises a plurality of functional modules, and wherein said using information defining the existing web page to generate information defining the first new web page comprises copying all modules of the original web page, for which the user has read access, to the first new web page.

7. The method of claim 6, wherein copying a module comprises copying access right settings defining user access rights to the module.

8. The method of claim 1, wherein said access rights comprises a list of users who have read access and/or write access to the existing web page or to a predefined part of the existing web page.

9. The method of claim 1, wherein the information defining the original web page comprises meta data, the method further comprising:
copying meta data from the information defining the original web page to the information defining the first new web page.

10. The method of claim 9, wherein said meta data comprises tags or labels identifying subject matter of the web site and/or the individual modules of the web site.

11. The method of claim 9, further comprising providing editing controls to allow a user to edit the meta data, and using the edited meta data to automatically select content for at least one module of the first new web page.

12. The method of claim 9, further comprising using stored information identifying interests of a user to automatically select content for at least a part of the first new web page.

13. The method of claim 9, wherein a combination of meta data relating to the web site content and information about the user are used to select content for at least a part of the first new web page.

14. The method of claim 1, further comprising automatically allocating rating points to the original web page each time it is used as a template for a new web page.

15. The method of claim 1, further comprising creating a hyperlink from the first new web page to the original web page, and/or a hyperlink from the original web page to the first new web page.

16. The method of claim 1, further comprising creating a hyperlink on the first new web page, the hyperlink linking the first new web page with any web page in a chain of web pages from which the first new web page was generated, or any web page in a chain of web pages that has been generated using said first new web page.

17. The method of claim 1, further comprising creating a hyperlink linking to the first new web page, on any web page in a chain of web pages from which the first new web page was generated, or on any web page in a chain of web pages that has been generated using said first new web page.

18. The method of claim 1, further comprising generating a history list identifying the relationship between the first new web page, the original web page, and any previous web pages that were used to generate either the original web page or another of said previous web pages.

19. The method of claim 1, further comprising generating a list identifying any web pages that have been generated using the first new web page.

20. The method of claim 1, further comprising:
identifying user access rights of said user from whom said instruction is received;
copying information defining modules and content for which said user has read access, from the information defining the original web page to the information defining the new web page; and
allocating user access rights to the modules of the new web page, based on the user access rights of the corresponding modules in the original web page.

21. The method of claim 20, further comprising setting the read access level for each module to any one of the following: single user only; any user in a predetermined list of users; any logged on user, or unrestricted public access; and/or setting the write access level for each module to any one of the following: single user only; any user in a predetermined list of users; any logged on user, or unrestricted public access.

22. The method of claim 20, wherein the access level for each module comprises a setting to indicate whether the module is suitable for viewing on a mobile computing device.

23. A method of automatically generating a web page, the method comprising:
displaying an existing web page that is accessible over a network; and
in response to an instruction from a user:
sending an instruction to generate a first new web page to a server and sending an identifier of said existing web page to said server;
receiving said first new web page from the server and displaying said first new web page, wherein information defining said first new web page has been generated using information defining the existing web page;
providing user editing controls to allow a user to input user edits to edit content, layout, modules and/or access rights of the first new web page;
sending said user edits to said server to modify said information defining the first new web page in accordance with said user edits, said modified information defining the first new web page being stored in an information store which is accessible over the network; and
updating the display of said first new web page to include said user edits.

24. The method of claim 23, wherein said instruction from a user comprises an instruction that has been automatically generated as a result of the user operating a web page replication control in said existing web page.

25. The method of claim 23, further comprising
displaying a list of web page components;
receiving a user selection of a web page component; and
sending said user selection to said server for modifying of said information defining the first new web page by addition of information defining the selected web page component.

26. The method of claim 23, wherein the first new web page includes a user control which, on activation by a user, sends an instruction to a server to generate information defining a second new web page using said information defining the first new web page, said instruction including information identifying the first new web page to the server.

27. The method of claim 23, wherein said original web page comprises a plurality of functional modules, and wherein said receiving said first new web page comprises receiving a copy of all modules of the original web page, for which the user has read access.

28. The method of claim 27, wherein receiving a copy of a module comprises receiving copied access right settings defining user access rights to the module.

29. The method of claim 23, wherein said access rights comprises a list of users who have read access and/or write access to the existing web page or to a predefined part of the existing web page.

30. The method of claim 23, wherein the information defining the original web page comprises meta data, and wherein said receiving said first new web page comprises receiving a copy of said meta data.

31. The method of claim 30, wherein said meta data comprises tags or labels identifying subject matter of the web site and/or the individual modules of the web site.

32. The method of claim 30, further comprising providing editing controls to allow a user to edit the meta data, sending said edited meta data to the server, and receiving content for at least one module of the first new web page from said server, said content having been automatically selected using the edited meta data.

33. The method of claim 30, further comprising sending information identifying interests of a user to said server, and receiving content for at least a part of the first new web page from said server, said content having been automatically selected using said information identifying interests of a user.

34. The method of claim 30, comprising receiving content for at least a part of the first new web page from the server, said content having been selected using a combination of meta data relating to the web site content and information about the user.

35. The method of claim 23, further comprising displaying a hyperlink from the first new web page to the original web page.

36. The method of claim 23, further comprising displaying a hyperlink on the first new web page, the hyperlink linking the first new web page with any web page in a chain of web pages from which the first new web page was generated, or any web page in a chain of web pages that has been generated using said first new web page.

37. The method of claim 23, further comprising displaying any web page in a chain of web pages from which the first new web page was generated, or on any web page in a chain of web pages that has been generated using said first new web page, wherein said displayed web page includes a hyperlink linking to the first new web page.

38. The method of claim 23, further comprising displaying a history list identifying the relationship between the first new web page, the original web page, and any previous web pages that were used to generate either the original web page or another of said previous web pages.

39. The method of claim 23, further comprising displaying a list identifying any web pages that have been generated using the first web page.

40. The method of claim 23, further comprising:
displaying modules and content copied to the first new web page from said original web page, for which said user has read access, to said user; and
blocking the display of said modules and content to another user who does not have read access to the corresponding modules and content of the original web page.

41. The method of claim 40, further comprising receiving information from the server indicating whether a module is suitable for viewing on a mobile computing device.

42. A method of automatically generating a web page, the method comprising:
receiving a user selection or automatic selection of a topic for said web page;
using said topic selection to search a database for information associated with said topic;
selecting items of information within the search results using rating values associated with the items of information;
generating a web page comprising a plurality of said selected items of information arranged using predetermined layout information.

43. The method of claim 42, wherein using rating values comprises calculating scores using rating values and using said scores to select items of information within the search results, wherein the score for each item of information is dependent on the age of the item of information or the time at which the item of information was last updated or confirmed to be current.

44. The method of claim 42, wherein the selected topic is associated with one or more additional topics, and said search of the database comprises searching for items of information associated with the selected topic and/or at least one additional topic, and wherein using rating values comprises calculating scores using rating values and using said scores to select items of information within the search results, wherein the score for each item of information is dependent on which of the selected topic and additional topics are associated with each item of information.

45. A method of automatically selecting information from an information store or index wherein each item of information has meta data comprising a rating value and one or more tags, the method comprising:
retrieving data associated with one or more users;
generating a search query using said retrieved data associated with the one or more users;
searching said information store or index with said search query and selecting items of information having at least one tag corresponding to the search term;
awarding a score to each selected item of information, using the rating values of each item of information;
ranking the selected items of information according to their scores; and
outputting at least one of the selected items of information with a score in a top part of the ranking.

46. The method of claim 45, wherein said top part of the ranking is the top 20%.

47. The method of claim 46, wherein said top part of the ranking is the highest ranked item.

48. The method of claim 45, further comprising removing an item of information from the ranking after said information has been outputted; and
outputting a further item of said selected information which has a score in a top part of the revised ranking.

49. The method of claim 45, further comprising using said ranking to select information for output for a selected time period, and generating a new search query to generate a new ranking after the expiry of said time period.

50. The method of claim 49, wherein said time period is selected according to the type of medium to which the information is outputted and/or using statistics on the user's browsing behaviour on said medium.

51. The method of claim 45, further comprising adjusting the scores using weightings that are determined according to a creation date of each item of information.

52. The method of claim 45, further comprising adjusting the scores according to the number of times each item of information has previously been viewed by users.

53. The method of claim 45, further comprising adjusting the scores according to the source locations of the items of information.

54. The method of claim 45, wherein outputting the selected items of information comprises outputting said selected items to be published on an internet web site, to be broadcast on television or radio, or to be displayed on an electronic billboard, wherein said information associated with a user may comprise information associated with a single user or information associated with a group of users.

55. A method of generating a new modular web page using the method of claim 45, the method further comprising, for a module of said modular web site:
generating said search query using the retrieved information associated with the user and using tags associated with said module;
wherein said outputting the selected items of information comprises outputting the selected items of information with the highest scores which are suitable for output within said module.

56. The method of claim 45, wherein said awarding a score comprises using rating values that have been allocated only by members of a restricted group of users.

57. The method of claim 56, wherein said restricted group of users comprises users in a predetermined age range, users of a predetermined gender, users located in a predetermined geographical area, or some combination of these restrictions.

58. The method of claim 45, further comprising selecting a plurality of module types for a modular web page according to the results of the search of the information store or index.

59. A method of selecting content for display on a web page using predetermined user interest information from a user, said predetermined user interest information being stored on a server, the method comprising:
receiving a request from the user to view the web page;
using the user interest information to select content for display on the web site from an information content store or index; and
displaying the selected content on the web page.

60. The method of claim 59, wherein the selected content is selected using a combination of the user interest information and user assigned ratings assigned by a plurality of users, which are associated with the content.

61. The method of claim 59, wherein the selected content is selected using a combination of the user interest information and meta data associated with said web page.

62. The method of claim 59, wherein the selected content comprises advertising material selected from one or more databases of adverting material.

63. The method of claim 59, further comprising using said user interest information to modify the web page layout.

64. A method of outputting information to a user, the method comprising:
retrieving from a tag store tags from one or more of the following categories: tags representing interests of a user; tags relating to published web page content of the user; tags relating to a web page that a user has most recently requested to view; and tags relating to topics for which a user has requested to received advertising material, wherein individual tags may be in multiple categories;
providing each individual tag of said retrieved tags with a score, wherein said score is determined using the number and type of categories in which said individual tag is included;
using a predetermined number of tags with the highest scores to search an information database or index to locate information relating to the tags in this predetermined number of tags; and
outputting at least some of said located information to the user.

65. The method of claim 64, further comprising using the number of categories in which one or more of the predetermined number of tags occurs to select a format for displaying said located information.

66. The method of claim 64, wherein the located information comprises advertising material, and the number of categories in which one or more of the predetermined number of tags occurs is used to select an advertising format.

67. The method of claim 64, wherein a text format is selected if each said tag associated with particular located information is only in one of said categories.

68. The method of claim 64, wherein a multimedia format is selected if at least one of the tags associated with particular located information is in a predetermined number of categories.

69. The method of claim 64, further comprising determining scores for each tag in each category according to the time at which each tag was initially generated or confirmed by a user to be currently valid.

70. The method of claim 64, further comprising generating scores for individual tags that are present in multiple categories by allocating a score to each occurrence of an individual tag in any category, and summing the scores for said individual tag over a plurality of categories.

71. A method of rating a web page, web page component or user, the method comprising:
providing user controls to allow users to rate a web page, web page component or user by adding new tags to a tag cloud describing the web page, web page component or user, and/or by rating the tags in said tag cloud; and
storing data defining said tag cloud and said ratings in a data store.

72. The method of claim 71, further comprising providing user controls to rate a web page, web page component or user by allocating a numerical score, and storing said numerical store in said data store.

73. The method of claim 71, further comprising providing user controls to rate a web page, web page component or user by providing user comments, and storing said user comments in said data store.

74. A method of generating a tag cloud for a specified topic, the method comprising searching a database comprising meta data relating to each of a plurality of items of information, wherein said meta data indicates the subject matter of the information, and identifying items of information which have meta data matching said specified topic;
generating a list of meta data that is associated with the items of information identified in said search, said list including meta data that does not match said specified topic;
generating weights for each item of meta data in said list, using the number of times each item of meta data is associated with any item of information identified in the search; and
generating a tag cloud for the specified topic using said list and said weights.

75. The method of claim 74, further comprising using only the items of meta data which have weights above a predetermined threshold to generate said tag cloud.

76. The method of claim 74, wherein said weights are modified using any combination of the following factors: popularity of each tag; time since generation of each tag; time since last update of information associated with said tag; ratings values of said tag.

77. The method of claim 74, further comprising providing a search interface to allow a user to enter a search term, setting said specified topic to be said search term, and returning said tag cloud as search results.

78. The method of claim 74, further comprising providing a user interface comprising a visual representation of said tag cloud, wherein said user interface is configured to allow a user to select any topic in said tag cloud, and to generate and display a new tag cloud using the method of claim 67 using the topic selected by the user as said specified topic.

79. A method of displaying a tag cloud, comprising storing tags of the tag cloud, ratings for each tag, and information about users who created and rated each tag, the method comprising:
providing user controls to allow a user to specify a sub group of users according to a user criteria;
generating weightings for each tag in the tag cloud using only ratings that have been allocated by users in said selected group of users; and
displaying the tag cloud with said generated weightings.

80. The method of claim 79, wherein said user criteria comprises any combination of gender, age or age group, geographical location, type of employment, political views.

81. The method of claim 79, wherein said weightings are further determined according to the time at which each tag was created.

82. A method of automatically selecting an advert to be served to a user or a group of users, the method comprising:
ranking a list of adverts using price categories paid by advertisers for said adverts and using ratings allocated to the adverts by users;
selecting an advert from a top part of said ranked list; and
serving said selected advert to said user or group of users.

83. The method of claim 82, further comprising obtaining said list of adverts by searching a database of advert information using information specific to a user or group of users to whom the advert will be served.

84. The method of claim 83, wherein said selected advert is served to a web page, and said information specific to a user or group of users includes any of the following criteria:
stated interests of the user or group of users;
published content of web pages owned by the user or group of users;
advertising topics that the user or group of users has specified;
information associated with the web page to which the advert will be served;
information relating to the geographical location of the user or group of users;
a language used by the user or group of users, and/or
a preferred advert format selected by the user or group of users.

85. The method of claim 84, wherein at least some of said criteria are assigned weighting values to determine their relative importance, and said weighting values are used to determine search terms for searching a database of adverts to obtain said ranked list.

86. The method of claim 83, wherein said top part of the ranked list comprises the top 20% of the ranked list.

87. A method of generating a plurality of keywords for use in the selection of advertising material for a target web site, the method comprising:
retrieving keywords relating to one or more of the following sources: the content of the target web site; the author of the target web site; the user who is requesting to view the target web site; and other web sites owned by said user;
using weighting values to assign weights to the retrieved keywords according to the keyword source and the time at which the keyword was assigned to said keyword source;
generating a ranked list of keywords using said assigned weights;
comparing said ranked list of keywords to the keywords associated with individual adverts; and
selecting adverts in dependence upon the result of the comparison.

88. The method of claim 87, wherein said sources of keywords comprise tags associated with information in an information store.

89. The method of claim 87, further comprising
using a paid price of each selected advert and a user rating of said selected advert to assign a priority rating to the advert;
serving an advert to the target web site, said advert being chosen using said priority rating.

90. The method of claim 89, further comprising serving only adverts with a priority rating above a threshold value.

91. A method of selecting an advert format for serving an advert to a user, the method comprising:
searching a plurality of categories of stored information associated with the user to determine the number of categories in which an advert keyword occurs; and
selecting an advert format from a plurality of advert formats according to the number of said categories in which the advert keyword is found.

92. The method of claim 91, wherein the categories comprise one or more of the following: interests of a user; published web page content of the user; a web page that a user has most recently requested to view; and topics for which a user has requested to received advertising material.

93. The method of claim 91, wherein the categories each comprises one or more tags, and searching a category comprises searching the tags of a category.

94. The method of claim 91, wherein a text format is selected if said keyword is associated with only one of said categories.

95. The method of claim 91, wherein a multimedia format is selected if said keyword is associated with a predetermined number of categories.

96. A method of management of displayed adverts, the method comprising:
storing identifiers of adverts that have been served to a user on one or more web pages during a time period; and
providing user controls for displaying adverts corresponding to the stored identifiers and for sorting and/or searching adverts corresponding to the stored identifiers, in response to a user input.

97. The method of claim 96, wherein the time period is selected by the user.

98. The method of claim 96, further comprising sorting adverts according to any of the following criteria, in response to a corresponding user selection: time of serving of advert; time of publication of advert; content of the adverts; previous user interest in the adverts; previous labelling of adverts by the user; referrals of adverts by another user.

99. A method of generating and sharing revenue from advertising, the method comprising:
serving an advert to a first web page owned by a first user, wherein the first web page has been generated using a second web page as a template, or using a web page that has been directly or indirectly derived from the second web page as a template;
charging an advertising fee to an advertiser for serving said advert;
allocating a first predetermined portion of the advertising fee to the first user; and
allocating a second predetermined portion of the advertising fee to a second user who owns the second web page.

100. The method of claim 99, wherein the second web page is a web page that was used as a template by the first user to create the first web page or to create a web page from which the first web page was directly or indirectly derived.

101. The method of claim 99, wherein the second web page has been generated using a third web page as a template, or using a web page that has been directly or indirectly derived from the third web page as a template, the method further comprising:
allocating a third predetermined portion of the advertising fee to a third user who owns the third web page.

102. The method of claim 99, wherein the third web page is a web page that was used as a template by the second user to create the second web page or to create a web page from which the second web page was directly or indirectly derived.

103. The method of claim 99, wherein the first predetermined portion is larger than the second predetermined portion, and the second predetermined portion is larger than the third predetermined portion.

104. The method of claim 99, wherein the sum of said predetermined portions does not exceed 50% of the advertising fee.

105. The method of claim 99, wherein the remainder of the advertising fee is allocated to an owner of a web server hosting said web pages.

106. The method of claim 99, wherein the first user is allocated only said first portion of the advertising fee if the first web site was generated using another web site belonging to said first user as a template.

107. Apparatus for automatically generating a web page, the apparatus comprising:
receiving means for receiving an instruction from a user to generate a first new web page and receiving an identifier of an existing web page that is accessible over a network;
editing means for using information defining the existing web page to generate information defining the first new web page; providing user editing controls to allow a user to input user edits to edit content, layout, modules and/or access rights of the first new web page, and modifying said information defining the first new web page in accordance with said user edits; and
sending means for sending said information defining the first new web page to an information store which is accessible over the network.

108. The apparatus of claim 107, wherein the editing means is configured to generate said information defining the first new web page by copying instructions to invoke code run on a web server from said information defining the existing web page to said information defining the first new web page.

109. The apparatus of claim 107, wherein said receiving means is configured to receive an instruction that has been automatically generated as a result of the user operating a web page replication control in said existing web page.

110. The apparatus of claim 107, wherein said editing means is configured to provide information defining a plurality of web page components;
said receiving means is configured to receive a user selection of a web page component; and
said editing means is configured to add information defining the selected web page component to the information defining the first new web page.

111. The apparatus of claim 107, wherein the first new web page includes a user control which, on activation by a user, sends an instruction to a server to generate information defining a second new web page using said information defining the first new web page, said instruction including information identifying the first new web page to the server.

112. The apparatus of claim 107, wherein said original web page comprises a plurality of functional modules, and wherein said editing means is configured to copy all modules of the original web page, for which the user has read access, to the first new web page.

113. The apparatus of claim 112, wherein the editing means is configured to copy access right settings of the modules, defining user access rights to the module.

114. The apparatus of claim 107, wherein said access rights comprises a list of users who have read access and/or write access to the existing web page or to a predefined part of the existing web page.

115. The apparatus of claim 107, wherein the information defining the original web page comprises meta data, and wherein said editing means is configured to copy meta data from the information defining the original web page to the information defining the first new web page.

116. The apparatus of claim 115, wherein said meta data comprises tags or labels identifying subject matter of the web site and/or the individual modules of the web site.

117. The apparatus of claim 115, wherein said editing means is configured to provide editing controls to allow a user to edit the meta data, and to use the edited meta data to automatically select content for at least one module of the first new web page.

118. The apparatus of claim 115, wherein said editing means is configured to use stored information identifying interests of a user to automatically select content for at least a part of the first new web page.

119. The apparatus of claim 115, wherein the editing means is configured to use a combination of meta data relating to the web site content and information about the user to select content for at least a part of the first new web page.

120. The apparatus of claim 107, wherein said editing means is configured to automatically allocate rating points to the original web page each time it is used as a template for a new web page.

121. The apparatus of claim 107, wherein the editing means is configured to create a hyperlink from the first new web page to the original web page, and/or a hyperlink from the original web page to the first new web page.

122. The apparatus of claim 107, wherein the editing means is configured to create a hyperlink on the first new web page, the hyperlink linking the first new web page with any web page in a chain of web pages from which the first new web page was generated, or any web page in a chain of web pages that has been generated using said first new web page.

123. The apparatus of claim 107, wherein the editing means is configured to create a hyperlink linking to the first new web page, on any web page in a chain of web pages from which the first new web page was generated, or on any web page in a chain of web pages that has been generated using said first new web page.

124. The apparatus of claim 107, wherein the editing means is configured to generate a history list identifying the relationship between the first new web page, the original web page, and any previous web pages that were used to generate either the original web page or another of said previous web pages.

125. The apparatus of claim 107, wherein the editing means is configured to generate a list identifying any web pages that have been generated using the first new web page.

126. The apparatus of claim 107, wherein the editing means is configured to identify user access rights of said user from whom said instruction is received; to copy information defining modules and content for which said user has read access, from the information defining the original web page to the information defining the new web page; and to allocate user access rights to the modules of the new web page, based on the user access rights of the corresponding modules in the original web page.

127. The apparatus of claim 126, wherein the editing means is configured to set a read access level for each module to any one of the following: single user only; any user in a predetermined list of users; any logged on user, or unrestricted public access; and/or to set a write access level for each module to any one of the following: single user only; any user in a predetermined list of users; any logged on user, or unrestricted public access.

128. The apparatus of claim 126, wherein the access level for each module comprises a setting to indicate whether the module is suitable for viewing on a mobile computing device.

129. Apparatus for automatically generating a web page, the apparatus comprising:
display control means for displaying an existing web page that is accessible over a network on a display; and
sending means for sending an instruction to generate a first new web page to a server and sending an identifier of said existing web page to said server;
receiving means for receiving said first new web page from the server and displaying said first new web page, wherein information defining said first new web page has been generated using information defining the existing web page;
editing means for providing user editing controls to allow a user to input user edits to edit content, layout, modules and/or access rights of the first new web page;
wherein said sending means is configured to sending said user edits to said server to modify said information defining the first new web page in accordance with said user edits, said modified information defining the first new web page being stored in an information store which is accessible over the network; and
wherein said display control means is configured to update the display of said first new web page to include said user edits.

130. The apparatus of claim 129, wherein said sending means is configured to send an instruction from a user that has been automatically generated as a result of the user operating a web page replication control in said existing web page.

131. The apparatus of claim 129, wherein the display control means is configured to display a list of web page components;
the receiving means is configured to receive a user selection of a web page component; and
the sending means is configured to send said user selection to said server for modifying of said information defining the first new web page by addition of information defining the selected web page component.

132. The apparatus of claim 129, wherein the first new web page includes a user control which, on activation by a user, sends an instruction to a server to generate information defining a second new web page using said information defining the first new web page, said instruction including information identifying the first new web page to the server.

133. The apparatus of claim 129, wherein said original web page comprises a plurality of functional modules, and wherein said receiving means is configured to receive a copy of all modules of the original web page for which the user has read access.

134. The apparatus of claim 133, wherein the receiving means is configured to receive a copy of access right settings of each module, defining user access rights to the module.

135. The method of claim 129, wherein said access rights comprises a list of users who have read access and/or write access to the existing web page or to a predefined part of the existing web page.

136. The apparatus of claim 129, wherein the information defining the original web page comprises meta data, and wherein said receiving means is configured to receive a copy of said meta data.

137. The apparatus of claim 136, wherein said meta data comprises tags or labels identifying subject matter of the web site and/or the individual modules of the web site.

138. The apparatus of claim 136, wherein said editing means is configured to providing editing controls to allow a user to edit the meta data; said sending means is configured to send said edited meta data to the server, and said receiving means is configured to receive content for at least one module of the first new web page from said server, said content having been automatically selected using the edited meta data.

139. The apparatus of claim 136, wherein said sending means is configured to send information identifying interests of a user to said server, and said receiving means is configured to receive content for at least a part of the first new web page from said server, said content having been automatically selected using said information identifying interests of a user.

140. The apparatus of claim 136, wherein the receiving means is configured to receive content for at least a part of the first new web page from the server, said content having been selected using a combination of meta data relating to the web site content and information about the user.

141. The apparatus of claim 129, wherein the display control means is configured to display a hyperlink from the first new web page to the original web page.

142. The apparatus of claim 129, wherein the display control means is configured to display a hyperlink on the first new web page, the hyperlink linking the first new web page with any web page in a chain of web pages from which the first new web page was generated, or any web page in a chain of web pages that has been generated using said first new web page.

143. The apparatus of claim 129, wherein the display control means is configured to display any web page in a chain of web pages from which the first new web page was generated, or on any web page in a chain of web pages that has been generated using said first new web page, wherein said displayed web page includes a hyperlink linking to the first new web page.

144. The apparatus of claim 129, wherein the display control means is configured to display a history list identifying the relationship between the first new web page, the original web page, and any previous web pages that were used to generate either the original web page or another of said previous web pages.

145. The apparatus of claim 129, wherein the display control means is configured to display a list identifying any web pages that have been generated using the first web page.

146. The apparatus of claim 129, wherein the display control means is configured to display modules and content copied to the first new web page from said original web page, for which said user has read access, to said user; and to block the display of said modules and content to another user who does not have read access to the corresponding modules and content of the original web page.

147. The apparatus of claim 146, wherein said receiving means is configured to receive information from the server indicating whether a module is suitable for viewing on a mobile computing device.

148. Apparatus for automatically generating a web page, the apparatus comprising:
receiving means for receiving a user selection or automatic selection of a topic for said web page;
search means for using said topic selection to search a database for information associated with said topic;
selection means for selecting items of information within the search results using rating values associated with the items of information;
generating means for generating a web page comprising a plurality of said selected items of information arranged using predetermined layout information.

149. The apparatus of claim 148, wherein said selection means is configured to calculate scores using the rating values and to use the scores to select items of information within the search results, wherein the score for each item of information is dependent on the age of the item of information or the time at which the item of information was last updated or confirmed to be current.

150. The apparatus of claim 148, wherein the selected topic is associated with one or more additional topics, the search means is configured to search the database for items of information associated with the selected topic and/or at least one additional topic, and the selection means is configured to calculate scores using rating values and to use said scores to select items of information within the search results, wherein the score for each item of information is dependent on which of the selected topic and additional topics are associated with each item of information.

151. Apparatus for automatically selecting information from an information store or index wherein each item of information has meta data comprising a rating value and one or more tags, the apparatus comprising:
retrieving means for retrieving data associated with one or more users;
generating means for generating a search query using said retrieved data associated with the one or more users;
search means for searching said information store or index with said search query and selecting items of information having at least one tag corresponding to the search term;
scoring means for awarding a score to each selected item of information, using the rating values of each item of information, and ranking the selected items of information according to their scores; and
output means for outputting at least one of the selected items of information with a score in a top part of the ranking.

152. The apparatus of claim 151, wherein said output means is configured to output at least one of the selected items in the top 20% of the ranking.

153. The apparatus of claim 152, wherein said output means is configured to output the highest ranked item.

154. The apparatus of claim 151, wherein said scoring means is configured to remove an item of information from the ranking after said information has been outputted; and
wherein said output means is configured to output a further item of said selected information which has a score in a top part of the revised ranking.

155. The apparatus of claim 151, wherein said output means is configured to use said ranking to select information for output for a selected time period, and wherein said search means is configured to generate a new search query to generate a new ranking after the expiry of said time period.

156. The apparatus of claim 155, configured to select said time period according to the type of medium to which the information is outputted and/or using statistics on the user's browsing behaviour on said medium.

157. The apparatus of claim 151, wherein said scoring means is configured to adjust the scores using weightings that are determined according to a creation date of each item of information.

158. The apparatus of claim 151, wherein said scoring means is configured to adjust the scores according to the number of times each item of information has previously been viewed by users.

159. The apparatus of claim 151, wherein said scoring means is configured to adjust the scores according to the source locations of the items of information.

160. The apparatus of claim 151, wherein said output means is configured to output said selected items to be published on an internet web site, to be broadcast on television or radio, or to be displayed on an electronic billboard, wherein said information associated with a user may comprise information associated with a single user or information associated with a group of users.

161. The apparatus of claim 152, configured to generate a new modular web page,
wherein said generating means is configured to generate said search query using the retrieved information associated with the user and using tags associated with a module of said modular webpage;
wherein said output means is configured to output the selected items of information with the highest scores which are suitable for output within said module.

162. The apparatus of claim 153, wherein said score means is configured to award a score using rating values that have been allocated only by members of a restricted group of users.

163. The apparatus of claim 162, wherein said score means is configured to award said score using rating values that have been allocated only by a group of users in a predetermined age range, of a predetermined gender, in a predetermined geographical area, or some combination of these restrictions.

164. The apparatus of claim 153, further comprising selecting means for selecting a plurality of module types for a modular web page according to the results of the search of the information store or index.

165. Apparatus for selecting content for display on a web page using predetermined user interest information from a user, said predetermined user interest information being stored on a server, the apparatus comprising:
receiving means for receiving a request from the user to view the web page;
selection means configured to use the user interest information for selecting content for display on the web site from an information content store or index; and
display control means for displaying the selected content on the web page on a display.

166. The apparatus of claim 165, wherein the selection means is configured to select content using a combination of the user interest information and user assigned ratings assigned by a plurality of users, which are associated with the content.

167. The apparatus of claim 165, wherein the selection means is configured to select content using a combination of the user interest information and meta data associated with said web page.

168. The apparatus of claim 165, wherein the selection means is configured to select content comprising advertising material from one or more databases of adverting material.

169. The apparatus of claim 165, further wherein said selection means is configured to use said user interest information to modify the web page layout.

170. Apparatus for outputting information to a user, the apparatus comprising:
retrieving means for retrieving from a tag store tags from one or more of the following categories: tags representing interests of a user; tags relating to published web page content of the user; tags relating to a web page that a user has most recently requested to view; and tags relating to topics for which a user has requested to received advertising material, wherein individual tags may be in multiple categories;
scoring means for providing each individual tag of said retrieved tags with a score, wherein said score is determined using the number and type of categories in which said individual tag is included;
search means configured to use a predetermined number of tags with the highest scores to search an information database or index to locate information relating to the tags in this predetermined number of tags; and
output means for outputting at least some of said located information to the user.

171. The apparatus of claim 170, wherein said output means is configured to use the number of categories in which one or more of the predetermined number of tags occurs to select a format for displaying said located information.

172. The apparatus of claim 170, wherein the located information comprises advertising material, and the output means is configured to use the number of categories in which one or more of the predetermined number of tags occurs to select an advertising format.

173. The apparatus of claim 170, wherein the output means is configured to use a text format if each said tag associated with particular located information is only in one of said categories.

174. The apparatus of claim 170, wherein the output means is configured to use a multimedia format if at least one tag associated with particular located information is in a predetermined number of categories.

175. The apparatus of claim 174, wherein said scoring means is configured to determine scores for each tag in each category according to the time at which each tag was initially generated or confirmed by a user to be currently valid.

176. The apparatus of claim 170, wherein said scoring means is configured to generate scores for individual tags that are present in multiple categories by allocating a score to each occurrence of an individual tag in any category, and to sum the scores for said individual tag over a plurality of categories.

177. Apparatus for rating a web page, web page component or user, the apparatus comprising:
rating means for providing user controls to allow users to rate a web page, web page component or user by adding new tags to a tag cloud describing the web page, web page component or user, and/or by rating the tags in said tag cloud; and
storage means for storing data defining said tag cloud and said ratings.

178. The apparatus of claim 177, wherein said rating means is configured to provide user controls to rate a web page, web page component or user by allocating a numerical score, and storing said numerical store in said data store.

179. The apparatus of claim 177, wherein said rating means is configured to provide user controls to rate a web page, web page component or user by providing user comments, and storing said user comments in said data store.

180. Apparatus for generating a tag cloud for a specified topic, the apparatus comprising
search means for searching a database comprising meta data relating to each of a plurality of items of information, wherein said meta data indicates the subject matter of the information, and for identifying items of information which have meta data matching said specified topic; and
processing means for generating a list of meta data that is associated with the items of information identified in said search, said list including meta data that does not match said specified topic; for generating weights for each item of meta data in said list, using the number of times each item of meta data is associated with any item of information identified in the search; and for generating a tag cloud for the specified topic using said list and said weights.

181. The apparatus of claim 180, wherein said processing means is configured to use only the items of meta data which have weights above a predetermined threshold to generate said tag cloud.

182. The apparatus of claim 180, wherein said processing means is configured to modify said weights using any combination of the following factors: popularity of each tag; time since generation of each tag; time since last update of information associated with said tag; ratings values of said tag.

183. The apparatus of claim 180, wherein said search means further comprises a search interface to allow a user to enter a search term, wherein said specified topic is set to be said search term, and wherein said processing means comprises means to return said tag cloud as search results.

184. The apparatus of claim 180, further comprising display control means for displaying a visual representation of said tag cloud, wherein said user interface is configured to allow a user to select any topic in said tag cloud, and to generate and display a new tag cloud having the topic selected by the user as said specified topic.

185. Apparatus for displaying a tag cloud, the apparatus comprising:
storage means for storing tags of the tag cloud, ratings for each tag, and information about users who created and rated each tag;
selection means for providing user controls to allow a user to specify a sub group of users according to a user criteria;
processing means for generating weightings for each tag in the tag cloud using only ratings that have been allocated by users in said selected group of users; and
display control means for displaying the tag cloud with said generated weightings on a display.

186. The apparatus of claim 185, wherein said user criteria comprises any combination of gender, age or age group, geographical location, type of employment, political views.

187. The apparatus of claim 185, wherein said processing means is configured to determine weightings according to the time at which each tag was created.

188. Apparatus for automatically selecting an advert to be served to a user or a group of users, the apparatus comprising:
selection means for ranking a list of adverts using price categories paid by advertisers for said adverts and using ratings allocated to the adverts by users; and selecting an advert from a top part of said ranked list; and
output means for serving said selected advert to said user or group of users.

189. The apparatus of claim 188, wherein said selection means is configured to obtain said list of adverts by searching a database of advert information using information specific to a user or group of users to whom the advert will be served.

190. The apparatus of claim 189, wherein said output means is configured to serve said selected advert to a web page, and said information specific to a user or group of users includes any of the following criteria:
stated interests of the user or group of users;
published content of web pages owned by the user or group of users;
advertising topics that the user or group of users has specified;
information associated with the web page to which the advert will be served;
information relating to the geographical location of the user or group of users;
a language used by the user or group of users, and/or
a preferred advert format selected by the user or group of users.

191. The apparatus of claim 190, wherein said selection means is configured to assign weighting values to at least some of said criteria to determine their relative importance, and to use said weighting values to determine search terms for searching a database of adverts to obtain said ranked list.

192. The apparatus of claim 189, wherein said top part of the ranked list comprises the top 20% of the ranked list.

193. Apparatus for generating a plurality of keywords for use in the selection of advertising material for a target web site, the apparatus comprising:
retrieving means for retrieving keywords relating to one or more of the following sources: the content of the target web site; the author of the target web site; the user who is requesting to view the target web site; and other web sites owned by said user;
weighting means for using weighting values to assign weights to the retrieved keywords according to the keyword source and the time at which the keyword was assigned to said keyword source; and generating a ranked list of keywords using said assigned weights; and
selection means for comparing said ranked list of keywords to the keywords associated with individual adverts; and selecting adverts in dependence upon the result of the comparison.

194. The apparatus of claim 193, wherein said retrieving means is configured to use tags associated with information in an information store as a source of keywords.

195. The apparatus of claim 193, wherein said selection means is configured to use a paid price of each selected advert and a user rating of said selected advert to assign a priority rating to the advert; the apparatus further comprising:
output means for serving an advert to the target web site, said advert being chosen using said priority rating.

196. The apparatus of claim 195, wherein said output means is configured for serving only adverts with a priority rating above a threshold value.

197. Apparatus for selecting an advert format for serving an advert to a user, the apparatus comprising:
searching means for searching a plurality of categories of stored information associated with the user to determine the number of categories in which an advert keyword occurs; and
selection means for selecting an advert format from a plurality of advert formats according to the number of said categories in which the advert keyword is found.

198. The apparatus of claim 197, wherein the categories comprise one or more of the following:
interests of a user; published web page content of the user; a web page that a user has most recently requested to view; and topics for which a user has requested to received advertising material.

199. The apparatus of claim 197, wherein the categories each comprises one or more tags, and the searching means is configured to search the tags for each category.

200. The apparatus of claim 197, wherein the searching means is configured to select a text format if said keyword is associated with only one of said categories.

201. The method of claim 197, wherein the searching means is configured to select a multimedia format if said keyword is associated with a predetermined number of categories.

202. Apparatus for management of displayed adverts, the apparatus comprising;
storage means for storing identifiers of adverts that have been served to a user on one or more web pages during a time period; and
providing means for providing user controls to display adverts corresponding to the stored identifiers and for sorting and/or searching adverts corresponding to the stored identifiers, in response to a user input.

203. The apparatus of claim 202, wherein the time period is selected by the user.

204. The apparatus of claim 202, further comprising sorting means for sorting adverts according to any of the following criteria, in response to a corresponding user selection: time of serving of advert; time of publication of advert; content of the adverts; previous user interest in the adverts; previous labelling of adverts by the user; referrals of adverts by another user.

205. Apparatus for generating and sharing revenue from advertising, the apparatus comprising:
output means for serving an advert to a first web page owned by a first user, wherein the first web page has been generated using a second web page as a template, or using a web page that has been directly or indirectly derived from the second web page as a template; and
processing means for calculating an advertising fee to be charged to an advertiser for serving said advert; said processing means being configured to allocate a first predetermined portion of the advertising fee to the first user; and to allocate a second predetermined portion of the advertising fee to a second user who owns the second web page.

206. The apparatus of claim 205, wherein the second web page is a web page that was used as a template by the first user to create the first web page or to create a web page from which the first web page was directly or indirectly derived.

207. The apparatus of claim 205, wherein the second web page is a web page that was generated using a third web page as a template, or using a web page that has been directly or indirectly derived from the third web page as a template, wherein the processing means is configured to allocate a third predetermined portion of the advertising fee to a third user who owns the third web page.

208. The apparatus of claim 207, wherein the third web page is a web page that was used as a template by the second user to create the second web page or to create a web page from which the second web page was directly or indirectly derived.

209. The apparatus of claim 207, wherein the first predetermined portion is larger than the second predetermined portion, and the second predetermined portion is larger than the third predetermined portion.

210. The apparatus of claim 205, wherein the sum of said predetermined portions does not exceed 50% of the advertising fee.

211. The apparatus of claim 205, wherein the processing means is configured to allocate the remainder of the advertising fee to an owner of a web server hosting said web pages.

212. The apparatus of claim 205, wherein the processing means is configured to allocate only said first portion of the advertising fee to the first user if the first web site was generated using another web site belonging to said first user.

213. Apparatus for automatically generating a web page, the apparatus comprising:
data memory storing information defining an existing webpage;
code memory storing implementable code; and
a processor adapted to implement the code in the code memory, the code in the code memory comprising code to control the processor to perform the method of claim 1.

214. Apparatus for automatically generating a web page, the apparatus comprising:
data memory storing information defining an existing webpage;
code memory storing implementable code; and
a processor adapted to implement the code in the code memory, the code in the code memory comprising code to control the processor to perform the method of claim 23.

215. Apparatus for automatically generating a web page, the apparatus comprising:
data memory storing information associated with a plurality of different topics;
code memory storing implementable code; and
a processor adapted to implement the code in the code memory, the code in the code memory comprising code to control the processor to perform the method of claim 42.

216. Apparatus for automatically generating a web page, the apparatus comprising:
data memory storing information or an information index, each item of information having meta data comprising a rating value and one or more tags;
code memory storing implementable code; and
a processor adapted to implement the code in the code memory, the code in the code memory comprising code to control the processor to perform the method of claim 45.

217. Apparatus for automatically selecting content for display on a web page, the apparatus comprising:
data memory storing predetermined user interest information from a user;
code memory storing implementable code; and
a processor adapted to implement the code in the code memory, the code in the code memory comprising code to control the processor to perform the method of claim 59.

218. Apparatus for outputting information to a user, the apparatus comprising:
data memory storing tags from one or more of the following categories: tags representing interests of a user; tags relating to published web page content of the user; tags relating to a web page that a user has most recently requested to view; and tags relating to topics for which a user has requested to received advertising material, wherein individual tags may be in multiple categories;
code memory storing implementable code; and
a processor adapted to implement the code in the code memory, the code in the code memory comprising code to control the processor to perform the method of claim 64.

219. Apparatus for rating a web page, web page component or user, the apparatus comprising:
data memory storing user rating data for web pages, web page components and/or users;
code memory storing implementable code; and
a processor adapted to implement the code in the code memory, the code in the code memory comprising code to control the processor to perform the method of claim 71.

220. Apparatus for generating a tag cloud for a specified topic, the apparatus comprising:
data memory storing meta data relating to each of a plurality of items of information and indicating the subject matter of each item of information;
code memory storing implementable code; and
a processor adapted to implement the code in the code memory, the code in the code memory comprising code to control the processor to perform the method of claim 74.

221. Apparatus for displaying a tag cloud, the apparatus comprising:
data memory storing tags, ratings for each tag, and information about users who created and rated each tag;
code memory storing implementable code; and
a processor adapted to implement the code in the code memory, the code in the code memory comprising code to control the processor to perform the method of claim 79.

222. Apparatus for automatically selecting an advert to be served to a user or a group of users, the apparatus comprising:
data memory storing advert pricing data and advert rating data;
code memory storing implementable code; and
a processor adapted to implement the code in the code memory, the code in the code memory comprising code to control the processor to perform the method of claim 82.

223. Apparatus for generating a plurality of keywords for use in the selection of advertising material for a target web site, the apparatus comprising:
data memory storing keyword weighting values;
code memory storing implementable code; and
a processor adapted to implement the code in the code memory, the code in the code memory comprising code to control the processor to perform the method of claim 87.

224. Apparatus for selecting an advert format for serving an advert to a user, the apparatus comprising:
data memory storing a plurality of categories of stored information associated with the user;
code memory storing implementable code; and
a processor adapted to implement the code in the code memory, the code in the code memory comprising code to control the processor to perform the method of claim 91.

225. Apparatus for management of displayed adverts, the apparatus comprising:
data memory storing identifiers of adverts that have been served to a user on one or more web pages during a time period;
code memory storing implementable code; and
a processor adapted to implement the code in the code memory, the code in the code memory comprising code to control the processor to perform the method of claim 96.

226. Apparatus for generating and sharing revenue from advertising, the apparatus comprising:
data memory storing data relating to advertising revenue;
code memory storing implementable code; and
a processor adapted to implement the code in the code memory, the code in the code memory comprising code to control the processor to perform the method of claim 99.

227. A carrier medium carrying computer readable code for controlling a computer to automatically generate a web page by performing the method of claim 1.

228. A carrier medium carrying computer readable code for controlling a computer to automatically generate a web page by performing the method of claim 23.

229. A carrier medium carrying computer readable code for controlling a computer to automatically generate a web page by performing the method of claim 42.

230. A carrier medium carrying computer readable code for controlling a computer to automatically select information from an information store or index by performing the method of claim 45.

231. A carrier medium carrying computer readable code for controlling a computer to automatically selecting content for display on a web page by performing the method of claim 59.

232. A carrier medium carrying computer readable code for controlling a computer to output information to a user by performing the method of claim 64.

233. A carrier medium carrying computer readable code for controlling a computer to store a rating for a web page, web page component or user by performing the method of claim 71.

234. A carrier medium carrying computer readable code for controlling a computer to generate a tag cloud for a specified topic by performing the method of claim 74.

235. A carrier medium carrying computer readable code for controlling a computer to display a tag cloud by performing the method of claim 79.

236. A carrier medium carrying computer readable code for controlling a computer to automatically select an advert to be served to a user or a group of users by performing the method of claim 82.

237. A carrier medium carrying computer readable code for controlling a computer to generate a plurality of keywords for use in the selection of advertising material for a target web site by performing the method of claim 87.

238. A carrier medium carrying computer readable code for controlling a computer to manage a display of adverts by performing the method of claim 91.

239. A carrier medium carrying computer readable code for controlling a computer to generate and share revenue from advertising by performing the method of claim 96.

240. A carrier medium carrying computer readable code for controlling a computer to manage a display of adverts by performing the method of claim 99.
